(19) United States
(12) Patent Application Publication
(10) Pub. No.: US 2026/0105290 A1
(43) Pub. Date: Apr. 16, 2026

(54) Physical Neural Network

(71) Applicant: Imperial College Innovations Limited, London (GB)

(72) Inventors: Jack GARTSIDE, London (GB); Kilian STENNING, London (GB); Alex VANSTONE, London (GB); Holly HOLDER, London (GB); William BRANFORD, London (GB); Rupert Francis Maximillian OULTON, London (GB)

(73) Assignee: Imperial College Innovations Limited, London (GB)

(21) Appl. No.: 19/117,851

(22) PCT Filed: Oct. 3, 2022
(86) PCT No.: PCT/GB2022/052501

§ 371 Date: Apr. 2, 2025

(51) Int. Cl. G06N 3/063; G06N 3/084; G06N 3/086

(52) U.S. Cl. CPC G06N 3/063; G06N 3/084; G06N 3/086

(57) ABSTRACT

A device (1) for use as a physical neural network is described. The device includes a plurality of artificial neurons (2). Each artificial neuron includes a ferromagnetic thin-film nanomagnetic structure (3) having a respective switchable magnetic state. The device is responsive to input data taking the form of a field generated by a control apparatus (5). The input data is for switching one or more of the magnetic states and/or for exerting control over spin-wave dynamics of one or more of the magnetic states. The magnetic states and/or the spin-wave dynamics are readable by one or more sensors (6) to provide output data.

### FIELD

The present invention relates to a device for use as a physical neural network.

### BACKGROUND

Modern AI and machine-learning (ML) continues to provide striking advances across a diverse set of applications. However, this is accompanied by a burgeoning energy cost, threatening the sustainability of modern computing. This is driven by the vast number of trainable parameters required and the need to constantly shuttle data between memory and processing units when training ML networks. ‘Reservoir computing’ (RC) offers an attractive alternative. By replacing the hidden layers in a traditional neural network with a dynamic ‘reservoir’ with fixed network connections, both training times and energy costs are significantly reduced whilst maintaining strong performance for time-domain tasks. However, the non-linear, parallel computations underpinning RC and ML are not well catered for in CMOS. Consequently, there is a pressing need for hardware systems that: store and process information in the same unit, transfer information efficiently, and function in a brain-like (neuromorphic) manner.

Impressive successes have been seen across a number of hardware systems. Reference is made to: Thomas, A. Memristor-based neural networks. J. Phys. D: Appl. Phys. 46, 093001 (2013); Milano, G. et al. In materia reservoir computing with a fully memristive architecture based on self-organizing nanowire networks. Nat. Mater. 21, 195-202 (2022); Yao, P. et al. Fully hardware-implemented memristor convolutional neural network. Nature 577, 641-646 (2020); Li, C. et al. Efficient and self-adaptive in-situ learning in multilayer memristor neural networks. Nat. Commun. 9, 1-8 (2018); and Sui, X., Wu, Q., Liu, J., Chen, Q. & Gu, G. A review of optical neural networks. IEEE Access 8, 70773-70783 (2020). Yet key issues in memory volatility, destructivity, rapid physical degradation, reconfigurability, and on-chip footprint size are key challenges to overcome to improve scalability. Reference is made to Wang, Z. et al. Resistive switching materials for information processing. Nat. Rev. Mater. 5, 173-195 (2020).

Nanoscale ferromagnetic systems are emerging as an attractive candidate for implementing hardware reservoir computation. Reference is made to Gartside, J. C. et al. Reconfigurable Training and Reservoir Computing via Spin-Wave Fingerprinting in an Artificial Spin-Vortex Ice, arXiv preprint arXiv:2107.08941v2 (2021), which is incorporated by reference herein in its entirety. The magnetic configuration (state) of nanomagnets can possess an intrinsic long-term memory. Arrays of nanomagnets can interact wirelessly through dipolar coupling, allowing for information transfer with no electron movement and waste heat. This interaction is dependent on the state of surrounding nanomagnets and can enable collective ‘in-memory’ computation. Nanomagnets can switch at ˜ns timescales and nanomagnetic arrays can support collective GHz excitations (magnons) thereby enabling high-speed operation, well suited to next-generation computing and telecoms technologies. There is significant interest in developing these systems for neuromorphic computation and impressive demonstrations of RC in small networks have demonstrated their potential. Reference is made to: Torrejon, J. et al. Neuromorphic computing with nanoscale spintronic oscillators. Nature 547, 428-431 (2017); and Romera, M. et al. Vowel recognition with four coupled spin-torque nano-oscillators. Nature 563, 230-234 (2018). Theoretical proposals have shown the possible substantial memory, computational low-power operation capabilities of larger nanomagnetic arrays. Reference is made to: Jensen, J. H., Folven, E. & Tufte, G. Computation in artificial spin ice. In ALIFE 2018: The 2018 Conference on Artificial Life, 15-22 (MIT Press, 2018); Jensen, J. H. & Tufte, G. Reservoir computing in artificial spin ice. In ALIFE 2020: The 2020 Conference on Artificial Life, 376-383 (MIT Press, 2020); and Hon, K. et al. Numerical simulation of artificial spin ice for reservoir computing. Appl. Phys. Express 14, 033001 (2021). However, experimental progress has remained elusive due to limited means of writing and reading magnetic states at the nanoscale.

It is known, in software-based reservoirs, that that combining reservoirs in parallel and in series (deep), performance across a variety of tasks can be significantly improved over single reservoirs. Translating these schemes to hardware systems is not trivial. In software, random connections are made between different reservoirs and network and connection parameters can be iteratively refined. This extremely challenging in hardware due to complex wiring and data acquisition times.

### SUMMARY

The term ‘physical neural network’ is intended to cover artificial neural networks in which adjustable (physical) materials are used to emulate neurons. In other words, in a physical neural network, the artificial neurons are physical and implemented in hardware, i.e., not in software. In the present application, ferromagnetic thin-film nanomagnetic structures (e.g., nanomagnets) are used to emulate neurons.

According to a first aspect of the invention there is provided a device for use as a physical neural network. The device includes a plurality of artificial neurons. Each artificial neuron includes a ferromagnetic thin-film nanomagnetic structure having a respective switchable magnetic state. The device is responsive to input data taking the form of a field generated by a control apparatus. The input data is for switching one or more of the magnetic states and/or for exerting control over spin-wave dynamics of one or more of the magnetic states. The magnetic states and/or the spin-wave dynamics are readable by one or more sensors to provide output data.

Input data taking the form of field(s) provided by the control apparatus may correspond to an input layer of the physical neural network. The nanomagnetic structures may be configured to provide artificial synapses and correspond to a hidden layer of the physical neural network. Output data taking the form of the measureable response(s) of the magnetic states may correspond to an output layer of the physical neural network.

Some or all of artificial neurons may comprise only one nanomagnetic structure, said nanomagnetic structure having a switchable magnetic state. Some or all of the artificial neurons may comprise two or more nanomagnetic structures. In the case that an artificial neuron comprises two or more nanomagnetic structures, some of the magnetic states may be pinned (i.e., not switchable) or all of the magnetic states may be switchable.

The nanomagnetic structures may be disposed on a surface of a substrate. Alternatively, the nanomagnetic structures may be contained within a solid volume.

The nanomagnetic structures may be arranged in a coplanar arrangement.

Alternatively, the nanomagnetic structures may be arranged in a multiplanar arrangement.

The nanomagnetic structures may be arranged to define an array. Alternatively, the nanomagnetic structures may be arranged randomly.

The array of nanomagnetic structures may be ordered. Alternatively, the nanomagnetic structures may define an array which is disordered.

The array of nanomagnetic structures may form an artificial spin system that is an artificial spin ice or an artificial spin-vortex ice. The artificial spin-vortex-ice may be a width-modified artificial spin-vortex ice or a pinwheel artificial spin-vortex ice.

Alternatively, the array of nanomagnetic structures may form a structure in which at least a portion of the magnetic states have a magnetic texture that is a double vortex texture or a skyrmion texture.

The nanomagnetic structures may comprise or consist of an alloy, the alloy including: nickel and iron, optionally permalloy; and/or cobalt, iron, and boron, for example CoFeB; and/or yttrium, iron, and oxygen, for example yttrium iron garnet; and/or cobalt and platinum, for example CoPt.

Pairs of artificial neurons may be configured to be coupled by dipolar coupling so as to define artificial synapses. Each artificial synapse may have a trainable synaptic weight that is responsive to switching of the magnetic states or modification of spin-wave dynamics of one or more of the magnetic states.

According to a second aspect of the invention there is provided a system including the device according to the first aspect, a control apparatus for generating a field to switch one or more of the magnetic states and/or exert control over spin-wave dynamics of one or more of the magnetic states, and one or more sensors for sensing a state of one or more of the magnetic states.

The control apparatus may include a magnetic field generator and/or an electric field generator and/or an illumination apparatus.

The control apparatus may be configured to generate a time-varying magnetic field for magnetic switching, and/or microwave excitation for microwave-assisted magnetic switching, and/or optical illumination for all-optical magnetic switching, and/or a locally applied magnetic field from a scanning probe for topological magnetic writing, and/or heat for heat-assisted switching, and/or a local field for application by a read/write head (e.g., a conventional hard disk read/write head), and/or a current-induced field from a nanostructure proximate to the nanomagnetic structures (e.g., a nanopatterned stripline).

The one or more sensors may include a first sensor. The first sensor may be configured to perform ferromagnetic resonance measurements and/or magneto-optical Kerr effect measurements and/or electrical measurements (e.g., magneto-resistance or Hall effect measurements).

The system may further comprises a control interface for controlling the control apparatus and/or the one or more sensors.

Data for network processing may be stored in magnetic states and/or spin-wave excitation. Alternatively, data for network processing may be stored in an external memory cache connected to the control interface.

The system may further comprise a mask for masked training. The mask may be applied to the input before the input is received at the hidden layer.

The nanomagnetic structures may form a first hidden layer. The first hidden layer may be one of a plurality of hidden layers. The plurality of hidden layers may be connected in parallel, or in series, or in a hybrid arrangement combining series and parallel arrangements.

The nanomagnetic structures of the first hidden layer may be arranged in a first arrangement. The plurality of hidden layers may include a second hidden layer having a second arrangement, the second arrangement differing from the first arrangement.

At least one of the one or more sensors may be configured to sense a weighted combination of magnetic states from two or more different nanomagnetic structures. The weights of the weighted combination may be modifiable and for training.

The system according to the second aspect may include features corresponding to any features of the device according to the first aspect.

According to a third aspect of the invention there is provided a method of operating the device according to the first aspect or the system according to the second aspect, the method including: providing input data to the nanomagnetic structures and processing said data by switching one or more magnetic states and/or via spin-wave excitation; and reading out output data from the nanomagnetic structures by sensing one or more magnetic states. The method may be for training and/or inference.

Spin-wave excitation may include application of an RF-field and/or RF or DC electrical current and/or optical excitation.

According to a fourth aspect of the invention there is provided a method of training the device according to the first aspect or the system according to the second aspect, the method including the method according to the third aspect and training the device. Training the device includes determining whether a performance metric and/or a loss function and/or an error value of the device is improved for a given task after one or more magnetic states are switched and/or spin-wave dynamics are controlled by the control apparatus. Training the device also includes: in response to a positive determination of improvement of the performance metric or the loss function or the error value, keeping said one or more magnetic states switched and/or keeping changes to the state of the control apparatus; and/or in response to a negative determination of improvement of the performance metric or the loss function or the error value, switching back said one or more magnetic states and/or reversing changes to the state of the control apparatus.

The method of training may be performed using an algorithm that is random or recursive, for example by using backpropagation or by using a gradient descent technique or by using an evolutionary or genetic search algorithm and/or a regression algorithm including ridge or linear regression.

According to a fifth aspect of the invention there is provided a method of operating a system according to the second aspect in which the nanomagnetic structures form a first hidden layer, the first hidden layer is one of a plurality of hidden layers, and the plurality of hidden layers are connected in parallel, or in series, or in a hybrid arrangement combining series and parallel arrangements. The method includes: reading out data from two or more parallel outputs of the first hidden layer by sensing one or more magnetic states; performing a mathematical metric test on the outputs of the first hidden layer, for example evaluating memory and/or non-linearity; selecting a subset of the two or more parallel outputs based on the results of the mathematical metric test; and providing only the subset of the data read out from the two or more parallel outputs of the first hidden layer to the second hidden layer.

According to a sixth aspect of the invention there is provided a computer program including instructions which when executed by a one or more processors causes the computing device to perform the method according to any of the third, fourth, or fifth aspects.

According to a seventh aspect of the invention there is provided a computer program product comprising a computer-readable medium storing the computer program according to the sixth aspect.

According to an eighth aspect of the invention there is provided a module configured to perform the method according to any of the third, fourth, or fifth aspects. The module may be a hardware module.

According to a ninth aspect of the invention there is provided a monolithic integrated circuit including a processor subsystem and the module according to the eights aspect. The processor subsystem includes at least one processor and memory.

According to a tenth aspect of the invention there is provided a system including the device according the first aspect or the system according to the second aspect. The system also includes the integrated circuit according to the ninth aspect. The integrated circuit is arranged to control the magnetic states.

### BRIEF DESCRIPTION OF THE DRAWINGS

Certain embodiments of the present invention will now be described, by way of example, with reference to the accompanying drawings, in which:

FIG. 1 is a schematic diagram of a first example of a device for use as a physical neural network.

FIG. 2 is a perspective view of a portion of a second example of a device for use as a physical neural network.

FIG. 3 is a schematic diagram of a third example of a device for use as a physical neural network.

FIG. 4 is a process flow diagram illustrating a first example of a method of operating a physical neural network.

FIG. 5 is a process flow diagram illustrating a second example of a method of operating a physical neural network.

FIG. 6A: Panel a shows a scanning electron micrograph (3.5×3.5 μm²) of ASVI. The permalloy bars are 600 nm long, 200 nm (wide bar) or 125 nm (thin bar) wide and 20 nm thick, with a 100 nm vertex gap (bar end to vertex centre). Lattice vector \hat{x} is defined as along wide/thin bar rows and ŷ as perpendicular to rows. Panel b shows a phase diagram of the energy difference between vortex and macrospin states for a range of bar dimensions, determined by MuMax3 simulation. Red regions favour vortex states, blue regions favour macrospin. The dotted black line indicates dimensions with equal macrospin and vortex energy; the black circle at 600 nm×200 nm indicates the wide-bar dimensions of the sample studied here.

FIG. 6B: Panels c-f show MuMax3-simulated magnetization states of a single four-bar vertex in all-macrospin (c) and wide-bar vortex, thin-bar macrospin (d) states, and the corresponding simulated MFM images (e,f, respectively). The images are 1.6×1.6 μm². The MFM signal was simulated for a tip height 60 nm above the sample. The vertex gap is exaggerated relative to the experimental sample to allow clearer visualization. Panels g,h show experimental MFM images (1.9×1.9 μm²) of all-macrospin (g) and mixed vortex-macrospin (h) states. The image in h shows vortices in the top four bars and macrospins in the lower eight bars. The MFM scale bars have been converted from phase shift to magnetic charge q_{M}=Mₛₐₜ×w×t with Mₛₐₜ, w and t the nanoisland saturation magnetisation, width and thickness, respectively.

FIGS. 6C and 6D: Panel i shows magnetic force micrograph series (15×15 μm² images) showing the 4-loop vortex-injection field sequence from the initial −\hat{x} saturated, pure macrospin state (o loop, negative (−ve) field). The field loop amplitude was 18 mT, applied along \hat{x}. The series continues for 5, 7 and 10 loops, shown in FIG. 12A. The formation of vortex and macrospin domains is observed as field looping progresses to higher loop numbers. Hₛₐₜ and Hₑₓₜ refer to the globally applied initial saturation field and applied looping field, respectively. All images were taken in zero field.

FIG. 7A: Panel a shows differential FMR spectra measured in a −1.2 mT bias field after 0-30 successive±18 mT field cycles. The 0 loop state corresponds to the −200 mT saturated, pure macrospin state. Four main modes are observed: low-frequency vortex mode (˜3.5 GHZ), wide-bar macrospin mode (˜7 GHz), thin-bar macrospin mode (˜8.8 GHz) and high-frequency vortex mode (˜9.75 GHz). Panel b shows mode amplitude of the low-frequency vortex and wide-bar macrospin modes for 0-30±18 mT field cycles. Curves are displayed for three cases: field along the \hat{x} orientation, −\hat{x}-saturated thin bars (blue and orange symbols); field along the \hat{x} orientation, +ŷ-saturated thin bars (green and red symbols); field along the ŷ orientation, +ŷ-saturated thin bars (purple and brown symbols). The dashed lines for the macrospin modes are exponential decay fits to y=Ae^{-τ}^{_{MS}}^{x}+c, with decay constant τ_{MS} the macrospin evolution rate and c corresponding to the final macrospin population. The dashed lines for the vortex modes are fits to y=k−e^{-τ}^{_{V}}^{x}, with decay constant τ_{V} the vortex evolution rate and k relating to the final vortex population. Different vortex evolution rates and final vortex/macrospin populations are observed for the three cases, demonstrating reconfigurably directed vortex evolution via the thin-bar dipolar bias-field landscape and \hat{x}/ŷ field orientation relative to the sample lattice.

FIGS. 7B and 7C: Panels c-f show differential ±10 mT FMR heatmaps measured after 0 (c), 3 (d), 10 (e) and 30 (f)±18 mT field cycles. The sample was initially saturated along −\hat{x}, and the field applied along \hat{x}. The χ-shaped low-frequency vortex mode and ‘checkerboard’ high-frequency vortex mode increase with intensity throughout field cycling.

FIGS. 7D and 7E: Panel g shows MFM series of 3-100±18 mT field cycle states imaged after application of negative (top row) and positive (bottom row) fields of each field cycle. Increasing numbers of vortex state bars are observed as field cycling progresses, matching the increasing vortex FMR mode intensity in the heatmaps of c-f. The images are 15×15 μm².

FIG. 8A: Panels a-c show MuMax3 magnetization states of an ASVI vertex with both wide bars in the vortex state at Hₐₚₚ=+5 mT (a), 0 mT (b) and −5 mT (c). The vortex core is displaced along the bar length by Hₐₚₚ, leading to two low-frequency 3-6 GHz modes corresponding to magnetization regions above (M1_{A}) and below (M1_{B}) the vortex core. Both vortices here have the same chirality, and M1_{A} and M1_{B} are inverted in terms of high/low frequency at a given field for opposite chirality vortices. Panels d-n show spatial magnon mode power maps for the M1_{A} and M1_{B} vortex modes (d,e,h,k,l), M2 thin-bar macrospin mode (f,i,m) and M3 whispering gallery-like vortex mode (g,j,n). Images in a-n are 1 μm side length.

FIG. 8B: Panel o shows a simulated heatmap showing mode dispersion with field.

FIG. 9A: Panel a shows a FMR heatmap showing 0-35 mT field sweep along \hat{x} starting from a high-vortex-population state, ending in a saturated pure-macrospin state. The initial high-vortex-population state has thin bars and macrospin wide bars magnetized along ŷ. The wide-bar macrospins switch to +\hat{x} magnetization at 17 mT (H_{c} ‘M2M’), and the vortices switch to +\hat{x} macrospins beginning at 24 mT (H_{c} ‘V2M’) and saturate at 27 mT.

FIG. 9B: Panel b shows mode amplitudes of wide-bar vortex and macrospin modes for 5, 10 and 30 field-cycle states of ±18 mT measured while positively sweeping the field from 0 to 25 mT to reach the saturated pure-macrospin state. Spectra were measured after each field application in a bias field of −1.2 mT to remove the effects of varying Hₐₚₚ on mode amplitudes, allowing clearer comparison of the states. Field was applied in the \hat{x} direction, and thin bars saturated along −\hat{x}, hence V2M conversion occurs at slightly lower fields than in a. V2M conversion begins above 19.5 mT, allowing the ratchet effect whereby vorticization is achieved with 18 mT field cycles as vortices remain stable until higher Hₐₚₚ.

FIG. 9C: Panel c shows a macrospin FMR mode amplitude response of 0, 2, 5, 10, 20 and 30±18 mT field-cycle states to a single +21.5 mT ‘stimulus’ field application, followed by 15 subsequent±18 mT ‘recovery’ field cycles. A stimulus field of 21.5 mT was chosen on the basis of the results shown in b to convert ˜35-50% of vortices to macrospins. Initial field-cycled state amplitudes are shown at field loop number −1, a stimulus field of 21.5 mT was applied at loop 0 and loops 1-15 represent subsequent ±18 mT field cycles. The states retain memory (that is, longer-cycled states exhibit lower macrospin mode amplitudes) many loops after the 21.5 mT field application. The inset shows the post-stimulus mode evolution rate τ as a function of n (number of pre-stimulus field cycles). Linear fitting gives τ=−2.35×10⁻³n+0.235 dP/dH a.u./field loop, R²=0.94. The field was applied along \hat{x}.

FIG. 10A: Panel a shows a schematic of a reservoir computing scheme. Input values 0-1 are scaled over applied field range Hₐₚₚ=18-23.5 mT. The ASVI output response is obtained by applying a field loop, then measuring FMR spectra at Hₐₚₚ=2.6-9.5 GHZ (20 MHz steps). Weights are obtained by ridge regression on the ‘train’ dataset and applied to a separate ‘test’ dataset.

FIG. 10B to 10E: Panels b-i show transformation of sine wave (b-e) and inverse saw wave (f-i) input datasets I(t) to a variety of target waveforms y(t): saw wave (b), square wave (c,g), second-order hysteretic non-linear transformation (d,h) where (k-1) and (k-2) refer to function values at one and two time-steps in the past, respectively, I²(f₀) (e,i) and sine wave (f). Here, the reservoir outputs were sampled at 40 MHz in the ranges 3.6-4.56 GHz and 7.1-8.06 GHz (encompassing the vortex and macrospin peaks, respectively), giving a total of 48 reservoir outputs. Solid blue traces represent the same training procedure performed on the raw I(t) input datasets, bypassing the ASVI reservoir. The performance is severely reduced when bypassing the reservoir, visible as incorrect waveform shape and increased errors.

FIGS. 10F and 10G: Panels j and k show future prediction of t+1 (j) and t+10 (k) for a Mackey-Glass chaotic differential time series, a commonly used reservoir computing benchmark. ASVI performs well while raw inputs fail to produce a true prediction, simply reproducing the input dataset with a t+1 time lag (j), failing badly at the more challenging t+10 task (k). Here, all 397 reservoir outputs were used.

FIGS. 10H and 10I: Panels l and m show reservoir performance when lengthening the ‘train’ dataset for the saw wave transformation (l) and Mackey-Glass future prediction (m). The reservoir performance improves with increasing training length before plateauing.

FIG. 11: Panel a shows a MuMax3 time-series of vorticisation process at Hₐₚₚ=16 mT. Macrospin state in bottom right bar changes to a vortex via topological-defect exchange combining two half-integer, edge bound defects from opposite bar ends in the macrospin state into a single +1 winding number topological vortex-core defect in the bulk of the nanomagnet. Edge-bound half-integer+½ topological defects are circled in black in the 1 ns panel for visibility. Panel b shows a MuMax3 simulated time series of vortex-to-macrospin conversion at Hₐₚₚ=21 mT showing vortex-cores pushed by Hₐₚₚ into nanoisland edges, decomposing vortices into macrospin states. The vortex cores decompose on contact with the nanowire edges to a pair of +½ topological defects, which are circled in black in the 0.68 ns panel for visibility. Field applied along \hat{x}.

FIG. 12A: Panels a-c show a 5-10 loop training sequence continuing from the 0-4 loop sequence in FIGS. 6C and 6D.

FIG. 12B: Panels d-f show a 3-30 loop training sequence, imaged after positive field arm. Panels g-i show a subsequent 3-30 loop training sequence on the same array area as d-f), sample is reset to all-macrospin state with 200 mT field after sequence d-f). Different vortex locations and domain patterns are observed, highlighting the stochastic rather than deterministic nature of vortex training.

FIG. 13 shows mode-amplitudes of wide-bar macrospin and vortex modes while positively increasing field along +ŷ after 30±19 mT ŷ field-cycles, ending in saturated pure-macrospin state. Sample initially saturated along −ŷ pre-cycling, thin bars initially saturated along −ŷ before reversing at 27 mT and unlocking V2M conversion. Spectra measured in −1.2 mT bias field after each field application. V2M conversion begins at 27 mT, significantly higher than in FIG. 9B. This demonstrates control over protected vortex field-range via reconfigurable thin-bar bias-field.

FIG. 14 shows macrospin mode-amplitude evolution over field-cycle series consisting of single 21-23.5 mT ‘stimulus’ field applications followed by two subsequent ±18 mT loops. Stimulus fields convert vortices to macrospins, 18 mT loops convert macrospins to vortices. Sensitive response of mode-amplitude gradient to applied-field magnitude is observed. System begins at loop 0 in a highly-vorticised state.

FIGS. 15A-15J: Comparison between various output selections for reconstructing and saw and square wave from a sine-wave input. The optimum output selection is task dependent. Here, the FMR response was not smoothed before prediction.

FIGS. 16A-16C: ‘Train’ and ‘test’ response for τ=a) 0, b) 5, c) 10, d) 30, e) 40 and f) 50 when forecasting the Mackey-Glass equation. Panel g shows ‘Test’ MSE for Mackey-Glass prediction for up to 100 future steps. The ASVI response outperforms the input prediction when the target waveform is dissimilar to the input waveform. This is due to the input prediction simply reproducing the target dataset with a τ time-step lag rather than a true prediction of future performance—resulting in a sinusoidal MSE profile with peaks corresponding to π/2 phase shifts (e.g. panel e)τ=40) and troughs corresponding to π phase shifts (e.g. panel f)τ=50).

FIGS. 17A-17H: ASVI reservoir time-series transformation and prediction measuring at −1.2 mT. Panels a-h show transformation of a-d) sine-wave and e-h) inverse saw-wave input datasets I(t) to a variety of target waveforms y(t): a) saw-wave b,f) square-wave, c,g) second-order hysteretic non-linear transformation d,h) I²(f₀) e) sin-wave. The ASVI reservoir maintains reasonable transformation performance when measuring at a static −1.2 mT bias field to a high degree of accuracy demonstrated by low ‘test’ MSE errors (MSE ASVI). Solid blue traces are the same training procedure performed on the raw I(t) input datasets, bypassing the ASVI reservoir. Performance is severely reduced when bypassing the reservoir, visible as incorrect waveform curvature and increased errors. Panels i,j show a prediction of i) t+1 j) t+10 for a Mackey-Glass time-differential delay input commonly used as a benchmark for reservoir prediction quality. ASVI performs well while raw inputs fail to produce a true prediction and simply reproduce the input dataset with a t+1 time-lag j), which breaks down at the more challenging t+10 task k) resulting in poor performance. Reservoir performance when increasing the size of the ‘train’ dataset for k) sine-wave transformation and l) Mackey-Glass future prediction tasks. In all cases, the reservoir performance improves when increasing the number of training points as seen by the increasing ratio of MSE₁₀₀/MSEₙ where n is the length of the ‘training set’.

FIG. 18: Supplementary tables 1 and 2. Supplementary table 1: Comparison of MSE values for the waveform transformation tasks when measuring the FMR spectra at the Hₐₚₚ and −1.2 mT. MSE values are between 1.39-54.3×lower when measuring at Hₐₚₚ due to additional non-linear field-dependent shifts in mode frequency. Supplementary table 2: Comparison of MSE values for Mackey-Glass prediction when measuring the FMR spectra at the Hₐₚₚ and −1.2 mT. MSE values are 5.39 and 1.39×lower for t+1 and t+10 predictions respectively when measuring at Hₐₚₚ due to additional non-linear field-dependent shifts in mode frequency.

FIGS. 19A-19C: Artificial spin reservoirs. Panels a-e show a square artificial spin ice where bars host only macrospin states (MS-ASI). Panels f-j show a width-modified high density square (WM-ASVI) comprising two subsets of nanomagnets (one wide, one thin) arranged in a square geometry. Wide-bars host both macrospins and vortices. Panels k-o show a pinwheel artificial spin-vortex ice. Bar dimensions vary across the sample giving both magnetic and structural complexity. Bars can host macrospins, vortices and more complex structures. SEM images of the three samples are shown in a,f and k respectively. Ferromagnetic resonance (FMR) heatmaps of all samples in a demagnetised state are shown in panels b,g and l. MS-ASI (b) displays linear macrospin frequency-shifts with field. WM-HDS (g) exhibits a mixture of two linear macrospin frequncy-shifting modes at 6-7 GHZ (wide-bar) and 8-9 GHz (thin-bar) and a non-linear χ-shaped vortex mode between 2-6 GHz. PW-ASVI (l) exhibits a host of non-linear vortex modes. c,h and m) Spectral evolution of three samples when subject to a sinusoidal input where each data point is a minor field loop. c) MS-ASI shows two modes corresponding to bars aligned with and against the applied field. WM-ASVI (h) shows two dominant modes corresponding to the wide-(low-f) and thin-bar (high-f) resonances. The vortex mode is not detected at measurement fields between 18-23.5 mT. Modes shift linearly with applied field. The Wide-bar mode displays non-linear amplitude changes which lag with respect to the applied field due to macrospin/vortex conversion. PW-ASVI displays a range of modes with non-linear frequency-shifts and amplitude changes. MFM images show the saturated state (d,i,n) and demagnetised state (e,j,o). In the saturated state, all samples contain only macrospins. In the demagnetised state, WM-ASVI and PW-ASVI (j and o) show vortices.

FIGS. 20A-20H: Individual reservoir computational performance. Panel a shows a schematic of the single reservoir computation scheme. Scaled data is input into each reservoir by applying a minor field loop (+Hₐₚₚ then −Hₐₚₚ). The FMR output spectra is measured at −Hₐₚₚ. FMR amplitude of all frequency bins are used as computational outputs. Panel b shows memory capacity (MC) and non-linearity (NL) of the reservoirs. Vortices produce high MC (WM-ASVI, PW-ASVI). FMR spectra dominated by vortex modes produces high NL (PW-ASVI). Panel c shows MSE when transforming a sine input to a variety of targets. For simpler tasks, vortices boost performance up to 38.8× compared to macrospin-only reservoirs. Panel d shows MSE when predicting future values of the Mackey-Glass equation. Better performance is seen for WM-ASVI with high MC and low NL arising from a mixture of non-linear vortex evolution and linear resonant frequency shifts. Panel e shows MSE when transforming to a NARMA model with Mackey-Glass input signal. X corresponds to how far back the NARMA model is evaluated on. Samples with higher memory perform better. d) and e) show a periodic MSE due to the periodic nature of the Mackey-Glass equation, indicative of a breakdown in reservoir performance and versatility. Panels f-k show predictions for each sample for tasks with varying degrees of complexity. Improvement factors when introducing vortices are displayed. For simple tasks (f,i) all reservoirs perform well. For intermediate tasks (g) the presence of vortices significantly aids performance. For challenging tasks (h,j,k) no single reservoir performs well.

FIGS. 21A-21E: Parallel reservoir computing. Panel a shows a schematic of the parallel architecture. Data is input to two separate reservoirs in parallel and their outputs (FMR spectra) are later combined for training and prediction. Panel b shows MC and NL for single and parallel combinations with 60 total outputs. Panel c shows MSE for single and parallel configurations when transforming a sine input. The number of outputs used from each reservoir are optimised to give the best performance. Also shown is the improvement factor between the best single and best parallel configuration. Up to ˜4×improvement is seen for the challenging sine (3×)+sine (2×) transformation. Mackey-Glass d) future predictions and e) NARMA MSE and improvement factors. Only 1.5×improvement is observed. Example predictions for the best single and best parallel reservoirs are shown for f) (k-1)(k-2), g) sine (3×)+sine (2×), h) sine (2×)−saw (2×), i) Mackey-Glass t+8 and j) NARMA5. The corresponding reservoir is labelled at the top right of each prediction plot.

FIGS. 22A-22F: Deep reservoir computing. Panel a shows a schematic of a deep reservoir computing architecture. Data is input to the first reservoir (R1) and the output spectra is measured. Specific outputs from the R1 are then scaled and input into the second reservoir (R2). The outputs of both reservoirs are then combined for training and prediction. Panel b shpws MC and NL of single, parallel and deep reservoir 5 architectures. A broad range of enhanced MC and NL is achieved MSE profiles for c-e) Mackey-Glass future prediction and f-h) NARMA when varying the ordering of reservoirs. Reservoirs are ordered from c,f) high MC to low MC, d,g) low MC to high MC, e,h) 3 layer series low MC to high MC. Better performance is seen when going from low to high MC. Example predictions are shown when predicting i) t+8 and j) NARMA5 for single and deep architectures. Predicted values closely follow the target waveforms and improvements of up to 6.86× are achieved.

FIGS. 23A-23E: Metric programming: Panels a-c show MS-ASI, WM-ASVI and PW-ASVI FMR amplitudes at the maximum field (orange) and minimum field (blue) of a Mackey-Glass period. MC of individual outputs evaluated from 0 to 7 previous steps. Different outputs remember different steps back. Total MC (black) and NL (red) of each individual frequency bin across each reservoir is shown. For MS-ASI (a) and WM-ASVI (b), MC is highest where FMR peaks and sub-harmonics are present. NL peaks at maximum and minimum points of peaks and regions where amplitude is zero. For PW-ASVI (c), MC is highest away from the main FMR mode (9-10 GHz). High NL is observed across the majority of the main resonant peak. For reservoirs connected in series, panels d-i show the relationship between the R1 output metrics and R2 metrics when R2 is (d,e) MS-ASI (f,g) WM-ASVI and (h,i) PW-ASVI. Black dotted lines represent linear fits. An approximately linear relationship between R1 output and R2 metrics are found with response depending on reservoir ordering. j-l) Show the MC and NL of the various deep combinations, colour-coded by MSE for tasks t+8 (j), t+13 (k) and t+15 (l). The lowest MSE is highlighted with a red circle. The optimum combination of MC and NL varies depending on the task. Metric programming allows for system reconfiguration for optimum task performance.

FIG. 24 shows combining multiple deep neural networks into a large architecture and optimising the outputs from each of them to get the best performance. Here, performances up to 10× are seen for Mackey-Glass.

FIGS. 25A-25F: Variation of dimensions across the MS-ASI (a,b) and PW-ASVI (c-f) samples.

FIGS. 26A-26H: Nonlinear waveform transformation tasks performed by three different nanomagnetic arrays showing the variation in computing performance (measured via MSE) for different nanomagnetic array designs. Input dataset of sine waves (sine(x)) are transformed to a range of target waveforms: (a) a hysteretic (k-1)(k-2) transformation, (b) Sine(2x), (c) Sine (3x), (d) Saw(x), (e) Saw(2x), (f) Sine(3x)Sine(x), (g) Sine(2x)−Saw(2x), (h) Sine(3x)+Sine(2x). The three different samples are ‘pinwheel’ ASVI (PW-ASVI), width-modified ASVI (WM-ASVI) and macrospin ASI (MS-ASI). Train (left column) and test (right column) datasets are shown.

FIGS. 27A-27J: The same three nanomagnetic arrays as FIGS. 26A-26H are used for a future prediction task of the chaotic oscillatory Mackey-Glass time-series. Train and Test datasets are displayed in the left and right columns respectively. Various amounts of future prediction are shown in the different panels (a) to (j): (a) Predicting one time-step into the future (t+1); (b) Predicting four time-steps into the future (t+4); (c) (t+6); (d) (t+8); (e) (t+10); (f) NARMA-processed t+1; (g) NARMA-processed t+3; (h) NARMA-processed t+5; (i) NARMA-processed t+7; and (j) NARMA-processed t+9.

FIGS. 28A-28H: Sine waveform transformations performed using parallel-architecture physical neuromorphic processors comprising two to three distinct nanomagnetic arrays operating in a parallel-processing mode. The nanomagnetic arrays used are labelled in bold, the target waveforms are as follows: (a) (k-1)(k-2) hysteretic transform; (b) Sine(2x); (c) Sine(3x); (d) Saw(x); (e) Saw(2x); (f) Sine(3x)*Sine(x); (g) Sine(2x)−Saw(2x); and (h) Sine(3x)+Sine(2x).

FIGS. 29A-29H: Sine waveform transformations performed using parallel-architecture physical neuromorphic processors comprising two distinct nanomagnetic arrays operating in a parallel-processing mode. Different combinations of nanomagnetic arrays are shown vs. FIGS. 28A-28H. The nanomagnetic arrays used are labelled in bold, the target waveforms are as follows: (a) (k-1)(k-2) hysteretic transform; (b) Sine(2x); (c) Sine(3x); (d) Saw(x); (e) Saw(2x); (f) Sine(3x)*Sine(x); (g) Sine(2x)−Saw(2x); and (h) Sine(3x)+Sine(2x).

FIGS. 30A-30J: Future prediction of chaotic Mackey-Glass time series performed using parallel-architecture physical neuromorphic processors comprising two to three distinct nanomagnetic arrays operating in a parallel-processing mode. The nanomagnetic arrays used are labelled in bold, the future prediction tasks are as follows: (a) T+1; (b) T+4; (c) T+6; (d) T+8; (e) T+10; (f) NARMA1; (g) NARMA3; (h) NARMA5; (i) NARMA7; and (j) NARMA9.

FIG. 31: Comparison of computing performance improvement factor (MSE increase) for a range of nonlinear sine waveform transformation tasks, comparing performance as varying amounts (0-200) of reservoir outputs are used for different parallel nanomagnetic array combinations.

FIG. 32: FMR amplitude, memory for different previous input points and NL for each output for all three reservoirs.

FIGS. 33A-33E: a) States of a nanodisk. b) Schematic of a STNO. c) Magnetic flux profiles when two STNO's are connected by a macrospin (top) and vortex (bottom). d) Resonance frequency of the two STNO's when connected by a macrospin (left) and a vortex (right). When connected via a macrospin, the two oscillators synchronise. When connected by a vortex, they do not synchronise.

FIG. 34: Logic gates with frequency input. Each input data is assigned a waveform and frequency which is then used to probe the array response and converted to logical outputs.

FIG. 35: Confusion matrix when predicting 12 vowels. Test success rate of 92.14% is achieved.

FIG. 36: Hand-written digit classification. Panel a shows a system schematic. A nanomagnetic array is patterned on top of a continuous magnetic underlayer. Panel b shows that data is input to the left region of the array and the right region is trained. Panel c shows spin-waves are excited and propagate in the magnetic underlayer. Panel d shows spin-waves focus on a set of probes and the probe with the maximum amplitude corresponds to the predicted digit.

### DETAILED DESCRIPTION

In the following, like parts are denoted by like reference numerals.

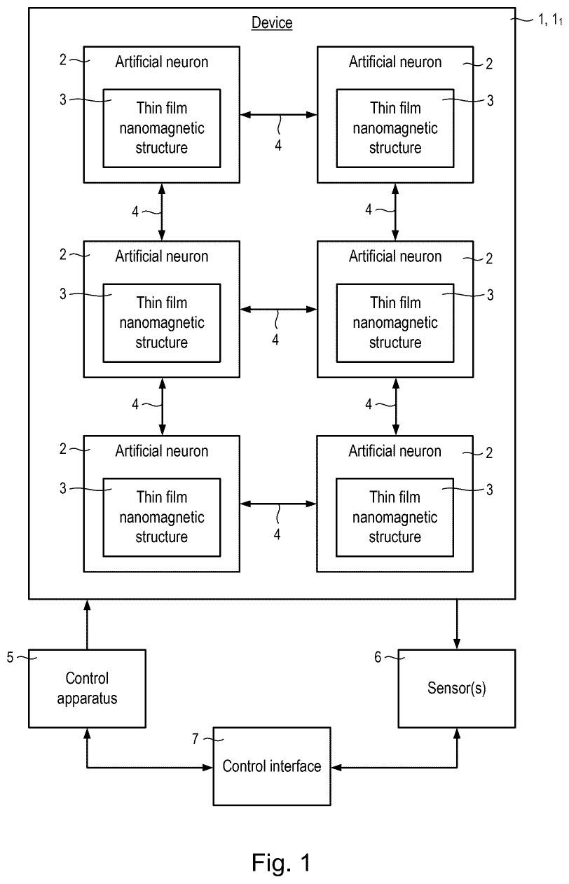

Referring to FIG. 1, a schematic diagram of a first example 1₁ of a device 1 for use as a physical neural network is shown (hereinafter the “first device”).

The first device includes a plurality of artificial neurons 2. Each artificial neuron 2 includes a ferromagnetic thin-film nanomagnetic structure 3 having a respective switchable magnetic state (not shown). The nanomagnetic structures 3 can be configured to provide artificial synapses 4. The first device is configured to receive input data from a control apparatus 5 and provide output data to one or more sensors 6. In some examples, the control apparatus 5 and/or the one or more sensors 6 can be controlled by a control interface 7.

Input data taking the form of field(s) provided by the control apparatus 5 can correspond to an input layer of a physical neural network. The nanomagnetic structures 3 can correspond to one or more hidden layers of a physical neural network. Output data taking the form of the measureable response(s) of the magnetic states can correspond to an output layer of a physical neural network.

In this way, the device can include intrinsic non-linearities and be suitable for use as, for example, a feed-forward neural network, or a recurrent neural network, or a convolutional neural network, or a trainable deep neural network, or a reservoir computing scheme.

In some examples, some or all of the artificial neurons 2 include only one nanomagnetic structure 3 (e.g., a nanomagnet), said nanomagnetic structure 3 having a switchable magnetic state. Some or all of the artificial neurons 2 may include two or more nanomagnetic structures 3. In the case that an artificial neuron 2 comprises two or more nanomagnetic structures 3, either some of the magnetic states may be pinned (i.e., not switchable) or all of the magnetic states may be switchable.

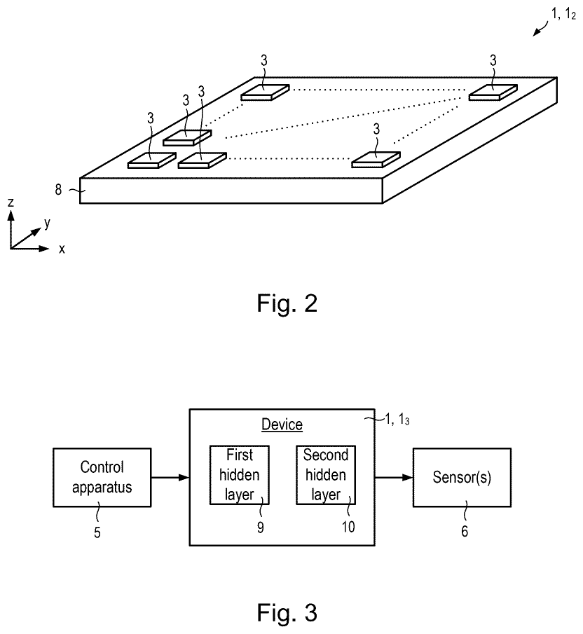

Referring also to FIG. 2, a portion of a second example 1₂ of a device 1 for use as a physical neural network is shown (hereinafter the “second device”). The features of the second device described hereinafter are equally applicable to the first device.

The second device is a specific example of the first device in which the in which the nanomagnetic structures 3 are disposed on a surface of a substrate 8 in a coplanar arrangement (i.e., within the same plane). In other examples, the nanomagnetic structures 3 can be arranged in a different way, for example the nanomagnetic structures 3 can instead be supported within a solid volume and/or arranged in a multiplanar arrangement. In coplanar arrangements the nanomagnetic structures 3 are offset in height from a surface of a substrate 8 or from a plane within a solid volume by the same amount relative to one another, whereas in (three-dimensional) multiplanar arrangements the nanomagnetic structures 3 are differently offset in height from a surface of a substrate 8 or from a plane within a solid volume, relative to one another (i.e., the nanomagnetic structures lying within a plurality of planes and instead of within a single plane).

In the second device, the nanomagnetic structures are arranged to define an array. In other examples, though, the nanomagnetic structures may be arranged randomly.

In the second device, though the array is defined by the arrangement of nanomagnetic structures 3, it is to be appreciated that not every site (alternatively point) in the array is required to be occupied by a ferromagnetic thin-film nanomagnetic structure having a switchable magnetisation. For example, at some sites in the array there may instead be thin-film nanomagnetic structure(s) having a different type of magnetic ordering, or ferromagnetic thin-film nanomagnetic structure(s) in which magnetisation is ‘pinned’ and not switchable into other energetically stable state(s), or indeed no ferromagnetic thin-film nanomagnetic structure(s) having a switchable magnetisation at all.

In the second device, the array of nanomagnetic structures is an ordered array. However, it is to be appreciated that in other examples the array that is defined by the nanomagnetic structures is disordered.

In some examples in which the array is ordered, the array is according to any one of the five 2D Bravais lattices, with a motif including one or more nanomagnetic structures 3. For example, the array may be arranged such that the nanomagnetic structures 3 are arranged to form an artificial spin ice or an artificial spin vortex ice. As will be described hereinafter, examples of an artificial spin-vortex ice include a width-modified artificial spin-vortex ice and a pinwheel artificial spin-vortex ice. As will be described hereinafter, in an artificial spin-vortex ice each magnetic state is a macrospin state or a vortex state. However, there is no requirement for the array to be ‘ice’ like, and the magnetic states can contain no vortices. In some examples, each magnetic state is one of a macrospin state, a vortex state, or has a different magnetic texture, such as a double vortex texture or a skyrmion texture.

In the case that the array of nanomagnetic structures 3 forms an artificial spin-vortex ice, at least some of the nanomagnetic structures 3 may be configured such that macrospin states and vortex states are energetically equivalent in those nanomagnetic structures 3. In some examples, at least some of the nanomagnetic structures 3 are configured to remain in macrospin states so as to provide a reconfigurable dipolar bias-field landscape and/or have magnetic states configured to direct vortex injection. As will be described hereinafter, the magnetic states can be non-volatile and have history dependent dynamics.

In other examples in which the array is disordered, the number density and/or dimensions and/or spacing of the nanomagnetic structures 3 differs across different portions of the array. In particular, the relative spatial position and angular alignment of nanomagnetic structures 3 may be randomly distributed. For example, the nanomagnetic structures 3 may be arranged to form an ‘artificial spin glass’ or an ‘artificial Hopfield network’.

The nanomagnetic structures 3 included in the array are either separated or in direct contact with each other. In some examples, the array of nanomagnetic structures 3 is supported upon or within a volume, with the nanomagnetic structures 3 spaced apart from each other. In other examples, the nanomagnetic structures 3 included in the array form a connected structure in which the nanomagnetic structures 3 are formed such that they are continuous at vertices. Examples of such a structure include a square or honeycomb lattice (alternatively mesh).

The nanomagnetic structures 3 may comprise or consist of an alloy, the alloy including: nickel and iron (for example, permalloy); and/or cobalt, iron, and boron (for example, CoFeB); and/or yttrium, iron, and oxygen (for example, yttrium iron garnet); and/or cobalt and platinum, (for example CoPt).

In some examples, pairs of artificial neurons 2 are configured to be coupled by dipolar coupling so as to define artificial synapses, each artificial synapse 4 having a trainable synaptic weight that is responsive to switching of the magnetic states or modification of spin-wave dynamics of one or more of the magnetic states.

Referring also to FIG. 3, a schematic diagram of a third example 1₃ of a device 1 for use as a physical neural network is shown (hereinafter the “third device”). The features of the third device described hereinafter are equally applicable to the first device and the second device.

The third device is a specific example of the first device and the second device in which a plurality of hidden layers are provided. The plurality of hidden layers include a first hidden layer 9 formed by the nanomagnetic structures 3 and a second hidden layer 10 which is formed in a different way (for example, with other nanomagnetic structures, or using a different neuromorphic hardware paradigm, or even in software). In other words, in some examples the nanomagnetic structures 3 of the first hidden layer 9 are arranged in a first arrangement and the second hidden layer 10 does not comprise a second plurality of nanomagnetic structures that are arranged in a second arrangement that is the same as the first arrangement. The plurality of hidden layers are connected in parallel, or in series, or in a hybrid arrangement combining series and parallel architectures.

The device 1 is shown as included in a system (hereinafter “the system”) that also includes a control apparatus 5 and one or more sensors 6. The control apparatus 5 is for generating a field to switch one or more of the magnetic states and/or exert control over spin-wave dynamics of one or more of the magnetic states. The one or more sensors 6 are for sensing a state of one or more of the magnetic states.

In some examples, the control apparatus 5 includes a magnetic field generator, an electric field generator, and/or an illumination apparatus.

In particular, the control apparatus 5 can allow for the generation of: a time-varying magnetic field for magnetic switching; and/or microwave excitation for microwave-assisted magnetic switching; and/or optical illumination for all-optical magnetic switching; and/or a locally applied magnetic field from a scanning probe for topological magnetic writing; and/or heat for heat-assisted switching; and/or a local field for application by a conventional hard disk read/write head; and/or a current-induced field from a nanostructure proximate to the nanomagnetic structures 3, for example a nanopatterned stripline.

Considering each of these in turn:

The time-varying magnetic field may have an amplitude, H, which encodes input data such as one-dimensional time series information, and may include a first portion of sweeping the field from 0 to +H to −H. In some examples, the time-varying magnetic field may be a minor loop. In other examples, the time-varying magnetic field may be a DC positive field with different amplitudes corresponding to different input values. In yet other examples, data may be encoded into the angle of the field around a 2D plane, with constant or varying amplitude. The time-varying magnetic field may be provided using an electromagnet such as a Helmholtz coil, or by a moving permanent magnet.

The microwave excitation may have an amplitude, waveform and/or frequency that encodes input data. This can allow for massively parallel data input, which the inventors have appreciated is important for complex computational tasks. If the microwave excitation has enough power, it can disturb/excite the nanomagnetic structures 3 to an extent to which they switch, i.e., microwave assisted switching, and/or exert control over (in other words, modifies) the spin-wave dynamics by linear or non-linear effects.

Optical illumination for all-optical magnetic switching all-optical magnetic switching may be applied using an illumination apparatus, such as a laser, for example a laser taking the form of a laser diode or a diode-pumped solid-state laser. In some examples, stage manipulation and/or beam deflection is used to address nanomagnetic structures 3 in the array. At least in this way, an image can be input to a first portion of an array and a second portion of the array can be trained.

Topological magnetic writing may be used to input data directly into magnetic states of nanomagnetic structures 3 using a scanning magnetic probe. This technique is described in detail in Gartside, J. C. et al. Realization of ground state in artificial kagome spin ice via topological defect-driven magnetic writing. Nat. Nanotechnol. 13, 53-58 (2018).

Heat assisted switching may be used to switch the magnetic states of nanomagnetic structures 3. Heat assisted switching may be driven by local or global magnetic fields, and localised heating produced by direct illumination with a laser, or by the use of a laser and a near field transducer, in a manner similar to Heat Assisted magnetic Recording (HAMR) hard disks.

A conventional hard disk read/write head may be used to apply a local field for switching magnetic states.

Finally, patterned nanostructures (for example, striplines) may be configured to provide current-induced Oersted fields for locally switching nanomagnetic structures 3.

Each of these options for switching the magnetic states are equally capable of exerting control over the spin-wave dynamics.

In each of the examples having a local (instead of global) input, data can allow data to be input spatially and then the system continually ‘clocked’ (i.e., provided with energy so it can evolve) either thermally or with an applied field. The evolution of the magnetic states in the system can then be monitored. Data can propagate through the first physical neural network via state switches (mediated by dipolar coupling alone, or by dipolar coupling plus an external clocking, for example either field or laser input, or by probabilistic switching) or spin-wave (i.e., magnon) detection and propagation to the next layer.

The control apparatus 5 is for controlling a physical neural network (that may be trained or untrained). In some examples, the control apparatus 5 is for training a physical neural network (that may be trained or untrained).

In particular, a first sensor belonging to the one or more sensors 6 may be configured to perform ferromagnetic resonance measurements, or magneto-optical Kerr effect measurements, or electrical measurements such as magneto-resistance or Hall effect measurements.

A FMR spectrometer can be used to measure the output of the device 1, and/or can be configured to perform broadband FMR measurements.

When performing FMR measurements, the device 1 may be disposed on a coplanar waveguide (not shown) which is connected to a microwave generator (i.e., an electric/magnetic field generator) and configured to couple RF magnetic fields to the device. The coplanar waveguide may have a longest dimension of less than 1 mm. Alternatively, micron-sized waveguides having a longest dimension of less than 1 μm may be fabricated in contact with the nanomagnetic structures 3, these micron-sized waveguides configured to provide spatial readout and/or frequency readout of magnetic states. The micron-sized waveguides can be fabricated in direct contact with the nanomagnetic structures 3 to allow for local readout of magnetic states.

The FMR spectrometer can be configured to measure artificial spin ice vertex-type populations and/or domain sizes. The device can be configured such that matrix multiplication is achievable through ferromagnetic resonance (FMR) differential measurement.

In other examples, the output of the device is measurable based on the magneto-optic Kerr effect (MOKE). In this scheme, the magnetisations of individual nanomagnetic structures 3 may be read out as individual outputs using small spot sizes, or the magnetisations of groups of nanomagnetic structures 3 in one area may be read out by using larger spot sizes. Magnetisations read out may subsequently be used for a final regression.

The sensor 6 may be configured to sense a weighted combination of magnetic states from two or more different nanomagnetic structures 3. The weights of the weighted combination are modifiable and for training.

In yet other examples, the output is be measured by electrical measurements such as magneto-resistance or Hall effect measurements. In this scheme, nanomagnetic structures 3 are configured to be probed electrically. By probing the resistance at multiple points, magnetic states across the physical neural network can be read out. Individual nanomagnetic structures 3 may be joined together across a vertex using a contact, for example, a gold contact, so that they are electrically connected but not magnetically connected, such that they would each retain their magnetic behaviour.

The device 1 described herein may be for neuromorphic computing, and/or inference based computing, and/or logic based computing (e.g., for use as a logic gate). The device 1 may be configured to process standing wave/travelling wave information where functionality is achieved by writing of magnetic states.

In some examples, the device 1 may further comprise a mask for masked training, the mask positioned between the control apparatus 5 and the nanomagnetic structures 3.

In some examples, data for network processing is stored in the device 1 in the form of magnetic states and/or spin-wave excitation. In other examples, data for network processing may be stored externally, for example in an external memory cache (not shown) connected to the control interface 7.

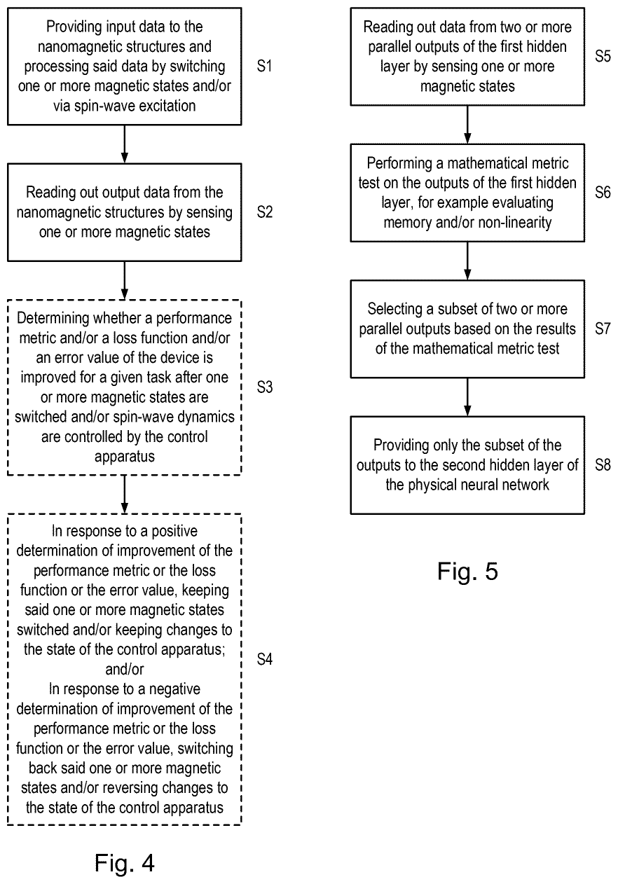

Referring to FIG. 4, process flow diagram illustrating a first example of a method (hereinafter the “first method”) of operating the device 1 or the system.

The first method includes providing input data to the nanomagnetic structures and processing said data by switching one or more magnetic states and/or via spin-wave excitation, and reading out output data from the nanomagnetic structures by sensing one or more magnetic states. Input data can be provided by the control apparatus 5 and output data read out by the one or more sensors 6. In particular, spin-wave excitation can include application of an RF-field and/or RF or DC electrical current and/or optical excitation by the control apparatus 6.

In some implementations the method is a method of training the physical neural network, and also includes determining whether a performance metric and/or a loss function and/or an error value of the device 1 is improved for a given task after one or more magnetic states are switched and/or spin-wave dynamics are controlled by the control apparatus 5, in response to a positive determination of improvement of the performance metric or the loss function or the error value, keeping said one or more magnetic states switched and/or keeping changes to the state of the control apparatus 5, and/or in response to a negative determination of improvement of the performance metric or the loss function or the error value, switching back said one or more magnetic states and/or reversing changes to the state of the control apparatus 5.

In some implementations, the method of training is performed using an algorithm that is random or recursive, for example by using backpropagation or by using a gradient descent technique or by using an evolutionary or genetic search algorithm and/or a regression algorithm including ridge or linear regression. In the case that the training is performed using ridge regression, the training may be performed via matrix multiplication.

Alternatively, manual tuning of trainable network weights may be performed by using the input.

As will be described hereinafter, the training may include considering only output data at a first timestep, i.e., with no time-multiplexing or software memory needing to be employed and all memory effects occurring physically within a reservoir (for example, an artificial spin-vortex ice reservoir), meaning that no storage of past reservoir responses is required for inference after training is complete. This can allow for reduced memory cost and processing time.

Referring also to FIG. 5, process flow diagram illustrating a second example of a method of operating the device 1 or the system shown (hereinafter the “second method”). To perform the second method, the device 1 is required to include two hidden layers.

The second method includes reading out data from two or more parallel outputs of the first hidden layer by sensing one or more magnetic states (preferably using the sensor(s) 6), performing a mathematical metric test on the outputs of the first hidden layer (for example, evaluating memory and/or non-linearity), selecting a subset of the two or more parallel outputs based on the results of the mathematical metric test, and providing only the subset of the data read out from the two or more parallel outputs of the first hidden layer to the second hidden layer.

In some examples, the system is for use as a reservoir computing scheme and the first hidden layer may be a first reservoir layer. The second hidden layer may be a second reservoir layer. The inventors have found that if the output of the first reservoir has a high memory, so does the second reservoir. The inventors have also found that if the output of the first reservoir has a high non-linearity, so does the second reservoir. This relationship can allow the entire system to be effectively programmed to have a certain combination of memory and non-linearity, making the entire system more versatile.

In particular, a mathematical metric test may be performed on each parallel output (e.g., on each frequency bin for the FMR), and the outputs selecting the highest metric test performances may be selected (metric tests include nonlinearity, memory capacity & complexity). The time-varying response of these outputs may then be used as the input datastream to the next reservoir in the series.

To calculate the memory and non-linearity: first, take the time-series of a single output of the first reservoir and put it through a set of equations, then select which output has a certain memory and nonlinearity, and finally feed that into the second reservoir.

Information from one reservoir layer to the next may be encoded in magnetic states or spin-wave response. Transfer of information from one reservoir layer to the next may be trained. Readout may come from one, some, or all of the reservoir layers.

A computer program may be provided which includes instructions that, when executed by a one or more processors, causes the computing device to perform the first method or the second method. Said computer program may be sorted in a computer-readable medium of a computer program product. A module may be provided which is configured to perform the first method or the second method. The module may be a hardware module. The module may be included in a monolithic integrated circuit which also includes a processor subsystem including at least one processor and memory. A system may be provided which includes the device 1 or the system, along with the integrated circuit, the integrated circuit arranged to control the magnetic states.

Specific studies are now presented.

### Reconfigurable Training and Reservoir Computing in an Artificial Spin-Vortex Ice Via Spin-Wave Fingerprinting

Described herein is the first experimental demonstration of reservoir computing in an artificial spin system. Reservoir computing is motivated by the vast energy spent during training of a deep neural network (DNN). DNN's comprise many layers with a huge amount of interconnections (weights). In DNN's, the number of trainable parameters can be up to 10⁸. Reservoir computing schemes remove the hidden layers of a DNN and replace it with a fixed reservoir layer which has random connections. These connections are not trained. Instead, in reservoir computing schemes only the output connections are trained.

### Introduction

Strongly interacting artificial spin systems are moving beyond mimicking naturally occurring materials to emerge as versatile functional platforms, from reconfigurable magnonics to neuromorphic computing. Typically, artificial spin systems comprise nanomagnets with a single magnetization texture: collinear macrospins or chiral vortices. By tuning nanoarray dimensions the inventors have achieved macrospin-vortex bistability and demonstrated a four-state metamaterial spin system, the ‘artificial spin-vortex ice’ (ASVI). ASVI can host Ising-like macrospins with strong ice-like vertex interactions and weakly coupled vortices with low stray dipolar field. Vortices and macrospins exhibit starkly differing spin-wave spectra with analogue mode amplitude control and mode frequency shifts of Δf=3.8 GHz. The enhanced bitextural microstate space can give rise to emergent physical memory phenomena, with ratchet-like vortex injection and history-dependent non-linear fading memory when driven through global magnetic field cycles. The inventors have employed spin-wave microstate fingerprinting for rapid, scalable readout of vortex and macrospin populations, and appreciated that this can be leveraged this for spin-wave reservoir computation. ASVI can perform non-linear mapping transformations of diverse input and target signals in addition to chaotic time-series forecasting.

In the present specification, by tailoring nanoelements such that Ising and vortex states are energetically equivalent, the inventors present artificial spin-vortex ice (ASVI), a four-state, bitextured spin system comprising two Ising-like macrospin orientations and two vortex chiralities. In the present specification, ASVI is defined as a strongly interacting nanomagnetic array. The strong interactions between Ising-like macrospins favour ice rule configurations, whereas vortices exhibit flux closure patterns with low stray dipolar field.

The bistable texture can drive emergent physical memory properties. Vortices are stable to higher magnetic field than macrospins (all references to ‘field’ in this part of the specification refer to magnetic field unless otherwise stated), allowing ratchet-like vortex population control. Low vortex stray field modifies the dipolar field landscape, by pinning or promoting the reversal of adjacent bars. This can be leveraged for local control of memory and switching dynamics via complex, non-linear, vortex population control protocols. The array described herein incorporates thinner bars, tuned for macrospin stability, providing a reconfigurable bias field that exerts control over vortex injection dynamics.

Magnons are highly sensitive to magnetic texture, and bistable ASVI textures can offer deep magnonic reconfigurability, with a frequency shift of Δf=3.8 GHz between vortex and macrospin modes and highly non-linear vortex field gradients. The inventors demonstrate here fine analogue tuning of mode amplitudes via vortex injection, affording exceptional levels of spectral control and reconfigurability relative to existing reconfigurable magnonic crystals. The inventors employed spin-wave microstate fingerprinting for vortex/macrospin population readout and rapid, scalable measurement of physical memory effects. Reference is made to Vanstone, A. et al. Spectral-fingerprinting: Microstate readout via remanence ferromagnetic resonance in artificial spin systems. arXiv preprint arXiv: 2106.04406 (2021). The non-volatility of nanomagnetic states combined with history-dependent dynamics results in a ‘fading memory’, that is, the system gradually ‘forgets’ prior inputs when exposed to new data (here via global field loops), a key requirement for RC. The inventors used the physical memory and spin-wave properties of ASVI to realize a spin-wave reservoir computation scheme free from the need to electrically address individual reservoir elements. The inventors have demonstrated the learning of linear and non-linear signal transformations and chaotic time-series forecasting. The inventors have observed strong computational performance when employing length-constrained training datasets (here 200-400 points, 500-900 is typical) to reflect real-world, device-based applications such as smartphones, space exploration and internet of things with strict constraints on battery life and data capture.

### Artificial Spin-Vortex Ice

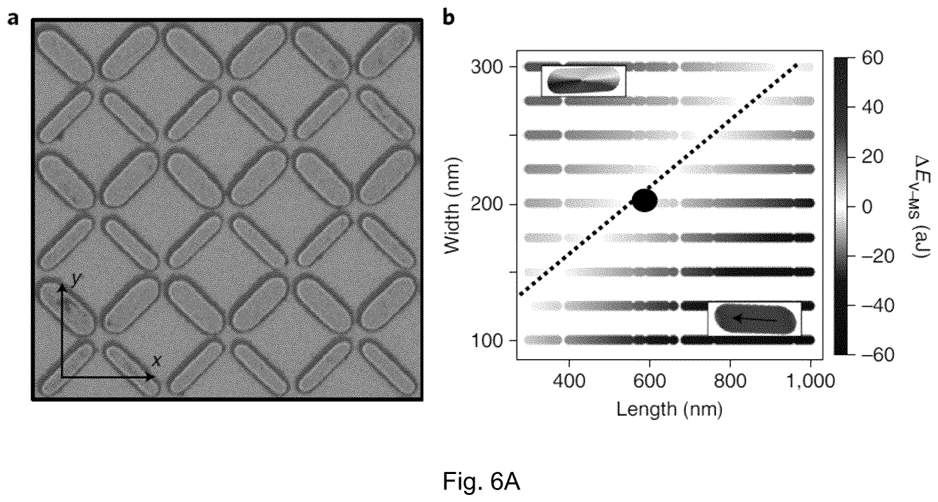

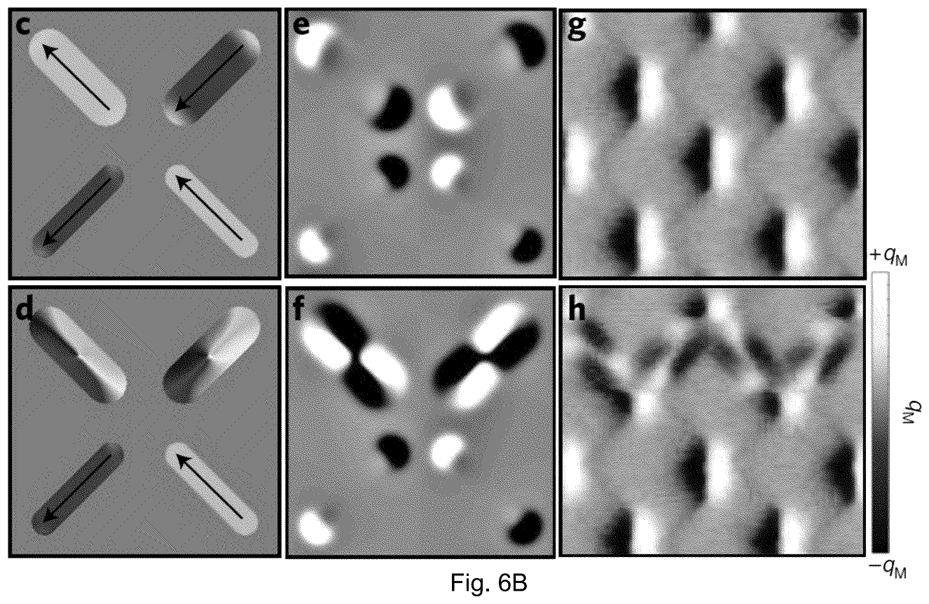

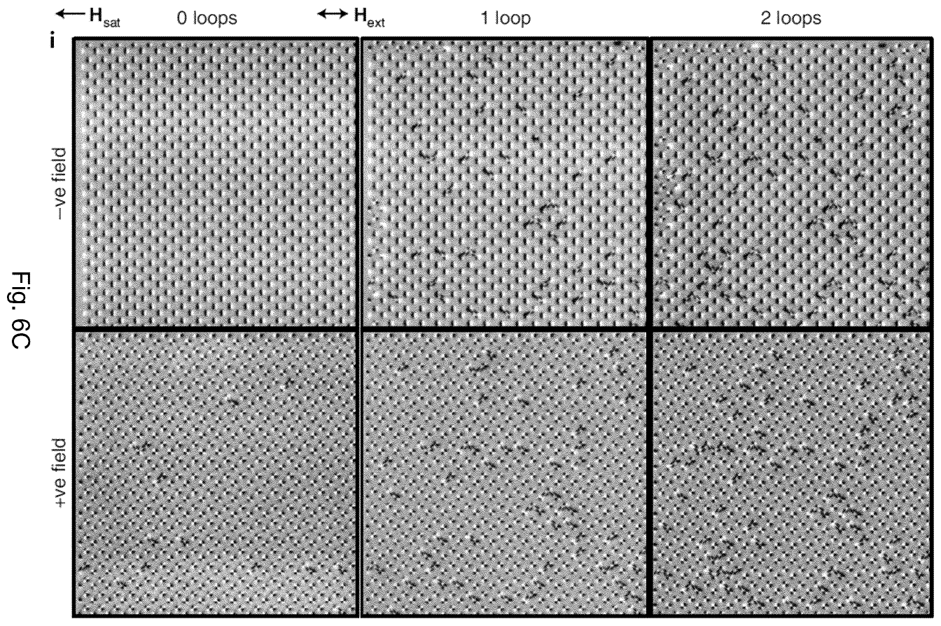

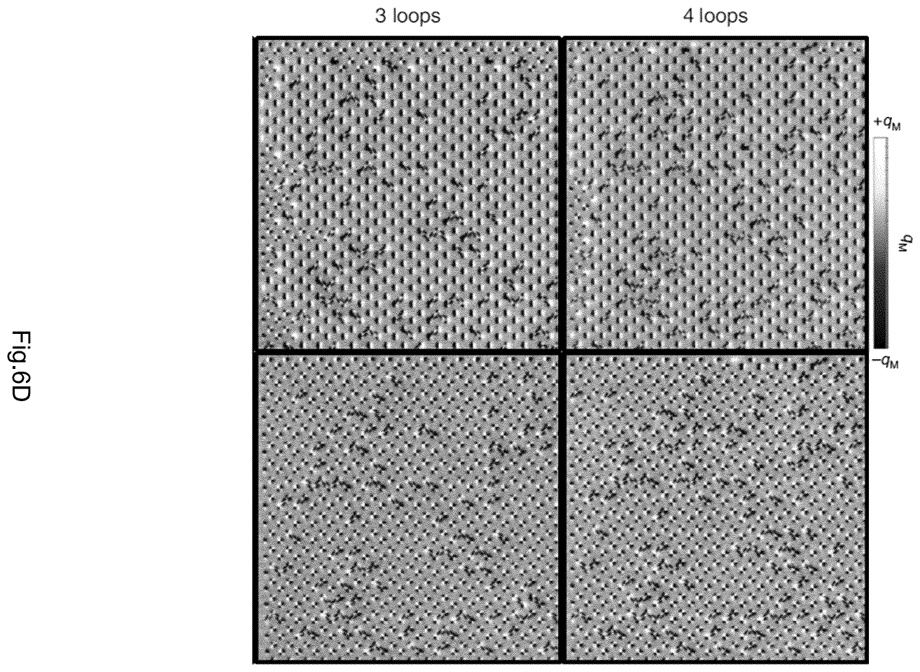

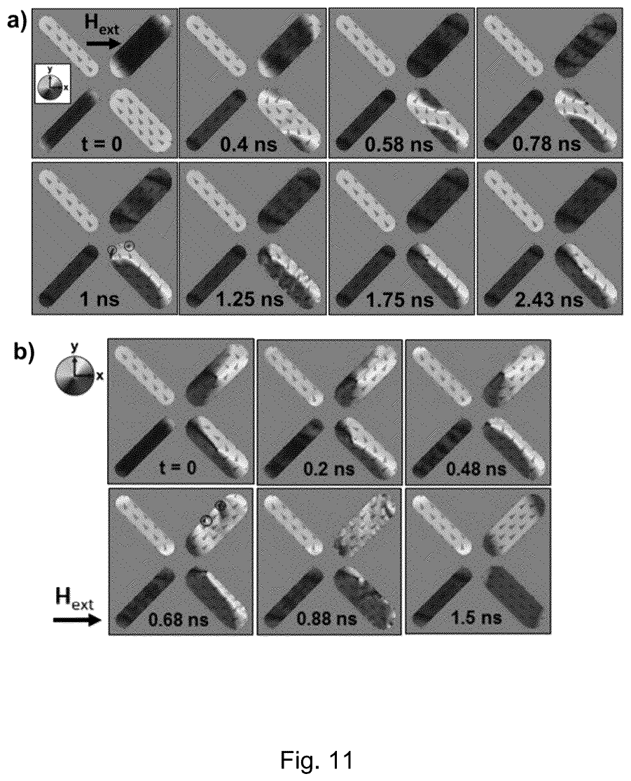

The ASVI described herein was based on square-lattice artificial spin ice (ASI) with alternating rows of thin and wide bars along & (FIGS. 6A-6D panel a)). Different coercive fields for thin and wide bars permit global-field microstate control, as described previously. Reference is made to Gartside, J. C. et al. Reconfigurable magnonic mode-hybridisation and spectral control in a bicomponent artificial spin ice. Nat. Commun. 12, 2488 (2021). Bars were permalloy, 600 nm long, 200 nm (wide bar) or 125 nm (thin bar) wide and 20 nm thick, with a 100 nm vertex gap (bar end to vertex centre). Along \hat{x}, the wide-bar coercive field distribution H_{c1} was 15.5-17 mT, and the thin-bar coercive field H_{c2} was 26-29 mT. The wide-bar dimensions were chosen such that the combined demagnetization and exchange energy of the macrospin state were equal to the vortex state (determined via micromagnetic simulation, FIGS. 6A-6D panel b), giving macrospin and vortex bistability. The ASVI considered here was bicomponent, with the macrospin-vortex transition occurring in wide bars. The thin bars remained in macrospin states to provide a reconfigurable dipolar bias-field landscape. FIGS. 6A-6D panels c,d) shows MuMax3 magnetization simulations of a single ASVI vertex with all-macrospin states (FIGS. 6A-6D panel c)) and wide-bar vortex, thin-bar macrospin states (FIGS. 6A-6D panel d)), with the corresponding simulated magnetic force microscope (MFM) images presented in FIGS. 6A-6D panels e-f), respectively. Vortex bars exhibit a characteristic ‘checkered’ pattern under a MFM, with diagonally opposite quadrants of positive (white) and negative (dark) magnetic charge. The relative orientations of dark and light MFM contrast quadrants allow vortex chirality readout (the opposite chirality magnetization states in FIGS. 6A-6D panel d) have opposite MFM contrast checkerboards in FIGS. 6A-6D panel f)). The reservoir computation scheme described here is unaffected by vortex chirality. FIGS. 6A-6D panels g,h) shows experimental MFM images of all-macrospin states (FIGS. 6A-6D panel g)) and a vortex chain in an otherwise macrospin state (FIGS. 6A-6D panel h)). The vortices are slightly distorted in the experimental MFM image relative to the simulation, due in part to tip-sample interactions favouring attractive (dark) over repulsive (light) interaction. A detailed study of the vortex formation process is provided in Supplementary Note 1.1 and FIG. 11.

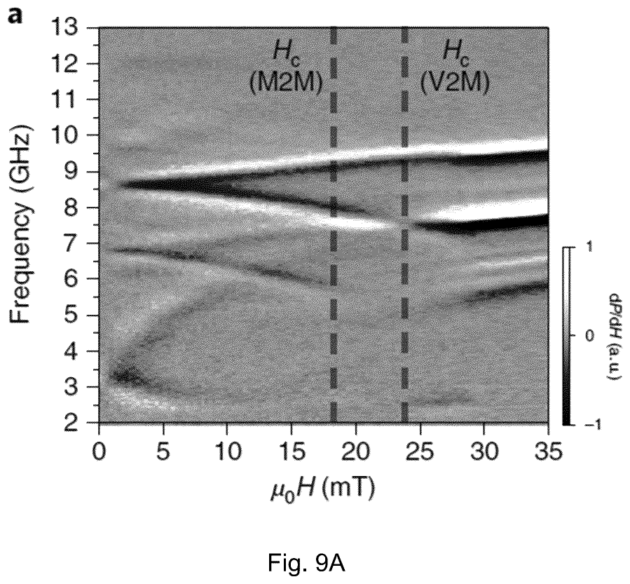

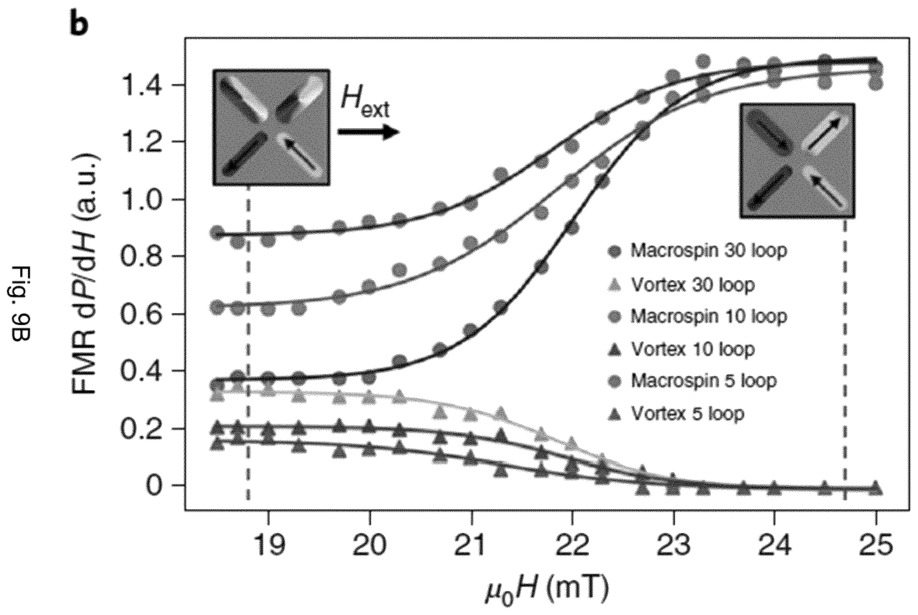

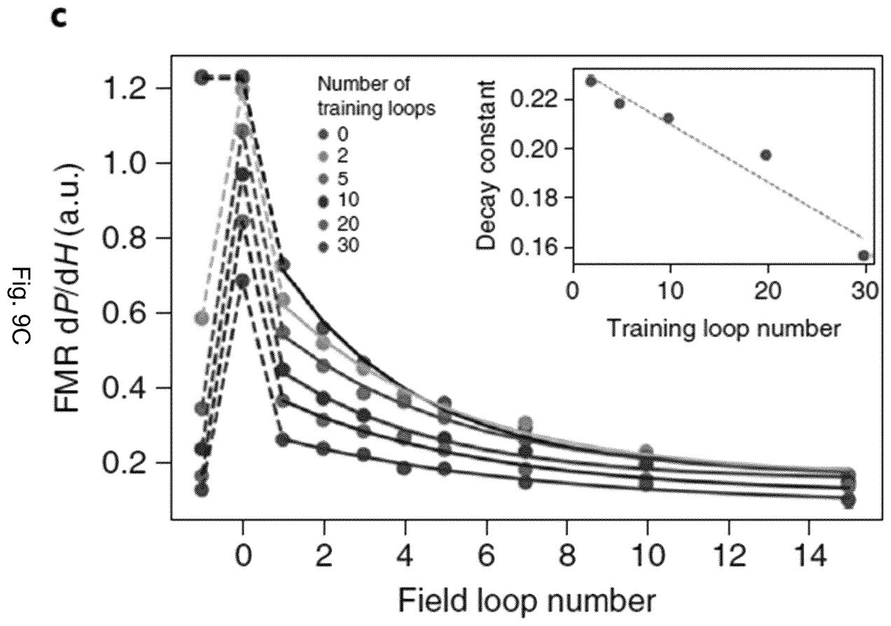

To study how vorticization progresses during field cycling, FIGS. 6A-6D panel i) shows a series of MFM images, where an all-macrospin, −\hat{x}-saturated ASVI state (top left panel) was subjected to four sequential ±18 mT \hat{x} minor field loops and imaged after each field application. The value of 18 mT was chosen such that thin bars never reverse, while wide bars reverse each field application, save for those becoming pinned via local microstate-dependent dipolar-field textures (for example, the left and top edges of the 3-loop, negative field panel in FIGS. 6A-6D panel i). The value of 18 mT is below the vortex-to-macrospin (V2M) conversion field (20 mT for the relative applied field Hₐₚₚ and array orientation here), creating a ratchet effect where some macrospins convert to vortices each loop, but not vice versa, increasing the vortex population throughout field cycling. V2M conversion is examined further in FIGS. 9A-9C. For clarity, when describing ‘saturated’ ASVI states, this part of the present specification refers to the remanent state after applying a global magnetic field (typically Hₛₐₜ=200 mT) such that all nanoislands are in a macrospin state, magnetized along the field axis (for example, see the top left panel of FIGS. 6A-6D panel i)).

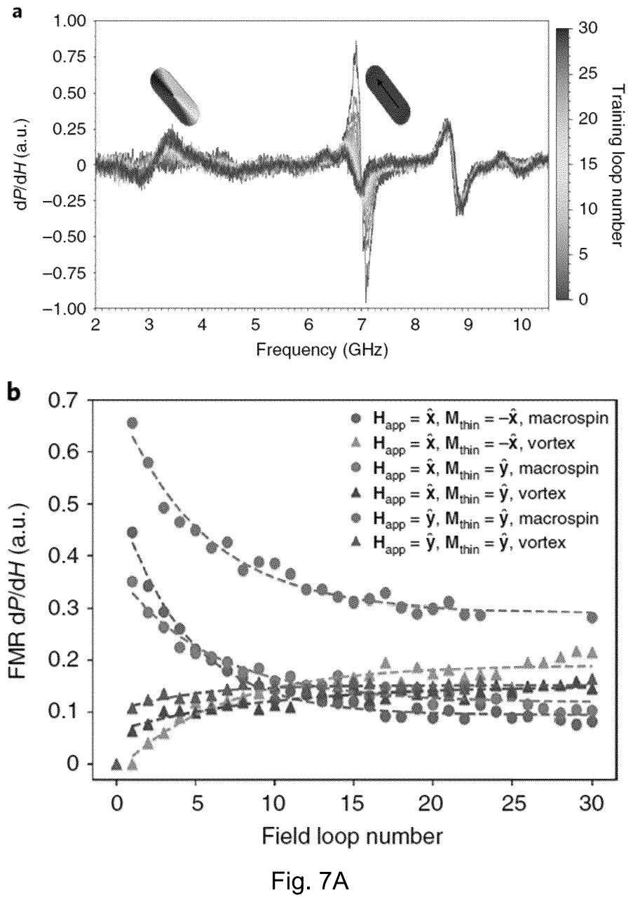

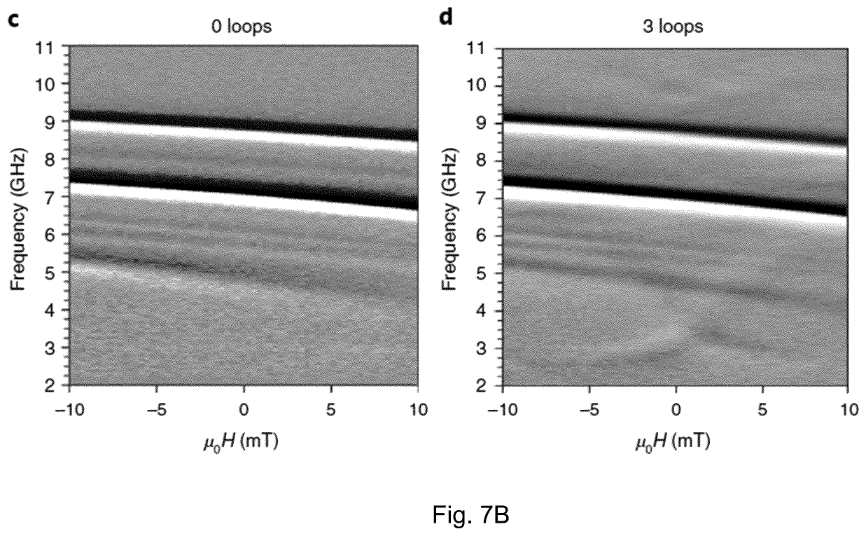

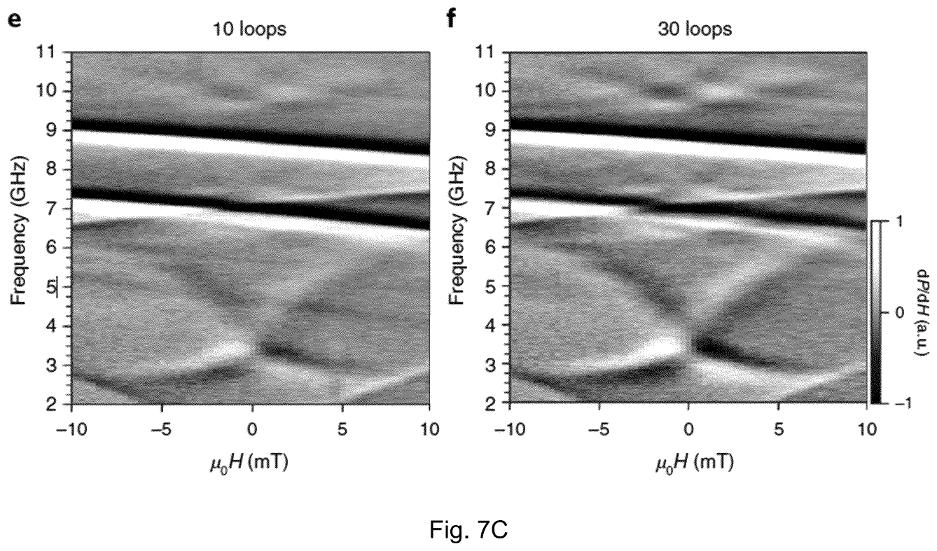

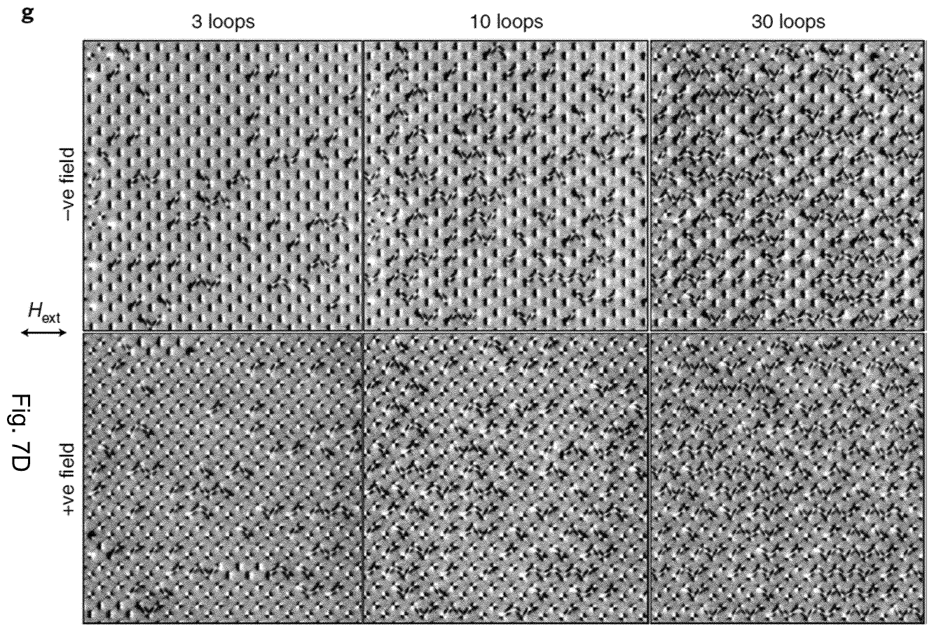

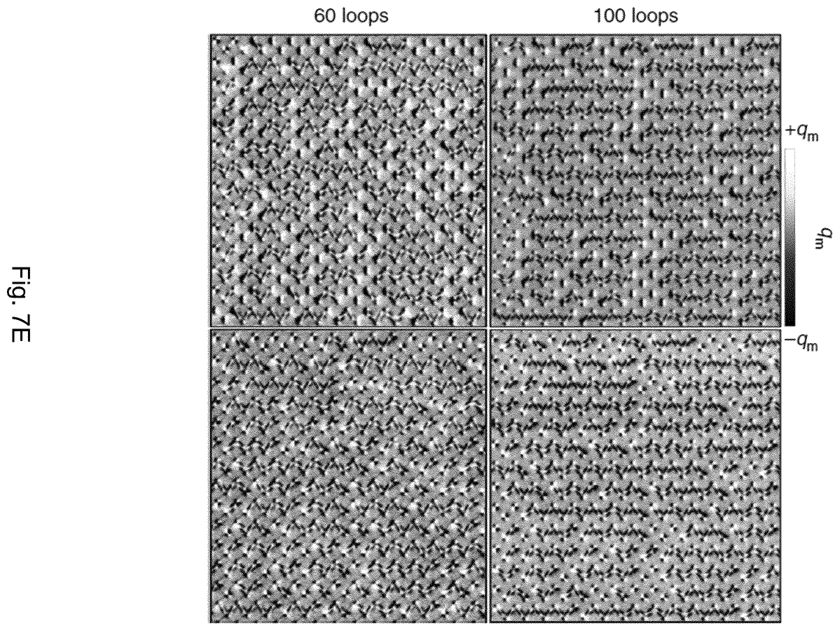

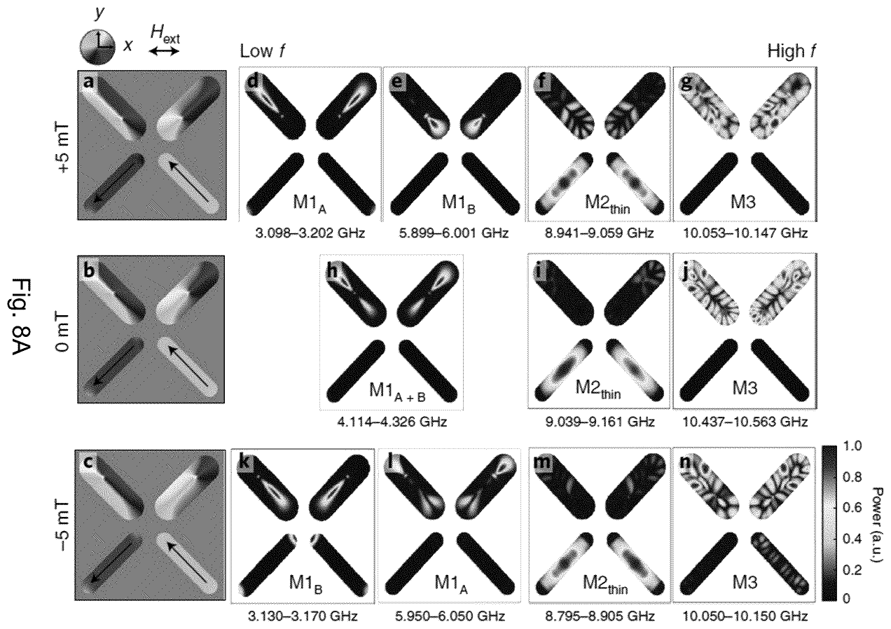

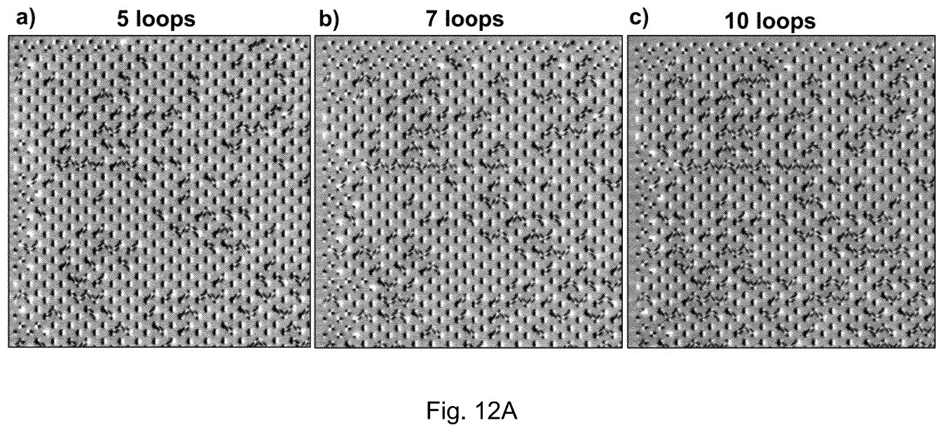

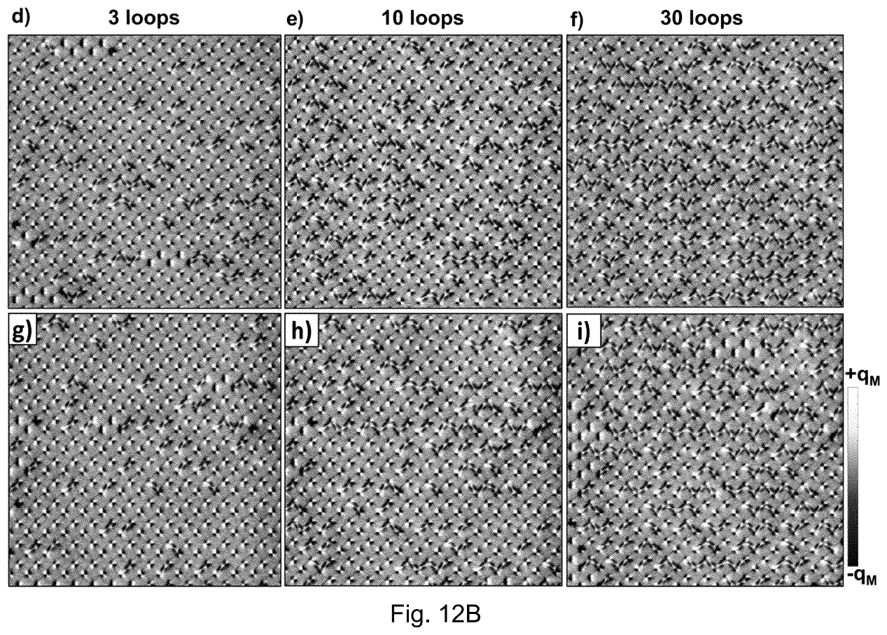

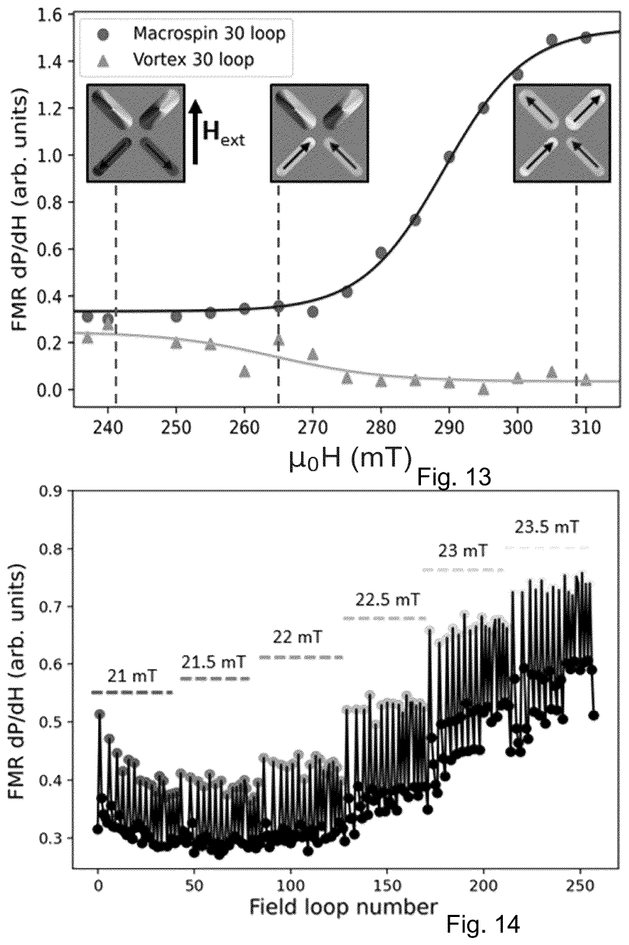

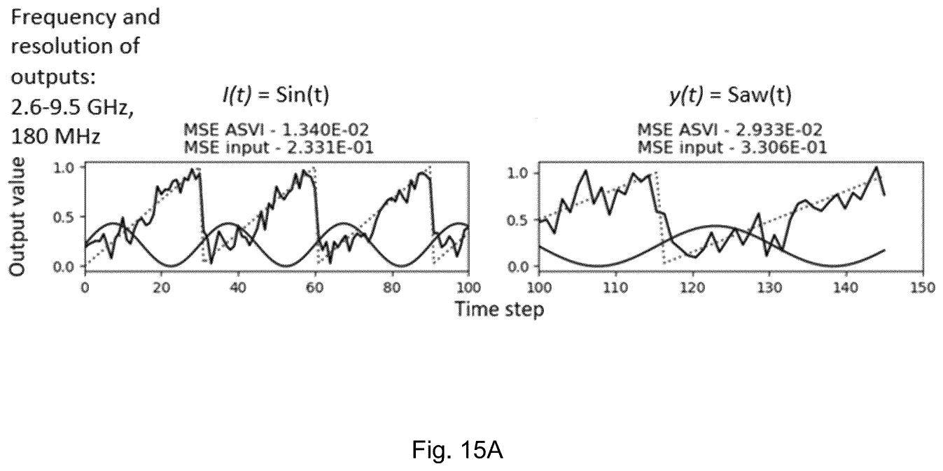

Vortices initially appear with stochastic placement (FIGS. 6A-6D panel i), 0 loop, positive (+ve) field). As field cycling progresses, vorticization occurs preferentially adjacent to existing vortices. This is due to the low dipolar field emanating from vortex bars causing asymmetry in the local dipolar-field texture and increasing the likelihood of asymmetric field torque on Q_{T}=+½ defects during switching where Q_{T} is the topological charge. This local promotion of vorticization leads to the formation of vortex and macrospin domains, with defined domain structures taking shape by loop 4 (+ve field image) and are clearly observed as field cycling continues to 5-10 loops (FIGS. 12A-12B and Supplementary Note 1.2) and higher loop numbers (FIGS. 7A-7E panel g)). A higher vorticization probability is observed when moving from positive to negative field, with 3.05% macrospins vorticizing per loop compared with 1.34% when switching from negative to positive. As mentioned above, this is due to different microstates and dipolar-field landscapes between field polarities. Thin bars remain magnetized along −\hat{x}, while wide bars reverse, hence negative fields place macrospins in ‘type 2’ spin ice states (0 loop, −ve field panel, FIGS. 6A-6D panel i)), while positive fields give ‘type 1’ or ground states (macrospins in 0 loop, +ve field panel, FIGS. 6A-6D panel i)). The two states have differing dipolar-field landscapes: in the type 2 state, wide and thin bars are magnetized the same way, giving a symmetric dipolar field at the vertex, while the type 1 state has oppositely magnetized wide and thin bars, which gives an unbalanced dipolar-field texture due to the stronger dipolar field of the wide bar. Again, this is more likely to give unbalanced field torques on Q_{T}=+½ defects, driving them to combine to a Q_{T}=+1 vortex state.

To demonstrate vorticization stochasticity, the inventors compared three separate but identical field-cycling sequences, each beginning from saturated all-macrospin states. FIGS. 6A-6D panel i) and FIGS. 7A-7E panel g) and FIGS. 12A-12B show different vortex locations and domain structures forming on the same array area, confirming vorticization is a stochastically dominated process, rather than determined by nanofabrication imperfections termed ‘quenched disorder’, which would favour spatially similar domain patterns each field-cycling sequence.

### Reconfigurable Spin-Wave Spectra and Vortex State Evolution

It was observed via MFM analysis with single-bar resolution how vorticization occurs. MFM is an intrinsically slow process, each image taking 10-30 min with scan windows limited to ˜10-100 μm. MFM analysis requires cumbersome mechanical apparatus, unsuitable for device integration. Ferromagnetic resonance (FMR) has emerged as a rapid, scalable on-chip microstate readout technique well-suited to strongly interacting nanomagnetic arrays. While not providing single-spin, exact microstate resolution, FMR can elucidate fine microstate details, including ASI vertex-type populations and domain sizes, unavailable via, for example, magneto-optic Kerr effect (MOKE) or vibrating sample magnetometry. Here, the inventors employed FMR to spectrally fingerprint mixed vortex-macrospin states.

The inventors analysed mode frequencies f following the Kittel equation

$$f = \frac{{μ}_{0} γ}{2 π} \sqrt{H ( H + M )}$$

in the k=0 limit applicable to this work, where γ is the gyromagnetic ratio and H=Hₐₚₚ+H_{loc}, where Hₐₚₚ is the globally applied field, H_{loc} is the local dipolar field of the nanomagnets, k the magnon wave vector and μ₀ the vacuum permeability. The local dipolar-field landscape varies greatly as vortex injection progresses, resulting in distinct microstate-dependent magnon spectra. To focus on the effects of vortex injection on the microstate and vortex population, spectra were measured at a consistent small bias field, chosen for good vortex mode signal-to-noise. All spectral differences may therefore be attributed to microstate changes and the corresponding shifts in H_{loc}. Broadband FMR spectra were measured in differential dP/dH mode with 10 MHz frequency resolution (P and H are the spin-wave power and applied field, respectively), with the samples excited by a millimetre-scale coplanar waveguide.

FIGS. 7A-7E panel a) shows differential FMR spectra measured after the negative-field arm of each ±18 mT loop over a 30-loop field-cycling sequence. The initial 0 loop state is a −\hat{x} saturated, all-macrospin state and exhibits two modes, a wide-bar macrospin mode at 7 GHz and a thin-bar macrospin mode at 8.8 GHz. As field cycling progresses along \hat{x}, the wide-bar mode decreases in amplitude as vortex injection converts macrospins to vortices. The wide-bar macrospin mode frequency redshifts throughout field cycling as H_{loc} is reduced by increasing numbers of flux-closed vortices, shifting 0.4 GHz after 30 loops. Similarly the thin-bar mode is blueshifted 0.15 GHz. As the wide-bar macrospin mode decreases, a new vortex mode grows at 3.5 GHZ, with equal vortex and macrospin mode amplitudes by 10 loops and vortex-mode amplitude double the macrospin at 30 loops. Fine shifts in mode amplitude and frequency are observed throughout field cycling, demonstrating the capacity of vortex injection to tailor relative mode power and frequency and provide on-demand spectral reconfiguration with more subtle, analogue-style control available than via the reconfiguration of entire microstates. The correspondence of mode amplitude to vortex and macrospin populations demonstrates the applicability of ‘spin-wave fingerprinting’ to multi-texture spin systems. The FMR response of ASI subjected to minor loops was previously studied in a conventional all-macrospin system and can be a powerful method for interrogating array microstate dynamics without slow MFM imaging or expensive beamline or Lorentz transmission electron microscopy techniques.

So far thin bars have been considered as providing a static dipolar bias field. The inventors have appreciated that their magnetization states can be exploited as an extra degree of freedom and reconfigurably ‘direct’ vortex injection. FIGS. 7A-7E panel b) shows peak amplitude extractions of wide-bar macrospin and vortex modes over 30-loop field-cycling sequences for three distinct cases: wide and thin bars initially saturated along −\hat{x} as in FIGS. 7A-7E panel a), wide-bars saturated along −\hat{x} and thin bars along +ŷ, and wide and thin bars saturated along +ŷ. Field was applied along the wide-bar saturation axis in each case (that is, \hat{x}, \hat{x}, and ŷ, respectively). The macrospin mode amplitude is fitted with y=Ae^{-τ}^{ₘₛ}^{x}+c, with decay constant τₘₛ the macrospin mode evolution rate and c corresponding to the final macrospin population. The vortex mode amplitude is fitted as y=k−Be^{-τ}^{_{V}}^{x}, with τ_{V} the vortex mode evolution rate and k relating to the final vortex population. By mode evolution the present specification refers to the changing mode power caused by the gradual conversion of the macrospin population to vortices by repeated field cycling.

For all cases, distinct mode evolution rates and final vortex/macrospin populations were observed, showing the degree of control available from the thin bars and the sensitivity of vorticization to dipolar-field texture that can be provided. Thus, vortex-injection dynamics can be tailored via the reconfigurable bias field from the thin bars. While parallel thin-bar states were prepared with uniform field here, it is to be appreciated that one may locally prepare arbitrary thin-bar magnetization states to spatially texture vortex injection.

Exploring vortex-mode field evolution, FIGS. 7A-7E panels c-f) shows FMR heatmaps for 0-30 field-cycle states. For the 0 loop, all-macrospin state wide-bar (˜7 GHZ) and thin-bar (˜9 GHz) nanobar-centre localized modes are observed, alongside a higher-index thin-bar mode (˜8 GHZ) and three higher-index wide-bar macrospin modes (˜5, 6 and 6.5 GHZ). After three field cycles, new mode structures are observed, with a pair of sigmoid-like modes between 2.5 and 6.5 GHz forming a χ-shaped structure intersecting at +1 mT. These modes correspond to the vortex state, increasing in amplitude in the 10-loop heatmap as more bars vorticize. Checkerboard-pattern higher-index 9.5-10.5 GHz vortex modes with near-zero field gradient also become visible at 10 loops. The 10-loop heatmap shows a lower-amplitude wide-bar macrospin mode with opposite (negative) gradient, corresponding to the population of oppositely magnetized wide bars (7.5 GHz mode at +10 mT), pinned by H_{loc}, as observed in higher-loop-number MFM images. The vortex modes further increase in amplitude in the 30-loop heatmap, as does the oppositely magnetized wide-bar macrospin mode. The opposing wide-bar macrospins cancel each other's dipolar field, reducing net H_{loc} and shifting the χ-shaped vortex-mode intersection towards 0 mT. Vortex-mode field gradients are highly non-linear, allowing enhanced control over mode frequency in vortex-injected ASVI relative to conventional reconfigurable magnonic crystals and highlighting the degree of spectral reconfigurability offered by ASVI. ASVI exhibits curved (low-frequency vortex modes), straight (macrospin modes) and flat (high-frequency vortex modes) mode gradients, an unusually rich spin-wave mode spectrum for a nanopatterned reconfigurable magnonic system. Simulations also show a vortex core gyrational mode at ˜0.1-0.5 GHZ, which was not observed as in this work FMR was limited to a minimum frequency of 2 GHz.

Linking the spectral response to the microstate and showing the effects of extended field cycling, FIGS. 7A-7E panel g) shows MFM images after 3-100 field loops, with the 3-30 loop states corresponding to the FMR heatmaps. The domain growth and increasing vortex population observed over loops 0-4 in FIGS. 6A-6D panel i) continues, with defined domain patterns observed and high-purity vortex states reached by 100 loops.

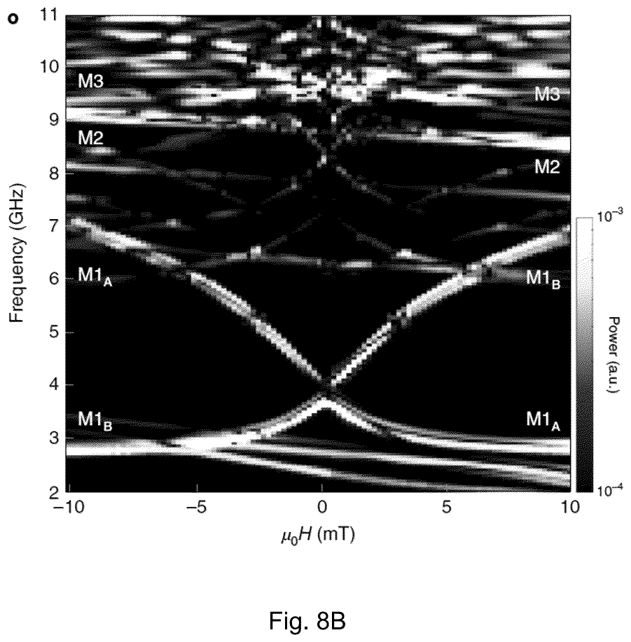

Micromagnetic simulation of spin-wave spectra and spatial mode profiles FIGS. 8A-8B panels a-c) shows MuMax3 simulations of the spatial profiles of ASVI magnon modes at Hₐₚₚ=+5 mT, 0 mT and −5 mT for a vertex with vortices in both wide bars. Three main modes are observed: M1_{A} and M1_{B} are bulk-like modes localized above (A) and below (B) the vortex core. The M1 modes exhibit sigmoidal field gradients with opposite ∂f/∂H sign as Hₐₚₚ causes the M1_{A} region to grow at the expense of M1_{B} as the field is swept negative-to-positive and the vortex core moves along the bar length. The macrospin thin bars exhibit a bulk mode, M2, and the vortex wide bars exhibit a higher-order mode, M3, with a whispering gallery-like profile around the bar edge. FIGS. 8A-8B shows the simulated mode field evolution, showing good correspondence with the experimental FMR minus the wide-bar macrospin mode, which is not present in the simulated vertex. Additional higher-index modes are resolved in the simulation, however, these are more sensitive to nanopatterning imperfection and fall below the experimental signal-to-noise threshold. The range of modes and their broad set of profiles and field gradients are an example of the flexibility and benefits offered by magnetic texture-based magnonics.

### Vortex-to-Macrospin Conversion and Fading Memory Behaviour

The vorticization process is bidirectional, with distinct switching dynamics and coercive fields when converting vortices to macrospins. FIGS. 9A-9C panel a) shows an FMR heatmap starting at 0 mT with a 30-loop, high-vortex-population state, then sweeping Hₐₚₚ across 0-35 mT. Macrospins in the initial state are magnetized along +ŷ, and Hₐₚₚ swept along +\hat{x}. Three switching behaviours are observed: wide-bar macrospins switching at 15.5-17 mT, thin-bar macrospins at 27 mT and V2M conversion at 24-28 mT. The tapering linewidth of the wide-bar macrospin mode at ˜7.5 GHz between 24 and 28 mT reveals details of quenched disorder effects in V2M conversion (Supplementary Note 1.3).

FIGS. 9A-9C panel b) shows V2M conversion for 5, 10 and 30 field-cycle states, cycled at +18 mT and swept 0-25 mT along +\hat{x} until reaching a saturated all-macrospin state. Phenomenological fits to macrospin and vortex mode amplitudes are achieved using sigmoid functions. For all states, V2M conversion begins at Hₐₚₚ=19.5 mT, reaching saturated all-macrospin states at 23.8 mT. This gives a vortex-injection field window 18-19.5 mT above the wide-bar coercive field and below the V2M conversion within which to exploit the vortex-injection ratchet effect. Thin-bar magnetization can be used to control the V2M switching fields, with −ŷ-magnetized thin bars increasing the beginning of V2M conversion to 24 mT and only reaching an all-macrospin state at 28 mT. Thin-bar control over V2M conversion is discussed in detail in Supplementary Note 1.4 and FIG. 13.

Partial conversion of vortex populations to macrospins can affect subsequent microstate evolution behaviour (FIGS. 9A-9C panel c)). 0-30 loop states were prepared at ±18 mT and then applied a ‘stimulus’ field of +21.5 mT, chosen to convert ˜35-50% of vortices to macrospins. After application of the stimulus field, the system was subjected to 15±18 mT \hat{x} field cycles. The wide-bar macrospin mode amplitude was measured at each step, with step number −1 representing the pre-stimulus state, step 0 the response to the stimulus field and steps 1-15 the post-stimulus field cycles.

Looking at the initial pre-stimulus state amplitudes, as expected, lower macrospin amplitudes were observed for longer field cycles (FIGS. 9A-9C panel c)). After stimulus field application (loop number 0), the inventors observed that the longer the field cycling, the smaller the increase in macrospin mode amplitude in response to stimulus field. This is somewhat surprising as longer-cycled states have larger vortex populations and therefore more bars available to convert to macrospins. This shows that vortex domains collectively resist V2M conversion. This is an important finding that shows ASVI retains long-term memory of its history, exhibiting substantially different responses to identical stimuli based on history. The response to post-stimulus ±18 mT loops, as in FIGS. 7A-7E panel b), shows exponential decay of macrospin mode amplitude. The inventors found that the mode evolution rate t is a function of pre-stimulus field-cycling history: τ=−2.35×10⁻³n+0.235, with n the number of pre-stimulus field cycles (inset in FIGS. 9A-9C panel c)). This shows that the underlying vortex evolution dynamics are themselves history-dependent. Additionally, longer-cycled states exhibit lower macrospin mode amplitudes even 15 loops after the stimulus field. This shows that ASVI vortex evolution history is a persistent and measurable property. One can distinguish shorter and longer training-loop-cycle samples even after identical long measurement field-cycle sequences and stimulus field applications. Crucially, although ASVI retains memory of its history, the different system trajectories presented in FIGS. 9A-9C panel c) gradually converge at higher field loop numbers. This progressive ‘forgetting’ is termed fading memory, a key prerequisite for strong reservoir computing performance. Fading memory often occurs passively via intrinsic system damping; here, as in other schemes, it is driven actively via the looping global field serving as a system clock. Longer sequences of varying magnitude field loops (up to 250 loops) are examined in Supplementary Note 1.5 and FIG. 14, showing how field-magnitude changes as small as 0.5 mT exert substantial influence over microstate trajectory dynamics.

### Reservoir Computation

ASVI can fulfils key RC criteria: its response to a given input is non-linear and history-dependent alongside its vast 4^{N} microstate space (N is number of nanoislands in the system). The crucial ‘fading memory property’ is also present in ASVI, as demonstrated in FIGS. 9A-9C panel c), where the response converges from different initial states when driven through the same data-input field-loop sequence.

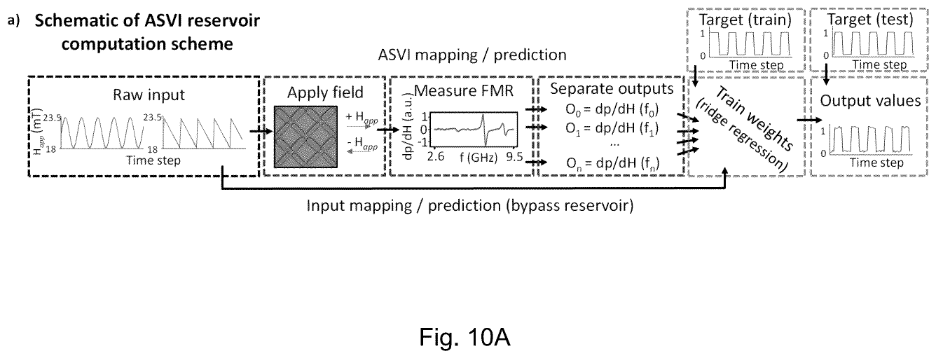

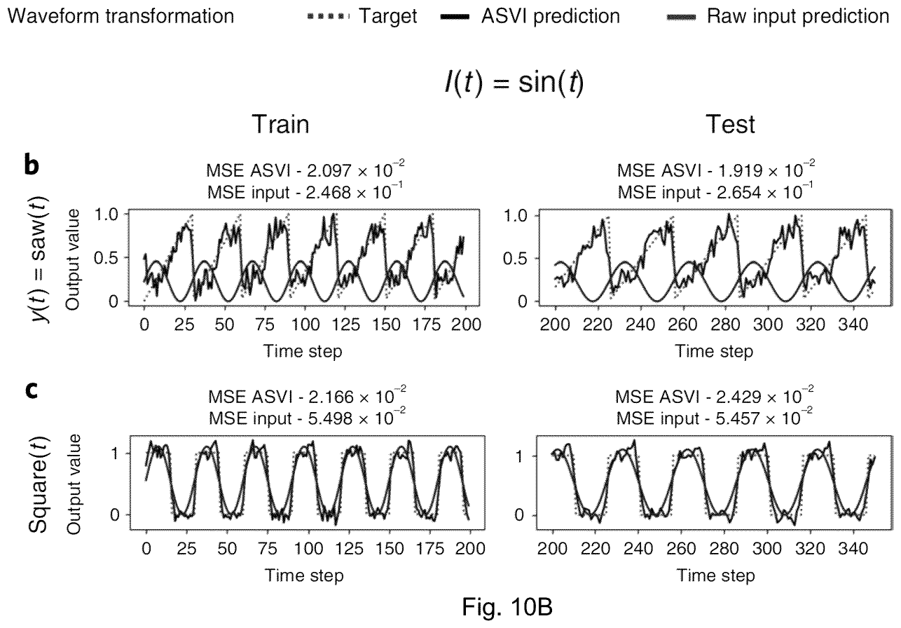

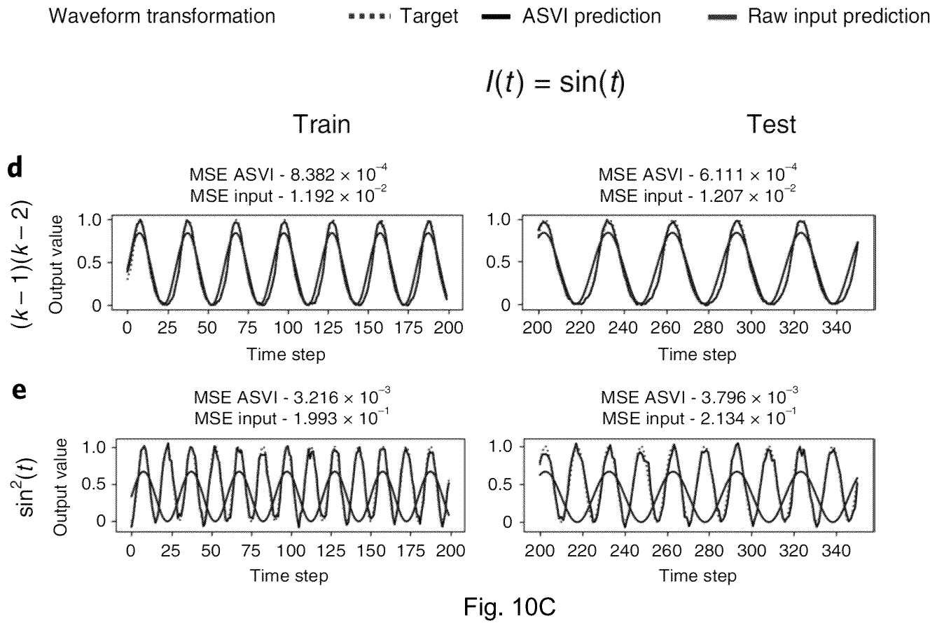

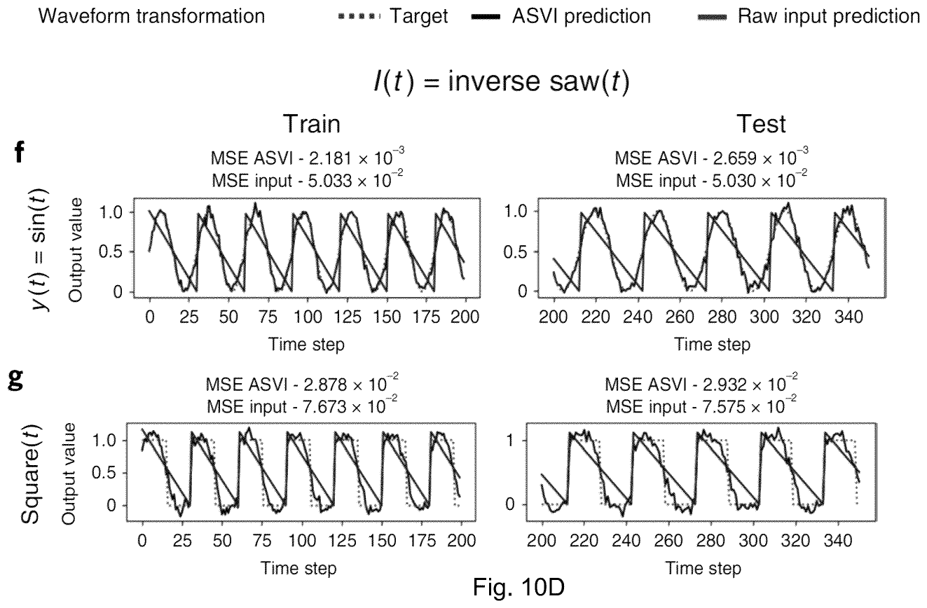

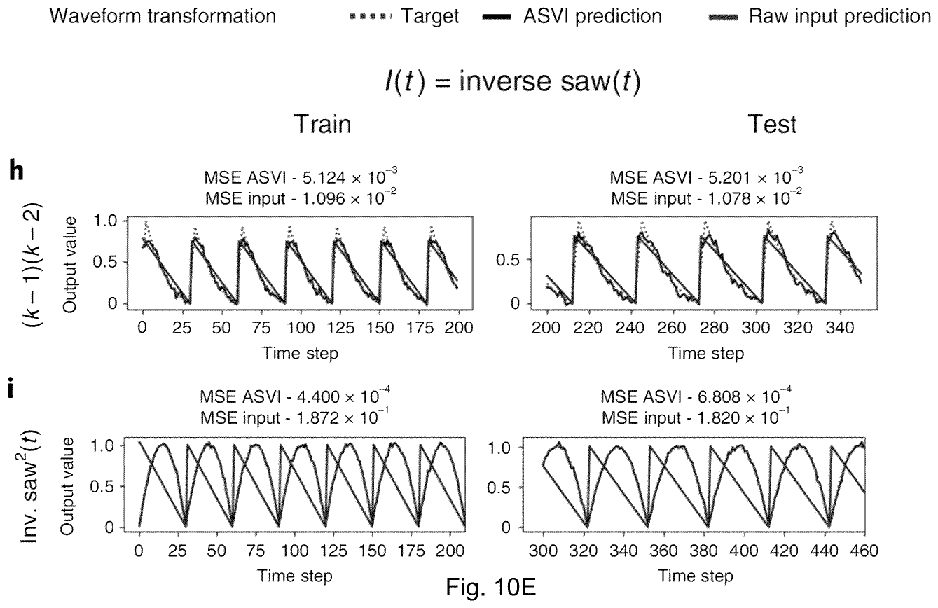

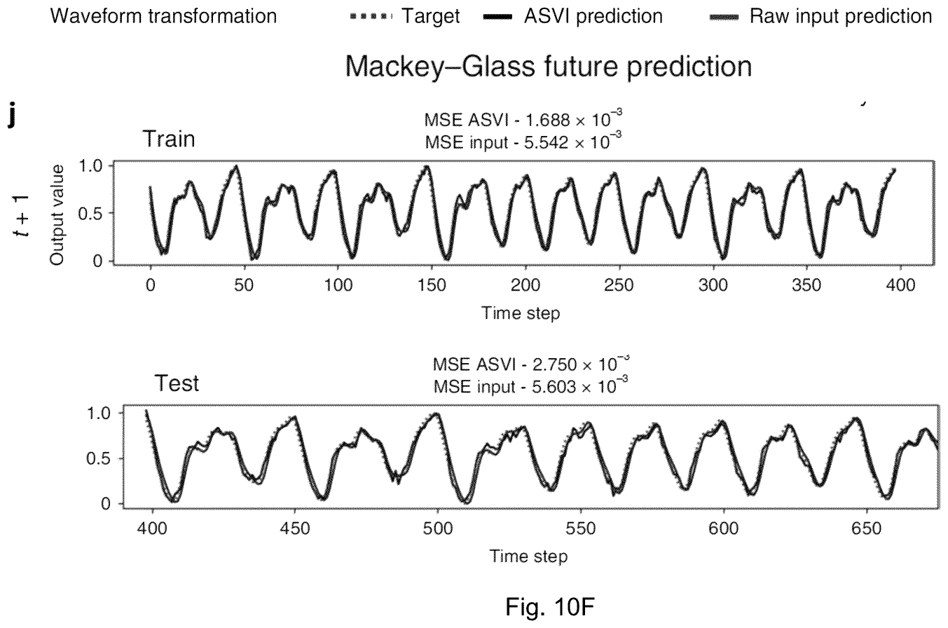

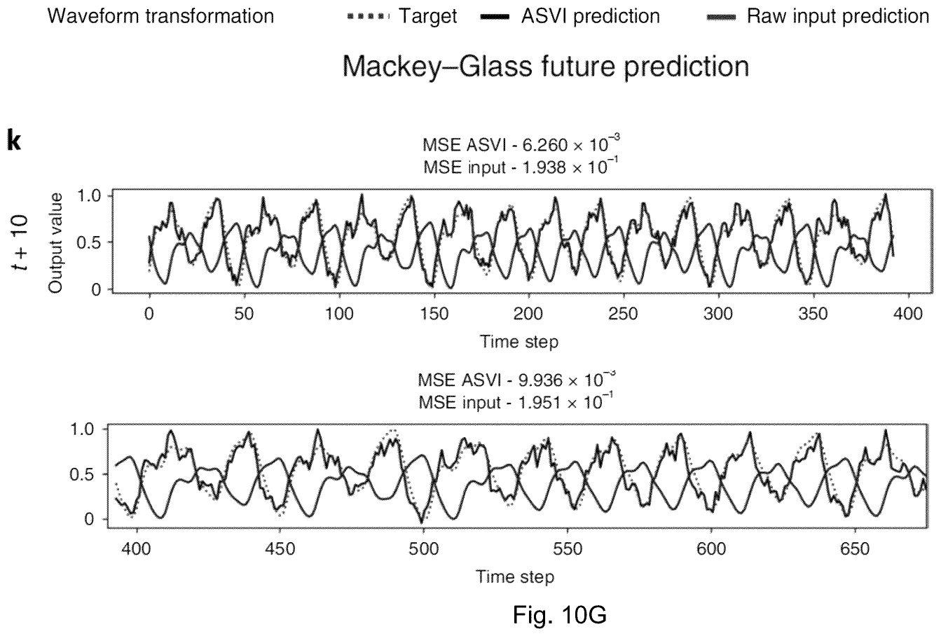

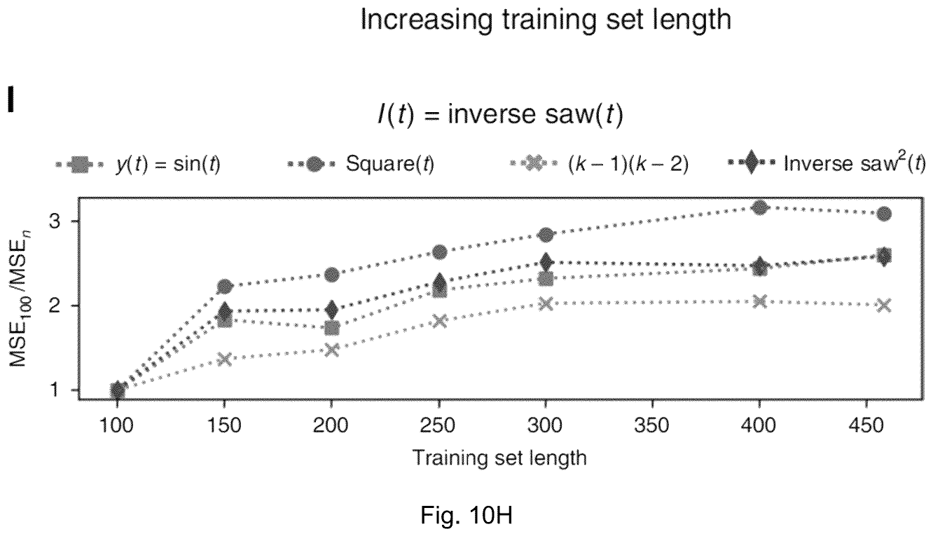

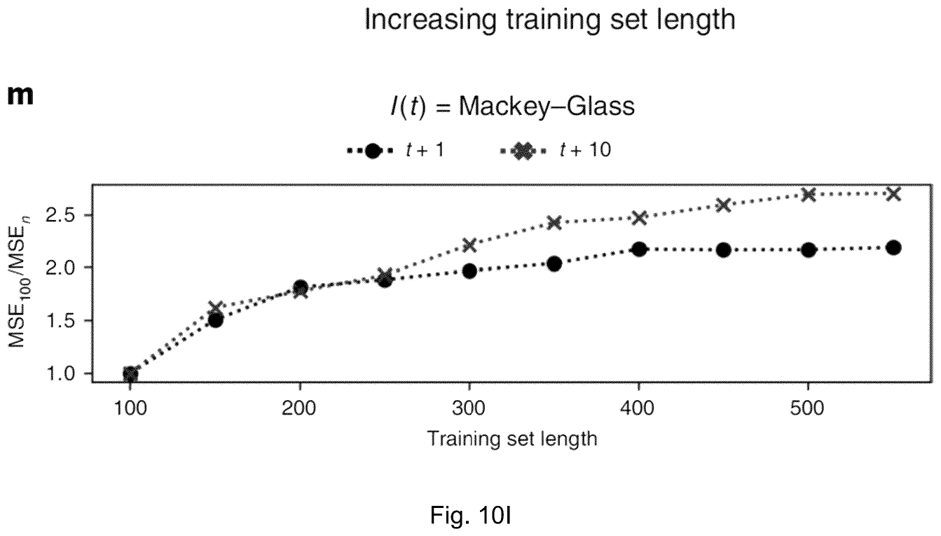

FIGS. 10A-10I panel a) shows a schematic of the ASVI reservoir computing scheme. Reservoir computing schemes consist of three layers: an input layer, a ‘hidden’ dynamic reservoir and an output layer. Here, the input layer corresponds to globally applied minor field loops with varying magnitude Hₐₚₚ, the hidden dynamic reservoir comprises the intrinsic non-linearities (vortex injection and spectral field response) and physical memory of the ASVI, and the output layer the measured FMR spectra after each input field loop.

Input values were linearly mapped onto an appropriate Hₐₚₚ range (18.0-23.5 mT) such that thin bars never reverse. For each data point, a minor field loop with a maximum field of Hₐₚₚ was applied along \hat{x}. The ASVI, serving as the reservoir, responds to the input field in a non-linear fashion, as shown throughout this study. The FMR response was then used as the output layer, where spin-wave mode amplitudes give microstate readout. The FMR was measured in the range 2.6-10.5 GHZ (20 MHz resolution) at Hₐₚₚ. The amplitude of each frequency bin was used as an independent output, giving a total of 397 reservoir outputs for each input time step. This process was repeated for all inputs in the entire dataset before training, with prediction performed offline.

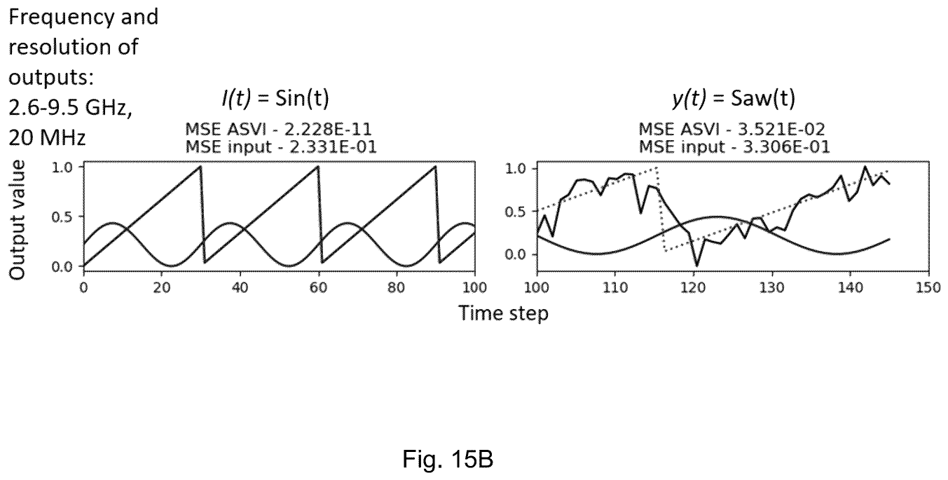

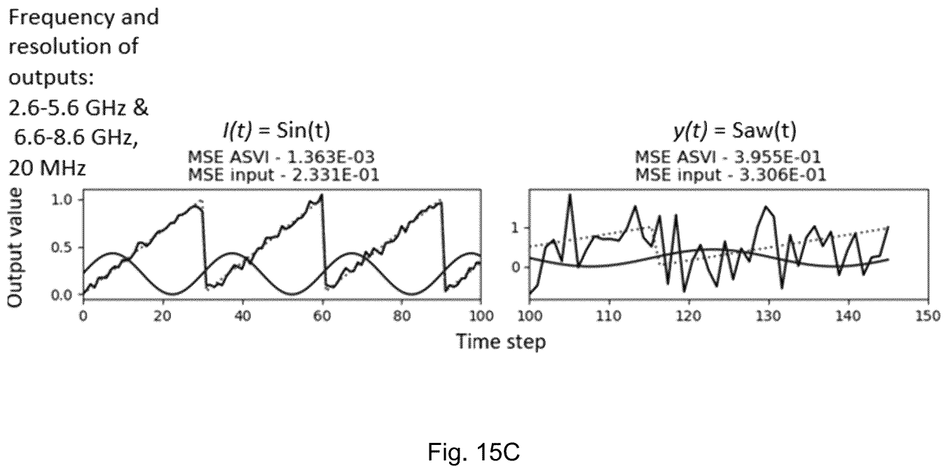

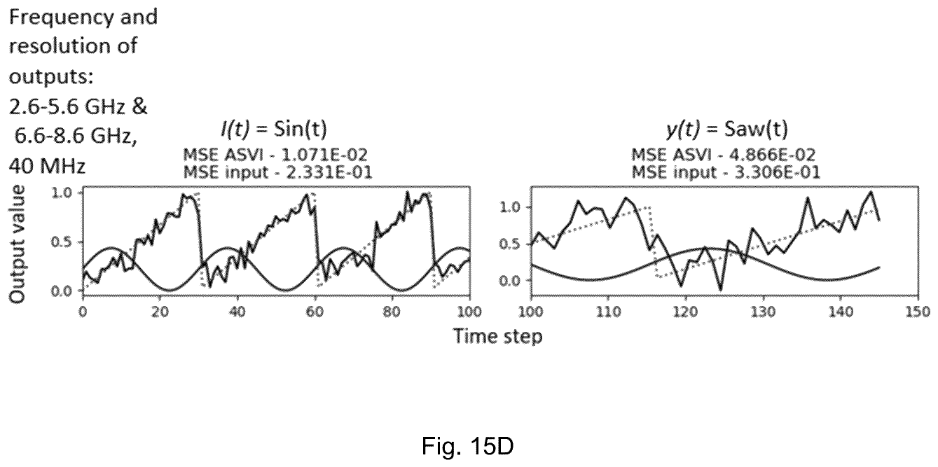

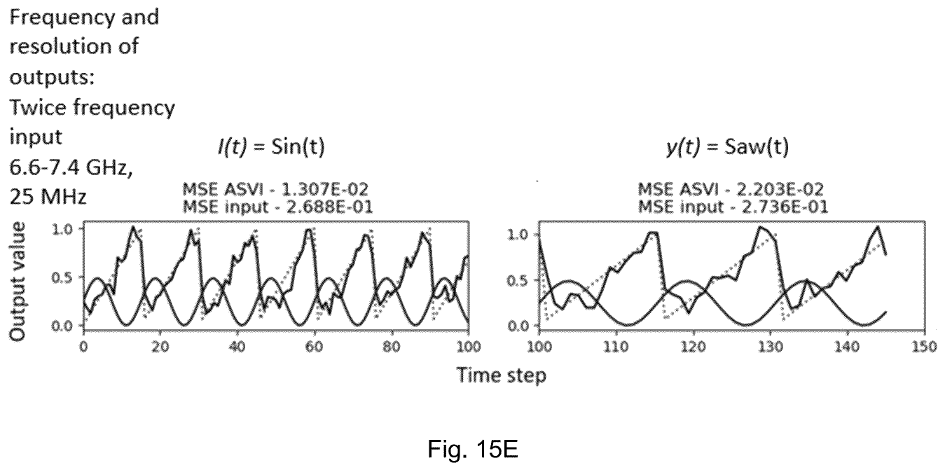

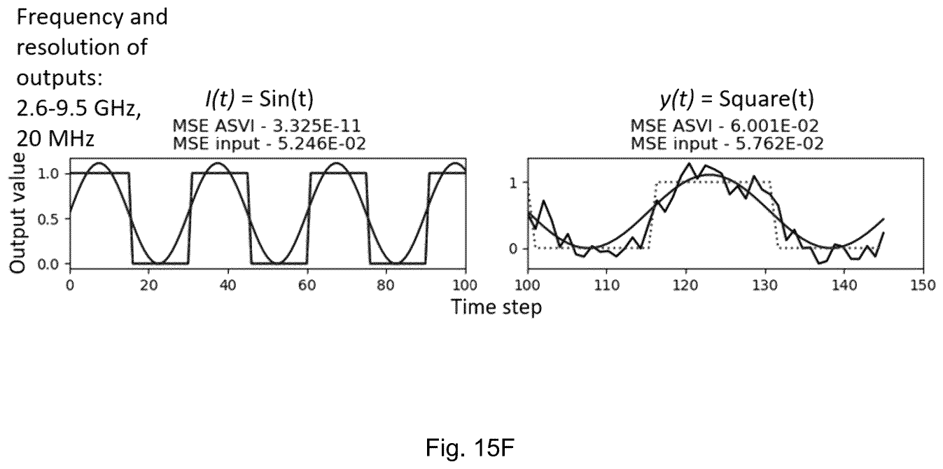

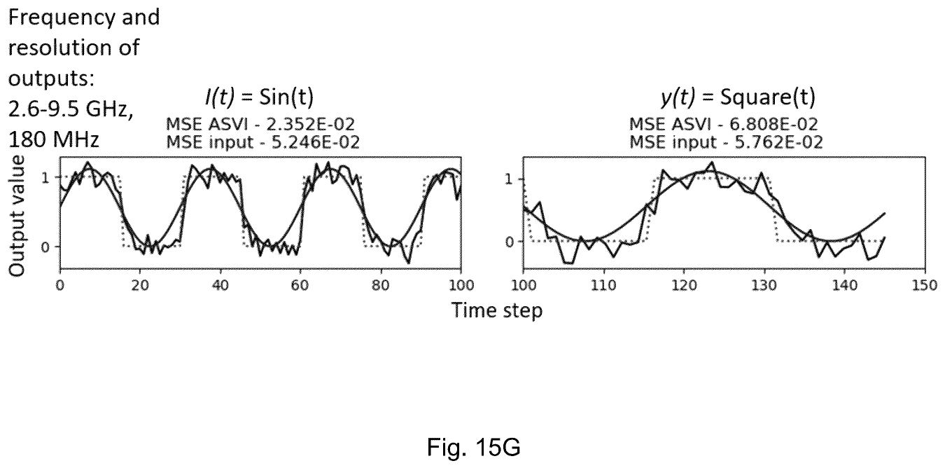

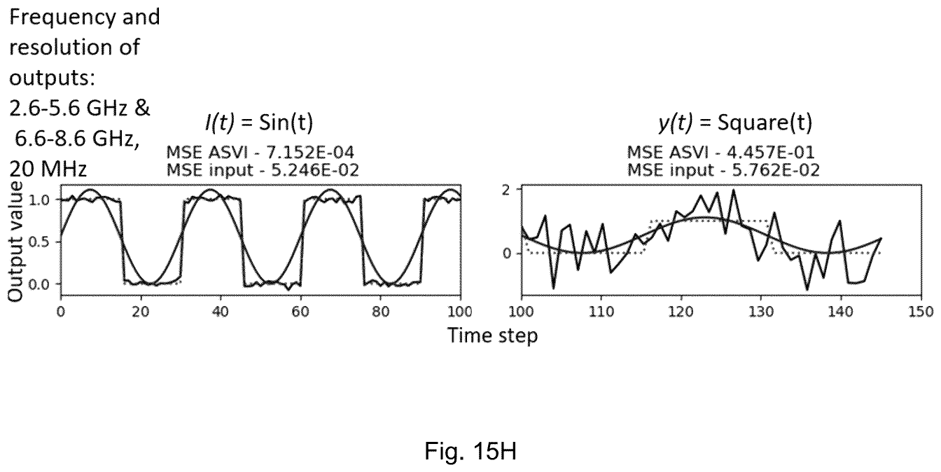

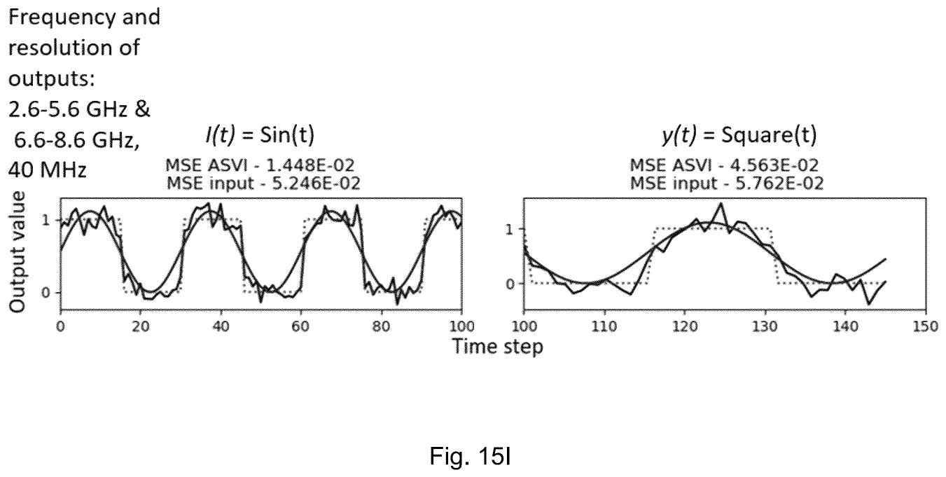

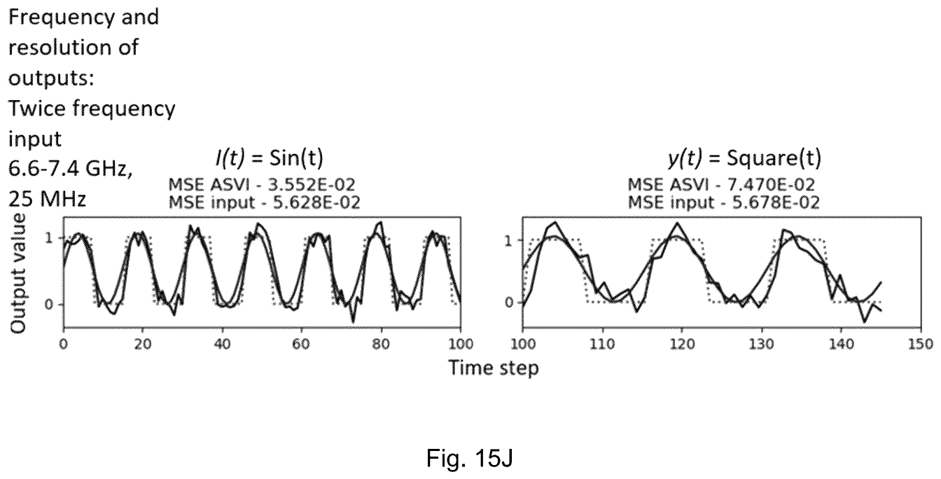

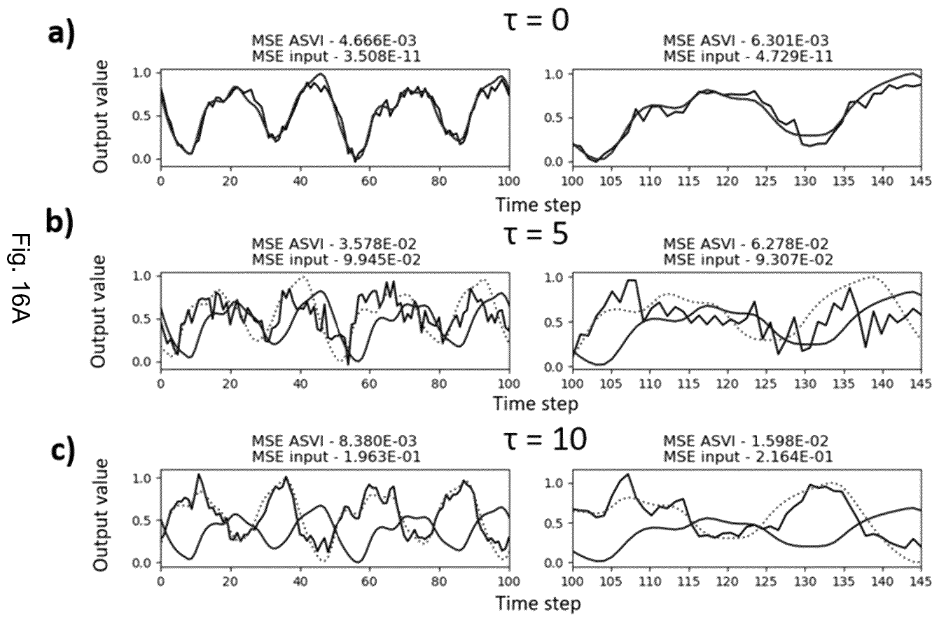

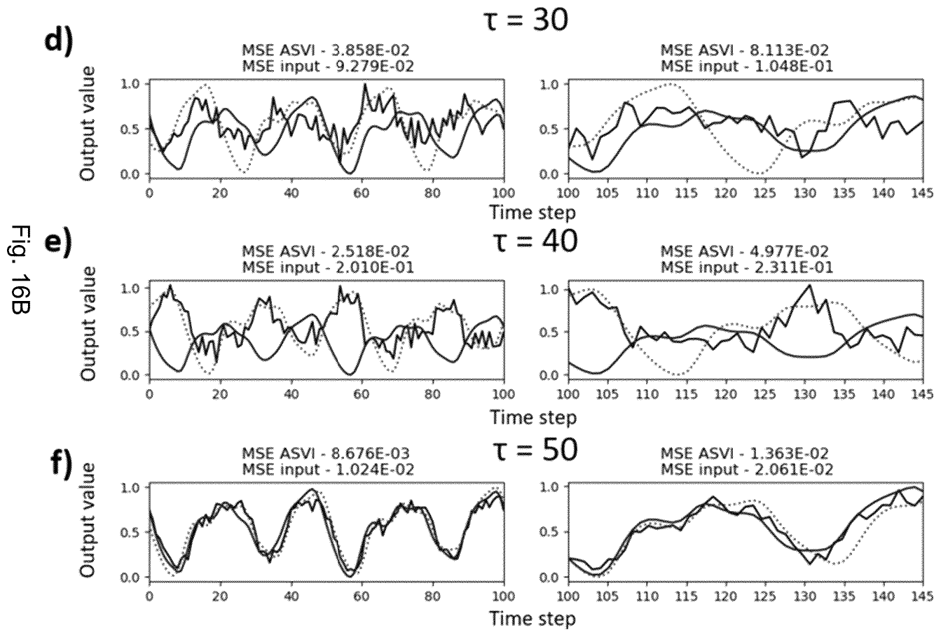

The goal of the training was to assign a weight wᵢ to each reservoir output Oᵢ such that

$${\sum }_{i = 0}^{i = n} {w}_{i} {O}_{i} \approx Y ,$$

where n is the number of reservoir outputs and Y is the target value. This procedure was performed on the entire training set so that the optimum set of weights was learned. For this, ridge regression via matrix multiplication (see Methods) was used. When training, the measured dataset was split into ‘train’ and ‘test’ datasets. The ‘train’ dataset was used to fit weights, and the ‘test’ dataset was used to assess fitted weights on previously unseen data. Short ‘train’ datasets were employed to mirror real-world, embedded device use cases with strict limits on data capture, energy cost and processing time. The weights were then applied to the ‘test’ dataset, which was not present during the weight learning, therefore assessing the computational performance on unseen data. Performance was measured as the mean squared error (MSE) between the target waveform and the ASVI prediction. To remove noise and reduce overfitting, specific ASVI frequency bins were discarded depending on the task (see Methods, Supplementary Note 1.6 and FIGS. 15A-15J). For the training method in this work, only the outputs at a given time step were considered, that is, no time multiplexing or software-based memory was employed, all memory effects occurring physically within the ASVI reservoir. An advantage here is that no storage of past reservoir responses was required for inference after training was complete, reducing memory cost and processing time and avoiding deceptively good reservoir performance where the software regression provides much of the computation. The training method employed here is simplistic by design, requiring no additional steps such as time multiplexing or complex feedback, which are costly in energy and processing time, vital considerations for embedded low-power, high-speed neuromorphic hardware.

First, the ASVI reservoir capacity to learn challenging non-linear transformations of a given input sequence I(t) onto an unknown output function y(t)=f(I(t)) was assessed. FIGS. 10A-10I panels b-i) shows the results of learning non-linear transformations of sine wave (FIGS. 10A-10I panels b-e)) and inverse saw wave (FIGS. 10A-10I panels f-i) input datasets I(t) to y(t) targets of saw wave (FIGS. 10A-10I panel b)), sine wave (FIGS. 10A-10I panel f)), square wave (FIGS. 10A-10I panels c,g)), a second-order non-linear hysteretic transformation following previous studies (y(t)=0.4y(t−1)+0.4y(t−1)y(t−2)+0.61³(t)+0.1; FIGS. 10A-10I panels d,h) and I²(f₀) (FIGS. 10A-10I panels e,i)). Here, the reservoir outputs at 40 MHz were sampled in the ranges 3.6-4.56 and 7.1-8.06 GHZ (encompassing the vortex and macrospin peaks, respectively), giving a total of 48 reservoir outputs. ASVI successfully learned to map all non-linear transformations of each input sequence, with a strong performance competitive with existing RC schemes and low MSE values of 6.1×10⁻⁴−2.9×10⁻² for the ‘test’ dataset.

The blue traces in FIGS. 10A-10I represent the same training procedure applied to the raw input dataset, entirely bypassing the ASVI reservoir and showing only the effect of software regression, an important test for assessing RC performance. The raw input predictions are seen to entirely fail at the transformation tasks, their mapping attempts simply reproducing the input datasets with different amplitude scaling. ASVI succeeds here as the requisite non-linearities for strong mapping performance can be supplied by the intrinsic physical nanomagnetic interactions and spectral field response.

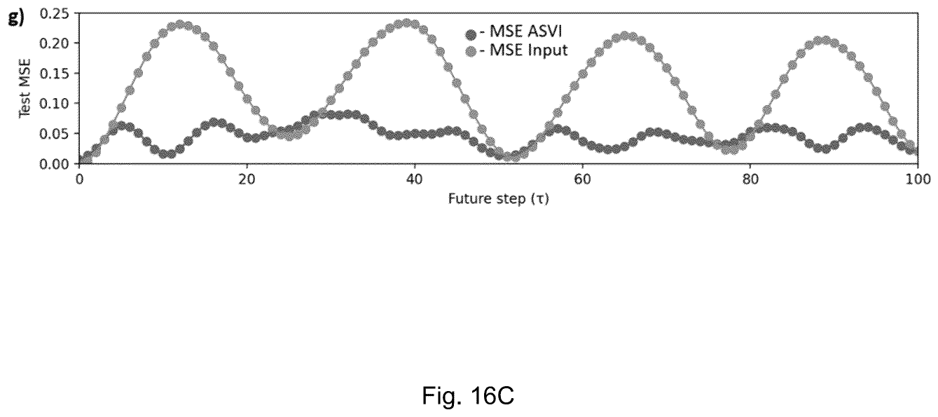

Next, future prediction performance was assessed. Here, the chaotic Mackey-Glass differential equation, commonly used for RC benchmarking, was used. The same training method was used with the target the Mackey-Glass equation at t+τ, where τ is how far into the future to predict. Here, all 397 reservoir outputs were used. FIGS. 10A-10I panel j,k) shows ASVI predictions for t+1 and t+10 with MSE values of 2.75×10⁻³ and 9.94×10⁻³, respectively. In this scenario, the raw input ‘prediction’ is simply a reproduction of the input dataset with a t time-step lag, well-known behaviour indicative of prediction breakdown. Hence, the ASVI prediction is superior despite the higher MSE, apparent when predicting further into the future, as in the t+10 case in FIGS. 10A-10I panel k). The input prediction does not match the target value, whereas the ASVI prediction closely follows the target trend. Further prediction steps are shown in Supplementary Note 1.7 and FIGS. 16A-16C.

FIGS. 10A-10I panels l,m) shows the reservoir performance when increasing the length of the ‘training set’ for the inverse saw wave transformation and Mackey-Glass prediction tasks, respectively. Doing so allows for a truer ridge-regression fit, reducing the possibility of overfitting. For both tasks improved reservoir performance up to 450-550 training points was found, as demonstrated by the increasing MSE₁₀₀/MSEₙ ratio, where n is the number of training points. Here, all 397 reservoir outputs were used.

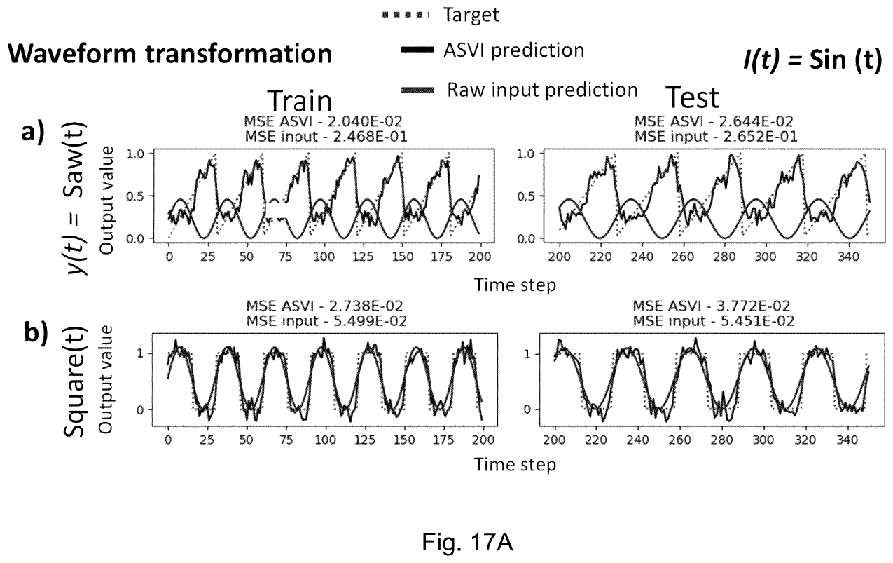

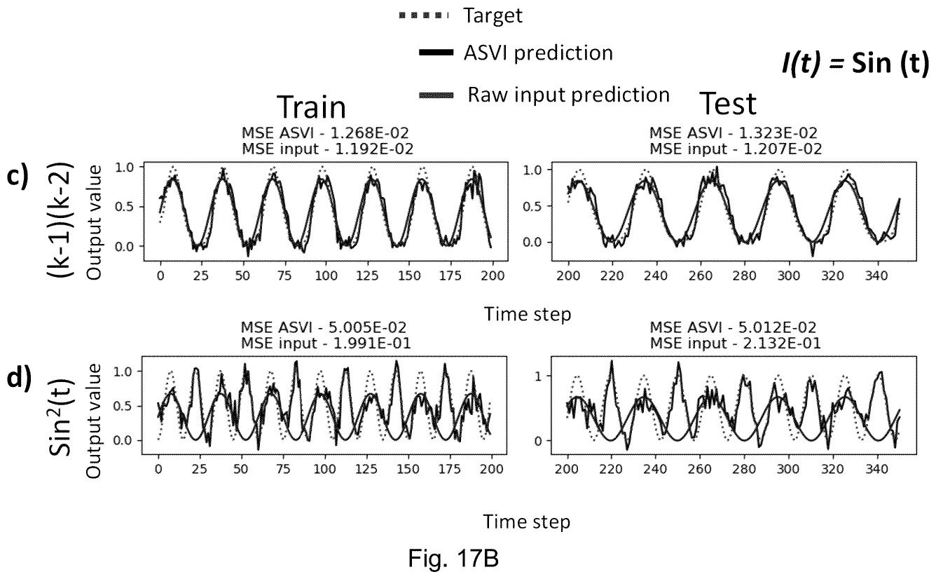

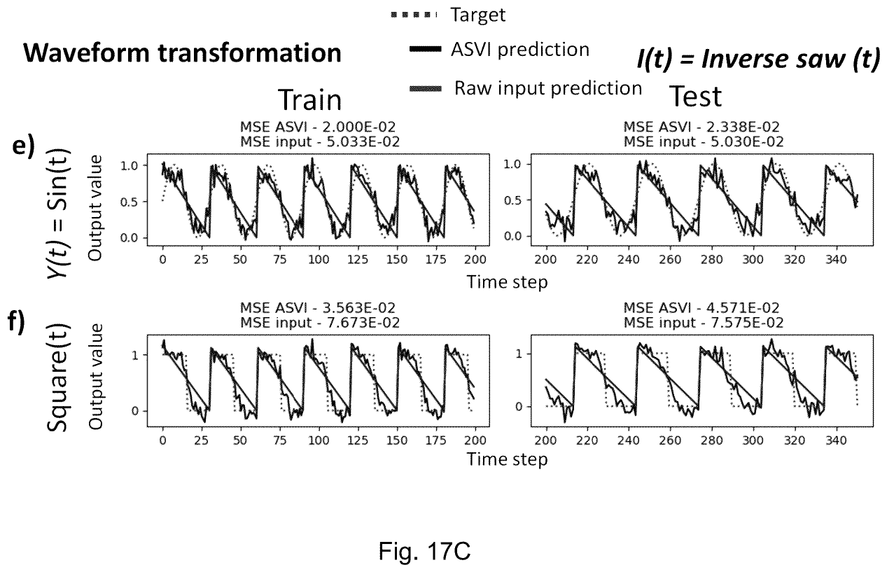

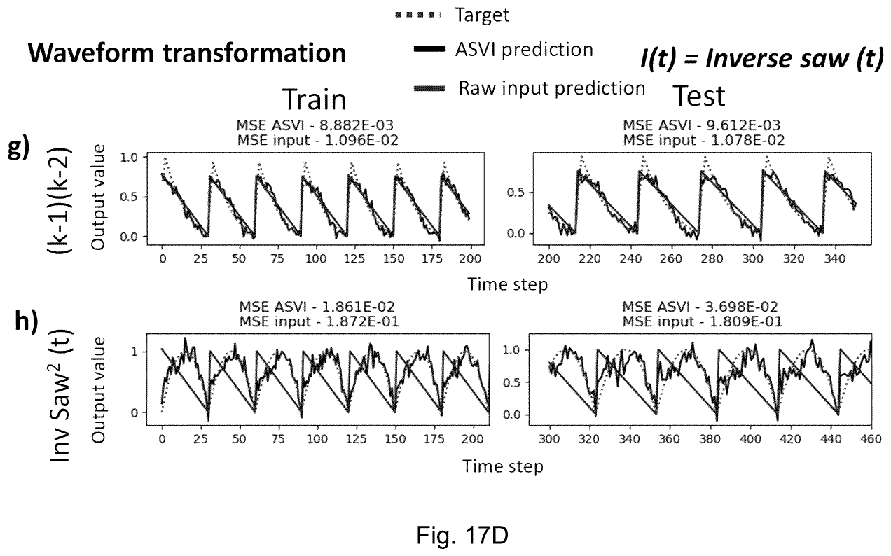

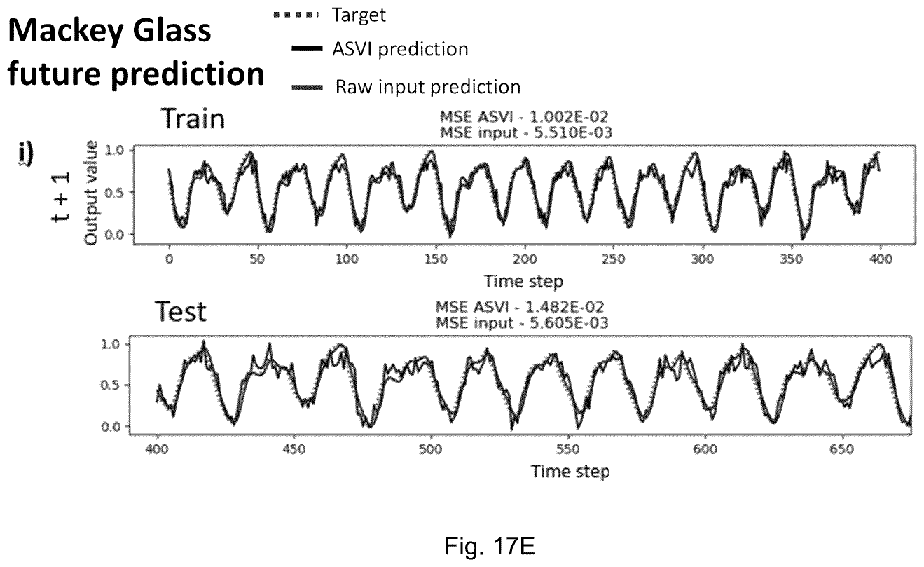

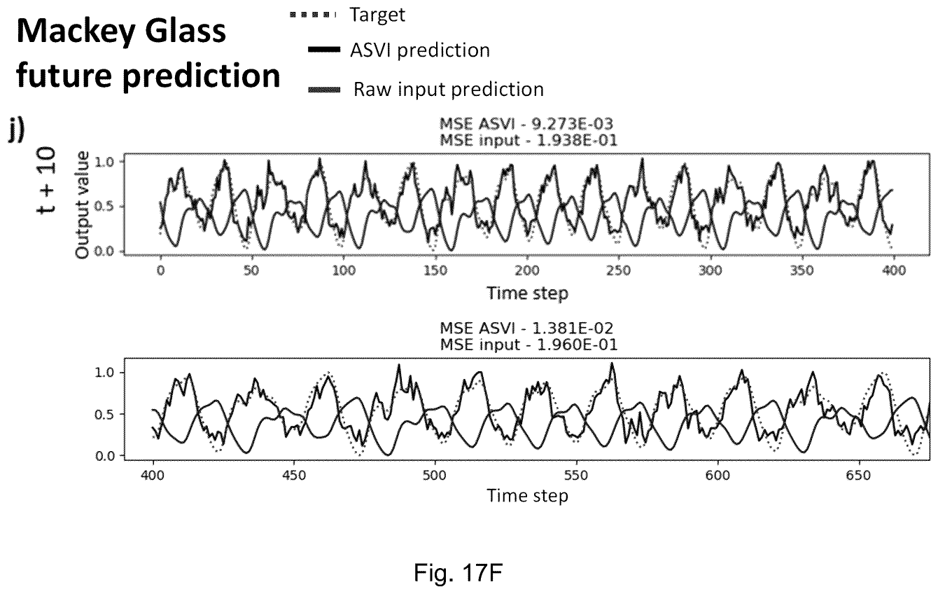

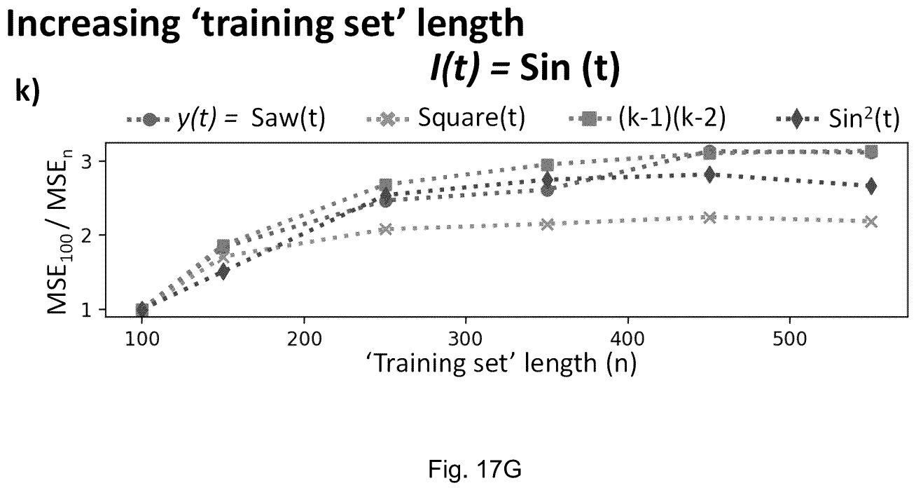

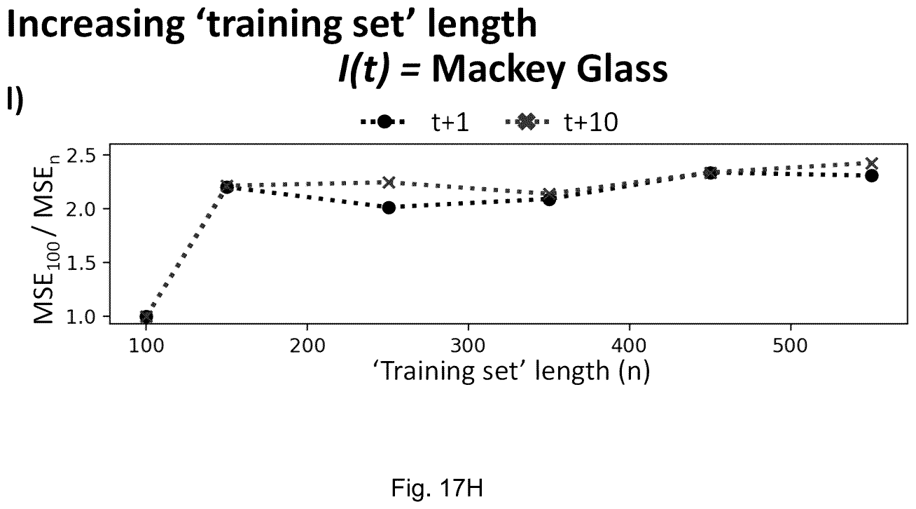

A modified reservoir computation scheme is presented in Supplementary Note 1.8 and FIGS. 17A-17H, where all spectra were measured in a constant −1.2 mT bias field rather than at Hₐₚₚ. The data show that computational performance is somewhat reduced with higher MSE values, although considerable performance is retained, demonstrating the versatility of ASVI across distinct measurement schemes.

It is worth examining the benefits offered by ASVI relative to other hardware reservoir computing systems. Nanomagnetic artificial spin systems can have the benefit of no long-term degradation over repeated switching cycles, a substantial issue for current memristor-based systems, which suffer from substantial degradation and oxidation during repeated cycling. The WOₓ redox memristors used in recent reservoir computation studies have a maximum endurance of 1012 cycles before device breakdown. At a reasonable clock speed of 100 MHz (with far higher speeds desirable), this offers just 2 h 45 min of operation, which represents a significant hurdle for the field to overcome. ASVI can be cycled indefinitely without degradation. Moreover, nanomagnetic artificial spin systems such as ASVI can have the benefit of indefinite non-volatile data storage and state retention, highly attractive both for robustness against power supply issues (especially for ‘in-the-field’ applications) and long-term retention of specific states with desirable functional characteristics. Additionally, there is no requirement to connect current address lines to all individual nanomagnets within the array, beneficial for device cost, fabrication complexity, power consumption and Ohmic heating. Nanomagnets intrinsically strongly interact with their neighbours, whereas such interactions must be artificially engineered into the system at-cost for memristors and other systems.

The scheme described herein demonstrates the scope for improved scalability and device integrability via achievable modifications. Nanopatterned spin-wave resonators with high quality factor Q at specific frequencies can be employed (for example, at the macrospin and vortex peaks) for rapid readout at different spatial regions of micrometre-scale ASVI reservoirs. Field-input speeds for both data input and radio frequency (RF) excitation can be dramatically increased to 10⁷-10⁸ Hz via nanosecond-pulsed fields from nanopatterned striplines, enabling continuous input of directly captured data. Combining multiple nanopatterned striplines and pickup resonators or waveguides can allow for parallel as well as sequential data input and readout.

ASVI can also be well-matched to hybrid approaches combining reservoir computation with DNN-like manual tuning of network weights in hardware via direct nanomagnetic writing, for example, surface-probe, optical or microwave-assisted switching.

### CONCLUSIONS

The inventors have demonstrated ASVI, a four-state spin system with engineered texture bistability can give rise to emergent dynamics, including collective physical memory phenomena and highly reconfigurable spin-wave spectra. Fading memory behaviour was observed when the system was driven through repeated minor field loops. Vortices were found to exhibit substantial capacity to locally modify memory and switching behaviour, highlighting rich emergent dynamics from engineering diverse magnetic textures in artificial spin systems. Vortex chains and domains can be harnessed to define magnon waveguides. The vortex-to-macrospin frequency shift of Δf=3.8 GHz was found to be competitively high across reconfigurable magnonics and the analogue-style mode amplitude tuning has technological appeal.

The inventors have demonstrated the efficacy of ASVI as a neuromorphic computation platform across a diverse range of tasks by learning linear and non-linear waveform transformations in addition to chaotic time-series prediction with strong results competitive with other reservoir systems while employing short training datasets and no individual electrical addressing of reservoir elements. The inventors consider the scheme implemented here to be compatible across a range of artificial spin systems, including conventional all-macrospin ASI, albeit without the benefits of clear frequency separation between macrospin and vortex peaks and asymmetric non-linearities of the macrospin and vortex field response. The observed large Δf=3.8 GHz mode shift far surpasses the 0.1-0.3 GHz shifts available in conventional all-macrospin ASI. Combining these benefits with the nanosecond timescales of the switching dynamics and spin-wave response can provide rapid, scalable signal processing and computation, and expand the scope of functional artificial spin systems. Developing low-energy hardware platforms for neuromorphic computation is understood to be important as the energy cost of machine learning rises exponentially. The low-power benefits of magnonics and intrinsic non-volatility, passive strong inter-element coupling and no current address line requirement for each element can situate ASVI as an attractive candidate for future neuromorphic computational hardware.

### Micromagnetic Simulation:

Simulations were performed using MuMax3. To maintain field sweep history, ground-state files were generated in a separate script and used as inputs for dynamic simulations. The material parameters used for NiFe were saturation magnetization Mₛₐₜ=750 kA m⁻¹, exchange stiffness Aₑₓ=13 pJ and damping α=0.001. All simulations were discretized with lateral dimensions c_{x,y}=5 nm and normal direction c_{z}=10 nm, and periodic boundary conditions were applied to generate the lattice from the unit cell. A broadband field excitation sinc pulse function was applied along the z direction with a cut-off frequency of 20 GHz and amplitude of 0.5 mT. The simulation was run for 25 ns, saving the magnetization every 25 ps. Static relaxed magnetization at t=0 was subtracted from all subsequent files to retain only dynamic components, which were then subject to a fast Fourier transform along the time axis to generate a frequency spectrum. Power spectra across the field range were collated and plotted as a colour contour plot with resolution Δf=40 MHz and Δμ₀H=1 mT. Spatial power maps were generated by integrating over a range determined by the full-width half-maximum of peak fits and plotting each cell as a pixel whose colour corresponds to its power. Each colour plot was normalized to the cell with the highest power. High-resolution simulations performed for FIGS. 8A-8B have lower damping (α=0.0001), and were run for 100 ns, saving every 50 ps. The lower damping serves just to reduce the linewidth for clarity of visualization, and other behaviours associated with more realistic higher damping were well preserved. This produces colour plots with resolution Δf=10 MHz and Δμ₀H=0.2 mT. Hₐₚₚ was offset from the array \hat{x}, ŷ axes by 1° to better match experiment.

To achieve the vortex states (for example, in FIGS. 6A-6C panel d) and FIGS. 8A-8B), MuMax3's built-in vortex initialization command was used and then allowed to relax to a minimum energy configuration.

### Nanofabrication:

The ASVI was fabricated by the electron-beam lithography liftoff method on a Raith eLine system with a poly(methyl methacrylate) resist (PMMA). Ni₈₁Fe₁₉ (permalloy) was thermally evaporated and capped with Al₂O₃. A ‘staircase’ subset of bars was increased in width to reduce its coercive field relative to the thin subset, allowing independent subset reversal via global field. The flip-chip FMR measurements required millimetre-scale nanostructure arrays. The 3×2 mm² array employed for this study meant that the distribution of nanofabrication imperfections termed ‘quenched disorder’ was of greater magnitude here than typically observed in studies on smaller artificial spin systems, typically employing arrays with dimensions of 10-100 μm. The chief consequence of this was that the Gaussian spread of coercive fields was over a few millitesla for each bar subset (15.5-17 mT for wide bars, 26-29 mT for thin bars). Smaller ASVI arrays have narrower coercive field distributions, with the only consequence being that the optimal applied field ranges for reservoir computation input will be scaled across a corresponding narrower field range, not an issue for typical 0.1 mT or better field resolution of modern magnet systems.

### Fmr Measurement:

FMR spectra were measured using a NanOsc Instruments cryoFMR in a Quantum Design physical properties measurement system. Broadband FMR measurements were carried out on large-area samples (˜2×2 mm²) mounted flip-chip style on a coplanar waveguide. The waveguide was connected to a microwave generator, coupling RF magnetic fields to the sample. The output from the waveguide was rectified using an RF diode detector. Measurements were conducted in a fixed in-plane field while the RF frequency was swept in 10 MHz steps. The d.c. field was then modulated at 490 Hz with a 0.48 mT RMS field and the diode voltage response measured via lock-in. The experimental spectra show the derivative output of the microwave signal as a function of field and frequency. The normalized differential spectra are displayed as false colour images with a symmetric log colour scale.

### Reservoir Computation:

The reservoir training inputs were chosen to have approximately 30 data points per period for the sine and inverse saw waves and Mackey-Glass input, with outputs sampled at every input. The Mackey-Glass time-delay differential equation takes the form

$$\frac{dx}{dt} = β \frac{{x}_{τ}}{1 + {x}_{τ}^{{}_{n}}} - λ x$$

and was evaluated numerically with β=0.2, n=10 and τ=17 with these three parameters governing the nature of chaotic oscillatory behaviour. The array was initially saturated in a −200 mT field in the \hat{x} direction.

Reservoir computing schemes consisted of three layers: an input layer, a ‘hidden’ reservoir layer and an output layer, corresponding to (globally) applied fields, the ASVI and the FMR response, respectively.

In each case, the inputs were linearly mapped to a field range spanning 18-23.5 mT, with the mapped field value corresponding to the maximum field of a minor loop applied to the system. After each minor loop, the FMR response was measured at the applied field Hₐₚₚ and −1.2 mT in the range 2.6-10.5 GHz in 20 MHz steps. Measurements were performed at two fields to compare the reservoir prediction quality. The FMR output was smoothed in frequency by applying a low-pass filter to reduce noise (examples of prediction quality without smoothing are shown in Supplementary Note 1.4). For each input data point, 397 distinct frequency bins were measured, and each bin was taken as an output giving 397 reservoir outputs. This process was repeated for the entire dataset with training and prediction performed offline.

Offline training and prediction were performed using a matrix multiplication method. First the ASVI response was separated into two datasets. A ‘train’ dataset for learning the optimum set of weights for a given task, and a ‘test’ dataset to test the performance of the learned weights on previously unseen data. The training set of reservoir outputs xₜᵣₐᵢₙ(u) and the target waveform \tilde{y} was considered.

$${x}_{train} ( u ) = ( \begin{matrix}{O}_{0} ( 0 ) & {O}_{0} ( 1 ) & … & {O}_{0} ( m ) \\ {O}_{1} ( 0 ) & {O}_{1} ( 1 ) & … & {O}_{1} ( m ) \\ ⋮ & ⋮ & ⋱ & ⋮ \\ {O}_{n} ( 0 ) & {O}_{n} ( 1 ) & … & {O}_{n} ( m )\end{matrix} ] \tilde{y} = ( \begin{matrix}{y}_{0} \\ {y}_{1} \\ ⋮ \\ {y}_{n}\end{matrix} )$$

where m is the number of reservoir outputs, n is the number of input data points in the ‘train’ dataset and Oₙ(m) is the mth reservoir output for input step n (that is, the amplitude of the mth frequency bin). The goal of training was to obtain a 1×M array of weights Wₒᵤₜ that transform the reservoir outputs (x(u)) into the desired target (\tilde{y}). For this, ridge regression was used, which solves the linear optimization problem Wₒᵤₜ=arg min_{W}(∥\tilde{y}−Wxₜᵣₐᵢₙ(u)∥²+λ∥W∥²) with the following solution Wₒᵤₜ=(xₜᵣₐᵢₙ(u)Tₓ_{ₜᵣₐᵢₙ}(u)+λI)⁻¹xₜᵣₐᵢₙ(u)^{T}\tilde{y}, where I is the identity matrix, T the transpose and λ is the ridge regularization term (fixed at 0.0001 for all tasks). This was performed with the freely available Python package scikit-learn.

Once Wₒᵤₜ had been obtained, the ‘test’ dataset xₜₑₛₜ(u) was then multiplied by Wₒᵤₜ to obtain the reservoir prediction \tilde{y}_{ASVI} (that is, xₜₑₛₜ(u)Wₒᵤₜ=\tilde{y}_{ASVI}) as follows:

$${x}_{test} ( u ) {W}_{out} = ( \begin{matrix}{O}_{n + 1} ( 0 ) & {O}_{n + 1} ( 1 ) & … & {O}_{n + 1} ( m ) \\ {O}_{n + 2} ( 0 ) & {O}_{n + 2} ( 1 ) & … & {O}_{n + 2} ( m ) \\ ⋮ & ⋮ & ⋱ & ⋮ \\ {O}_{n + l} ( 0 ) & {O}_{n + l} ( 1 ) & … & {O}_{n + l} ( m )\end{matrix} ) ( \begin{matrix}{W}_{0} \\ {W}_{1} \\ ⋮ \\ {W}_{m}\end{matrix} ) = ( \begin{matrix}{y}_{ASVI , n + 1} \\ {y}_{ASVI , n + 2} \\ ⋮ \\ {y}_{ASVI , n + l}\end{matrix} ) = {\tilde{y}}_{ASVI}$$

where l is the number of input data points in the ‘test’ dataset. The performance of the reservoir was assessed by calculating the MSE of the target waveform and reservoir response according to MSE=(\tilde{y}_{ASVI}−\tilde{y})²/l.

To reduce noise and overfitting, a subset of the total outputs was chosen depending on the task. For the transformation tasks the output as sampled at 40 MHz in the ranges 3.6-4.56 and 7.1-8.06 GHz (encompassing the vortex and macrospin peaks, respectively), giving a total of 48 reservoir outputs. For the Mackey-Glass future prediction, all 397 reservoir outputs were used. For all transformation tasks except the inverse saw² task (FIGS. 10A-10I panels b-h)), ‘train’ and ‘test’ lengths of 250 and 150 data points were used, respectively. For the inverse saw2 task (FIGS. 10A-10I panel i)), a ‘train’ length of 300 and a ‘test’ length of 250 data points was used. This was necessary due to the difficulty of the task. For the Mackey-Glass future prediction (FIGS. 10A-10I panels j,k)), ‘train’ and ‘test’ lengths of 393 and 271 data points were used, respectively. When exploring the effects of varying the ‘train’ length (FIGS. 10A-10I panels l,m)), a fixed ‘test’ length of 100 data points was used. See Supplementary Note 1.4 for details on output selection. Although the vortex mode is lower in amplitude than the macrospin mode, it is broader in frequency and therefore registered by more frequency bins, which allows good computation performance.

### Mfm Measurement:

MFM images were produced on a Dimension 3100 surface probe microscopy system using commercially available normal-moment MFM tips.

### Supplementary Note 1.1—Detailed Discussion of Micromagnetic Macrospin-to-Vortex Conversion Process

FIG. 11 panel a) shows a simulated MuMax3 time series of the vorticisation process. The magnetisation texture of the bottom-right bar is distorted via a combination of applied field Hₐₚₚ=16 mT and local dipolar field H_{loc} from the other bars, resulting in vortex core formation and stabilisation on a nanosecond timescale.

The detailed dynamics of the process can be well understood through a topological-defect picture, which will now be examined. References for describing magnetisation textures such as macrospins, vortices and domain walls via dynamic topological defects include: Pushp, A. et al. Domain wall trajectory determined by its fractional topological edge defects. Nat. Phys. 9, 505-511 (2013); and Tchernyshyov, O. & Chern, G.-W. Fractional vortices and composite domain walls in flat nanomagnets. Phys. Review Letters 95, 197204 (2005).

An initial −\hat{x} saturated vertex (t=0) is field-swept along +\hat{x} with a 1° angular-offset such that the bottom-right wide-bar experiences slightly higher field-torque and switches first. Hₐₚₚ brings the topological charge Q_{T}=+½ edge-bound topological defects at either bar-end to opposite long-edges (t=0.4 ns), creating pockets of +\hat{x} magnetisation (red regions) which spread through the bar (t=0.58 ns). In normal macrospin reversal, the M=+\hat{x} region growth continues and the Q_{T}=+½ defects finish at opposite bar ends. However, in vorticisation one of the Q_{T}=+½ defects reverses direction halfway (t=0.78 ns). This is the crucial step differentiating macrospin-to-macrospin reversal from macrospin-to-vortex conversion. The defects now come into close proximity at the vertex-centre bar end (t=1 ns) before combining into a single Q_{T}=+1-defect (t=1.25 ns). Integer-charge defects may only exist in the magnet bulk, and a Q_{T}=+1-defect is otherwise known as a vortex-core. The vortex-core moves into the nanomagnet bulk (t=1.75 ns) before reaching a central equilibrium point, minimising exchange and demagnetisation energy (t=2.43 ns). The factors causing one Q_{T}=+½ defect to reverse direction and drive vorticisation may be isolated in simulation, but are more stochastic in experiment. Angularly offsetting Hₐₚₚ from \hat{x} or ŷ encourages vorticisation in simulation by generating unequal field torques on the Q_{T}=+½ defects at either macrospin end. This effect was not observed in experiment, possibly due to edge-roughness affecting edge-defect trajectories and stochastic room-temperature thermal effects versus effective 0 K simulation. Simulation and experiment both find vorticisation more common when beginning from a type-1 microstate due to unbalanced dipolar fields from opposingly-magnetised thin and wide bars generating unequal field-torque on the two Q_{T}=+½ defects.

FIG. 11 panel b) shows a MuMax3 times series of V2M conversion at Hₐₚₚ=21 mT. Vortex-cores are pushed by Hₐₚₚ towards bar edges (t=0.48 ns) where they decompose on contact (t=0.68-0.88 ns) into pairs of edge-bound+½-defects characterising the macrospin state (t=1.5 ns). The edge-bound defect pair are visible in the t=0.68 ns frame, and are circled in black for clarity. Bringing the vortex core into proximity to the nanoisland edge carries a considerable exchange energy penalty which can be overcome by Hₐₚₚ. Such a penalty is not present when switching between macrospin states, hence the higher coercive fields when switching out of a vortex state.

### Supplementary Note 1.2—Extended 5-10 Loop Training Sequence and Distinct Domain Structures of Distinct Training Sequences

FIGS. 12A-12B panels a-c) follow on from FIGS. 6A-6C panel i), showing progressively higher vortex population as training progresses and more defined distinct vortex and macrospin domains, along with ‘trapped’ macrospins along the top and left edges which remain pinned and do not reverse with each loop.

FIGS. 12A-12B panels d-f) and FIGS. 12A-12B panels g-i) show two separate 3-30 loop training sequences on the same array area, with the sample reset (saturated to an all-macrospin state) between the two sequences. Locations of vortex bars and the spatial domain patterns are different in each training sequence, demonstrating that vortex training is stochastically-dominated, rather than a repeating process with the same bars vorticising every time determined by quenched disorder.

### Supplementary Note 1.3—Quenched Disorder Influence on Vortex-to-Macrospin Conversion and Spin-Wave Mode Linewidth and Frequency

Interesting details of V2M switching could be observed by following the central frequency of the wide-bar macrospin mode (border between light and dark bands) as switching progresses from 24-28 mT. If the Kittel mode gradient of the saturated wide-bar macrospin mode is extended back from its linear region 28-35 mT, the central mode frequency diverges from this gradient between 24-28 mT. Measured mode frequency is higher than the expected Kittel gradient at 24 mT, and gradually decreases while linewidth increases until it meets the Kittel gradient at 28 mT. This is due to the Gaussian distribution of bar widths and corresponding resonant frequency spread caused by quenched disorder. While wider macrospin bars with lower resonant frequency tend to reverse at lower field, here the switching is from vortex to macrospin states rather than between oppositely magnetised macrospins. FIGS. 6A-6C panel b) shows thinner bars energetically favour macrospin states, and as such switch to macrospins at lower field than broader bars. Thinner bars also exhibit higher-frequency resonances, so as V2M conversion progresses the macrospin population is initially dominated by thinner, higher-frequency bars and as such shifts the central mode-frequency above the expected average resonant Kittel frequency.

### Supplementary Note 1.4—Influence of Thin Bar Magnetisation and Dipolar Bias-Field on Vortex-to-Macrospin Conversion Process

FIG. 13 demonstrates further the reconfigurable control provided by the thin-bars. A 30-loop state with Hₐₚₚ=±19 mT was prepared along ŷ with −ŷ magnetised thin bars then sweep 0-31 mT along +ŷ until saturating into macrospin state. Here, V2M conversion is prevented until a higher field, beginning at 26.5 mT and saturating at 30.5 mT (versus 19.5-23.8 mT for the case of thin-bars magnetised along −\hat{x} as in FIGS. 9A-9C panel b). This is due to dipolar vertex energetics. With Hₐₚₚ along ŷ and −ŷ-saturated thin bars, vortices converting to macrospins would enter the ‘type 4’ or ‘monopole’ state, highly energetically-unfavourable repulsive configurations which impede motion of vortex-cores towards bar-edges.

### Supplementary Note 1.5—System Response and Microstate Dynamics for Longer Sequences of Varying-Magnitude Field-Loops

ASVI can be highly-sensitive to small changes in applied-field amplitude, leading to complex nonlinear responses to field-cycle sequences comprising different field-amplitudes. FIG. 14 shows macrospin mode-amplitude evolution over a field sequence comprising single 21-23.5 mT ‘stimulus’ field applications followed by two subsequent ±18 mT loops. System begins at loop 0 in a highly-vorticised state. Stimulus fields convert vortices to macrospins, 18 mT loops convert macrospins to vortices. Stimulus-field amplitude changes of 0.5 mT are enough to modify microstate evolution behaviour and mode-amplitude gradient, shown by the diverse range of amplitude gradients over the field sequence.

### Supplementary Note 1.6—Reservoir Output Selection and Effects of Smoothing

FIGS. 15A-15J shows a comparison for a variety of different output options when learning to map a sine-wave to a saw-wave and a square-wave. Here, the FMR response at −1.2 mT was measured and the FMR output does not undergo any smoothing. The optimum output configuration, demonstrated by the lowest ‘test’ MSE, is task dependent. Furthermore, the sampling rate of the output also affects the prediction performance. When comparing to FIGS. 10A-10I, reasonable prediction is still obtained in the absence of FMR smoothing.

### Supplementary Note 1.7—Mackey-Glass Future Predictions

FIGS. 16A-16C shows the results for Mackey-Glass predictions from 0-100 points into the future. Here, the FMR response at Hₐₚₚ was measured and ASVI outputs are taken as the FMR amplitude from 2.6-10.5 GHz at 20 MHz steps giving a total of 397 outputs. The ASVI prediction outperforms the input prediction when the target and input waveforms are dissimilar. While the Mackey-Glass differential equation is 30 chaotic, it has an underlying approximate periodicity (here around 22-25 time steps). This leads to deceptively low MSE for the input ‘prediction’ at integer multiples of this period, as it is in-fact simply a reproduction of the target dataset with a t time-step lag, a well-known behaviour indicative of a breakdown in prediction performance. This results in a sinusoidal error profile and is therefore not a meaningful prediction. The peaks of the error profile correspond to a π/2 phase shift (panel e) τ=40) and the troughs corresponds to a π phase shift (panel f) τ=50). In each case, the inputs were linearly mapped to a field range spanning 18-23.5 mT, with the mapped field value corresponding to the maximum field of a minor loop applied to the system. The ASVI was found to display initial oscillations in prediction performance, but significantly reduced relative to the software-only, raw input prediction.

### Supplementary Note 1.8—Measuring Reservoir Output Spectra at Constant −1.2 mT Bias Field

FIGS. 17A-17H shows ASVI waveform transformation and Mackey-Glass future prediction when measuring the FMR spectra at a −1.2 mT bias field. Reasonable transformation is observed throughout demonstrating the versatility of ASVI across distinct measurement schemes.

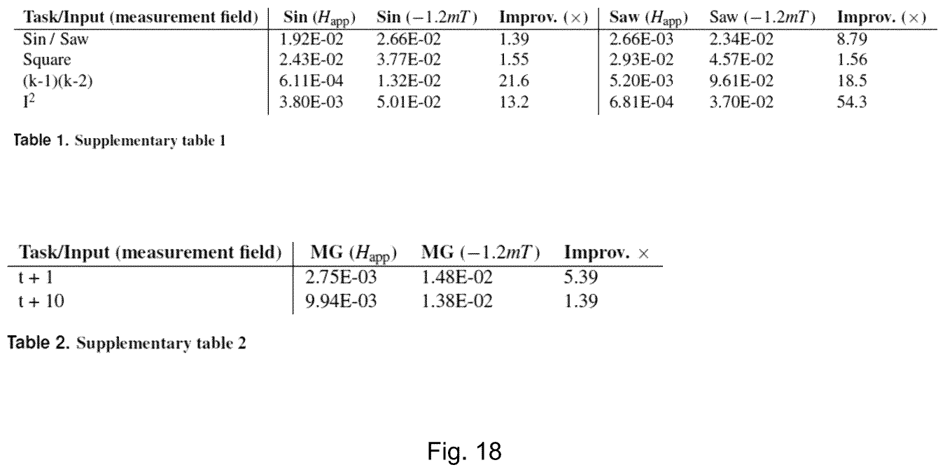

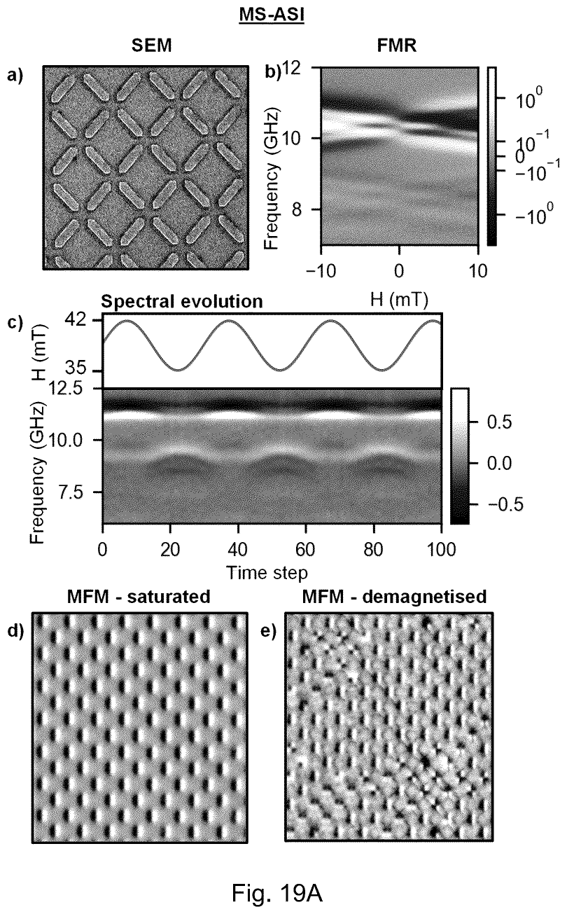

Supplementary Tables 1 & 2, shown in FIG. 18, show the MSE values and ratios when measuring at Hₐₚₚ and −1.2 mT for waveform transformation and Mackey-Glass future prediction respectively, MSE values range from 1.39-54.3×lower when measuring at Hₐₚₚ due to the additional non-linear field-dependent mode shifts when measuring at the applied field.

### Programmable, Deep and Parallel Reservoir Computing in Artificial Spin Systems

This study is an extension of “Reconfigurable training and reservoir computing in an artificial spin-vortex ice via spin-wave fingerprinting”.

The reservoir computing scheme described above under “Reconfigurable training and reservoir computing in an artificial spin-vortex ice via spin-wave fingerprinting” is good at some tasks, but breaks down for others. A good computational system should be able to solve a variety of tasks. In this section three different artificial spin reservoirs were combined to improve the versatility of the system. The same input and output approach as in the system previously described herein was used, and the inventors devised the extra steps required to make this possible. The approach of combining reservoirs is inspired by software reservoir computing studies, but there are key differences. In software-based studies, the hyperparameters of the reservoir (e.g. its size, number of interconnections etc.) are varied to optimise performance. When connecting two reservoirs, random connections between the reservoir nodes are made (again, this is optimised by performing lots of simulations). In the setup used here, neither of these things are possible, and huge arrays and a 1D input are used.

Two metrics are calculated for each reservoir: its memory and non-linearity. Good reservoir performance needs a combination of high memory and high non-linearity. When combining reservoirs in parallel (i.e. with no connections between the reservoir), the combined system has better performance for non-linear tasks. When combining reservoirs in series (referred to as deep RC or hierarchical RC in literature), improved performance in memory-dependent tasks is seen.

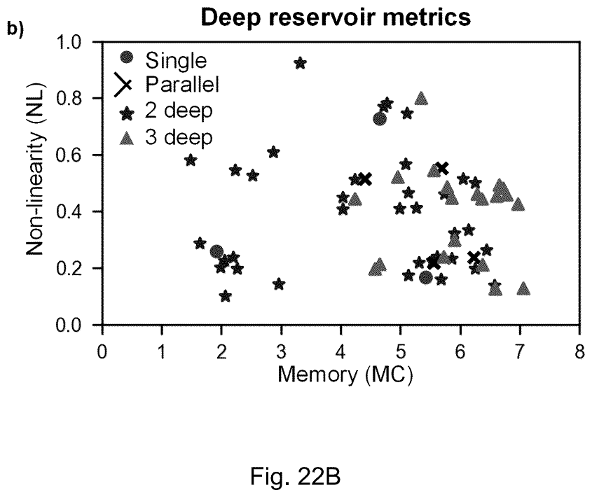

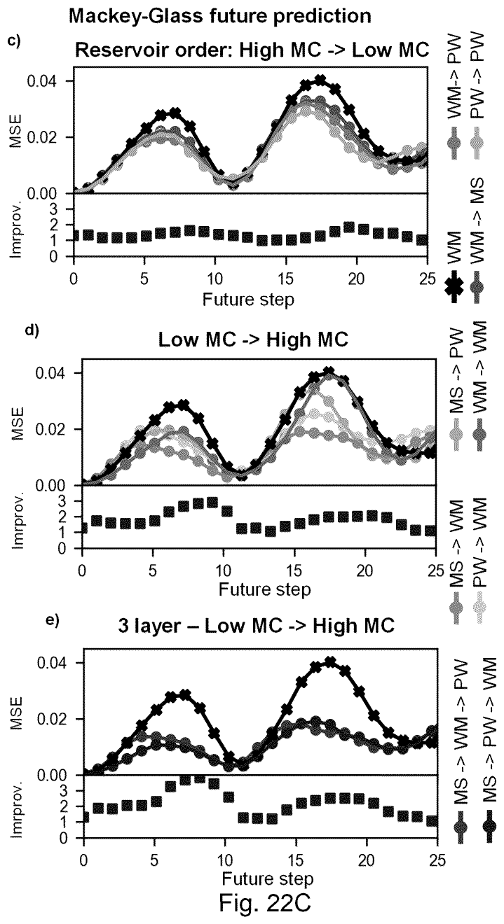

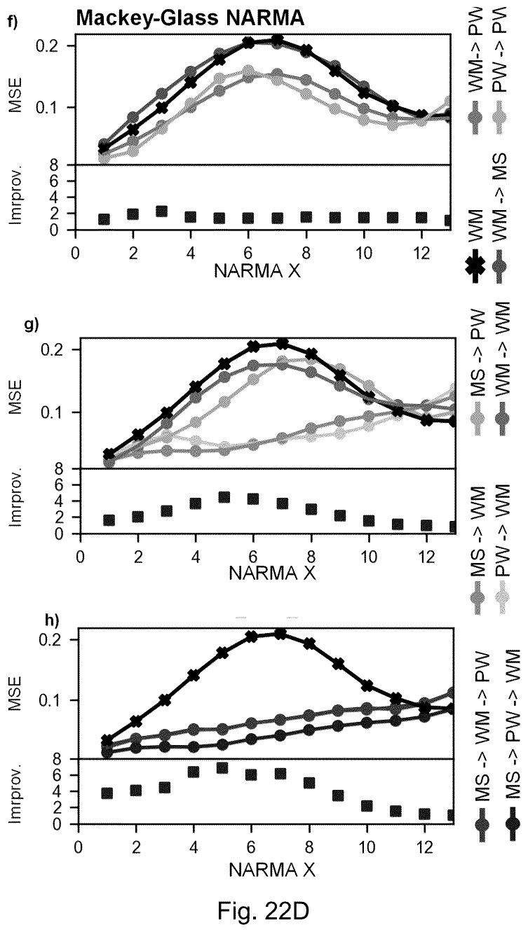

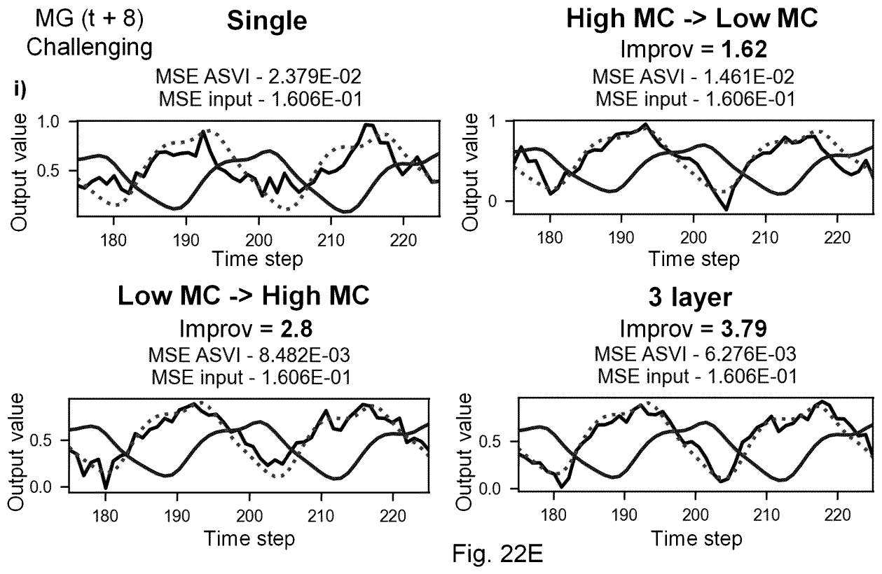

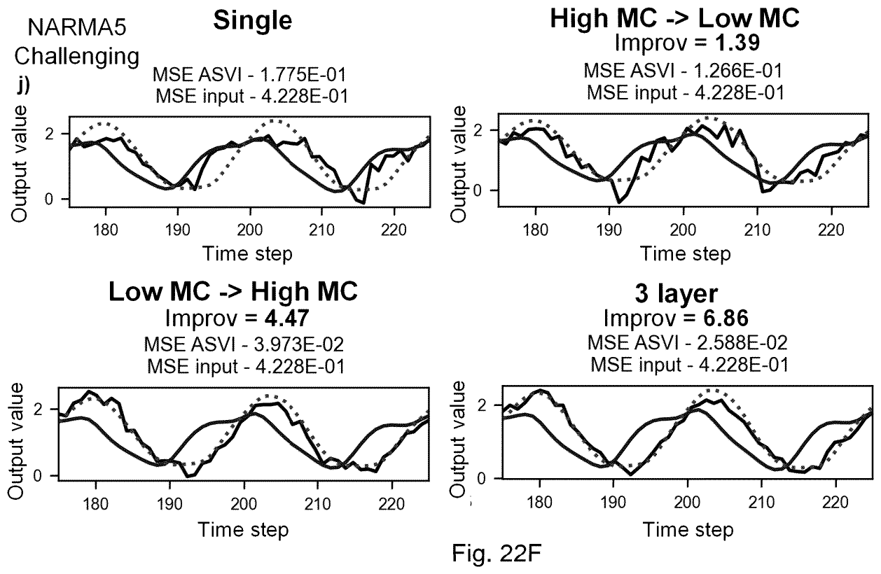

The inventors have found a simple and efficient way of connecting the reservoirs. First, memory and non-linearity of each FMR output is evaluated (FIGS. 22A-22F panels b-d)). Then, that output is fed into the second reservoir. The inventors found that if the FMR output has a high memory, so does the second reservoir (FIGS. 22A-22F panel e)). If the FMR output has a high non-linearity, so does the second reservoir (FIGS. 22A-22F panel f)). This relationship can allow for effective programming of the entire system to have a certain combination of memory and non-linearity (FIGS. 22A-22F panel g)) and can make the entire system more versatile. This method of connecting reservoirs has not been achieved before.

### Introduction

Nanoscale artificial spin systems are emerging as promising candidates for next-generation neuromorphic hardware. Their inherent passive memory, collective state-dependent dynamics and GHz response are all well-suited for technological integration. Implementing fully-trainable networks in hardware is a challenging feat due to fabrication and scalability challenges. Reservoir computing (RC) offers a simple, attractive alternative whilst retaining strong performance for time-domain tasks. Arrays of strongly-interacting nanomagnets have been theorised to possess ideal characteristics for hardware reservoir computing, but until recently, their experimental realisation was hampered by a lack of a rapid, scaleable readout.

By transitioning readout to the frequency domain, this issue was overcome to demonstrate non-linear transformation and chaotic time-series prediction. Engineering bistable elements provides ‘fading-memory’—key for reservoir computing. Here, the inventors compared artificial spin reservoirs with a range of physical properties and correlate these with computational performance and RC metrics, namely memory, non-linearity and complexity. Vortex engineering was found to be capable of significantly enhancing key RC metrics and computational performance, up to 8.8×compared to conventional artificial spin systems.

The versatility of a single artificial spin reservoir, and hardware reservoirs in general, is limited. This was countered by combining artificial spin reservoirs in parallel and deep architectures, achieving significant improvements in key RC metrics and task performance—up to ˜3×improvement for challenging time-series prediction tasks. Crucially, a method of programming architecture metrics is provided herein, allowing for versatile system reconfiguration depending on a given tasks demands, allowing for efficient performance optimisation and providing a more ‘complete’ computational platform.

In this work, the inventors began by investigating the performance of three distinct artificial spin reservoirs with varying physical properties and dynamics and relating this to their computational performance on signal transformation and chaotic time-series prediction tasks, alongside key RC metrics, namely memory, non-linearity and complexity. The presence of vortices gives rise to complex, non-linear responses boosting signal transformation performance up to 38.8×compared to conventional artificial spin systems. Engineering state energetics can give rise to distinct characteristic timescales and control over system memory, and allow for prediction of chaotic time-series. For a computational platform to be useful, it should be versatile in the tasks it can perform. However, single reservoir versatility is limited. Inspired by software-approaches, architectures of reservoirs were built up, connected in parallel and series, and enhanced RC metrics and computational performance (relative to their constituent reservoirs) were found to be able to be achieved. Parallel architectures were found to achieve up to 4×improvements in transformation tasks. Deep architectures were found to allow for enhanced architecture memory and improved prediction performance (up to 6.9×for challenging tasks). Notably, the inventors found that it was possible to overcome the issue of needing to iteratively refine parameters by devising a method of programming architecture metrics. The memory and non-linearity of interconnections and reservoir layers were found to be able to be linearly correlated, allowing for efficient reprogramming and future gradient-based training of multi-reservoir networks. This relatively simple reprogramming methodology can be used to produce an ideal set of metrics for a given task, boosting performance, and achieving a more versatile computational platform.

### Artificial Spin Systems

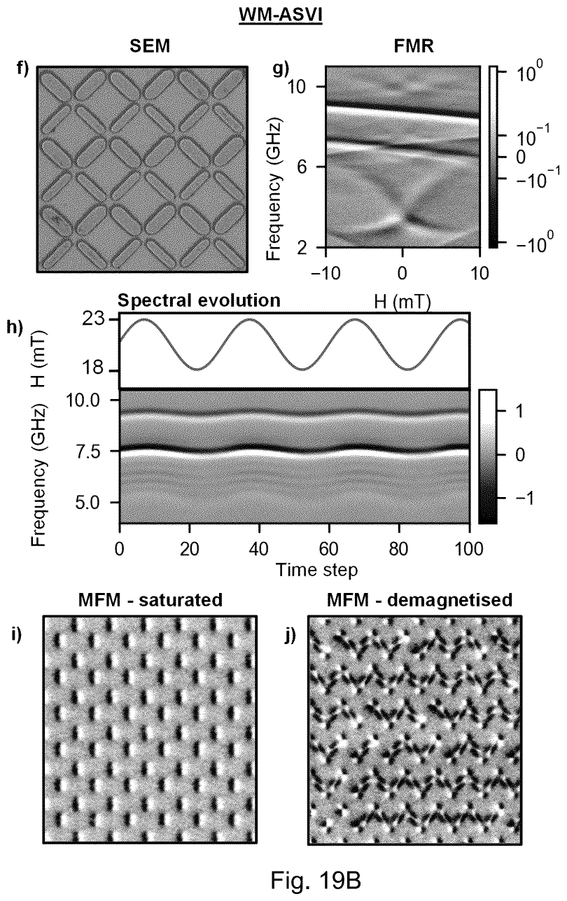

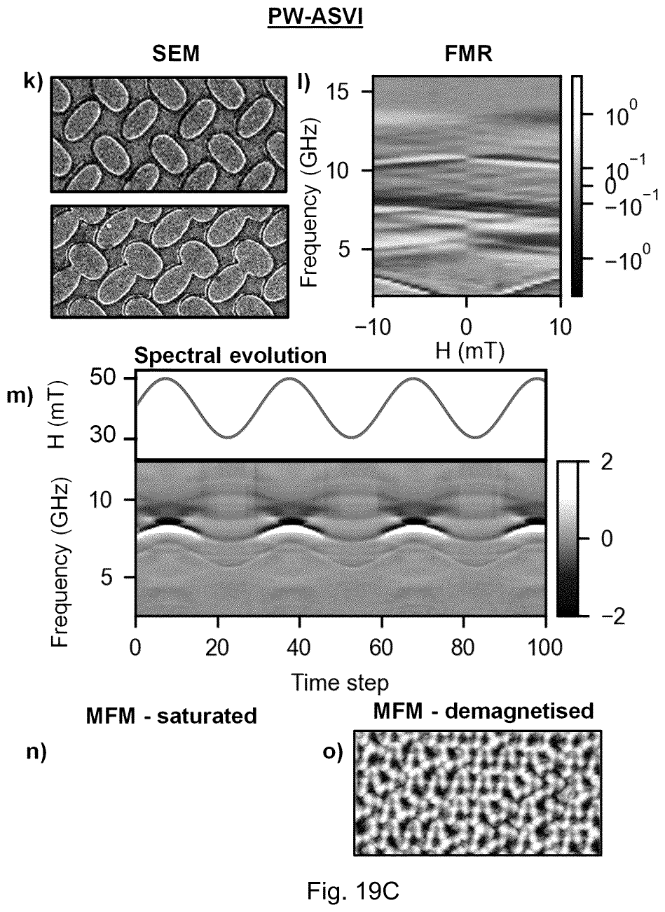

The artificial spin systems in this work are based on the square and pinwheel artificial spin ice geometry. Three samples were fabricated, macrospin square artificial spin ice (MS-ASI, FIGS. 19A-19C panels a-e)) width-modified artificial spin-vortex ice (WM-ASVI, FIGS. 19A-19C panels f-j)), and pinwheel artificial spin-vortex ice (PW-ASVI, FIGS. 19A-19C panels k-o)) via electron beam lithography (EBL) and thermal evaporation of Ni₈₀Fe₂₀. FIGS. 19A-19C shows SEM (a,f,k), field-swept FMR spectra when the sample is in a demagnetised state (b,g,l), and spectral evolution when subject to a sinusoidal field input (c,h,m) where each input value corresponds to a minor field loop, i.e. +Hₐₚₚ then −Hₐₚₚ. The samples were chosen to have a varying degree of magnetic and structural complexity producing a diverse set of computational properties (discussed later).

MS-ASI is a conventional square artificial spin ice (FIGS. 19A-19C panel a)). Bars have length 530 nm, width 120 nm and thickness 20 nm and can only host macrospin states, evidenced by MFM images in the saturated and demagnetised state (FIGS. 19A-19C panels d,e)). The FMR spectra of the demagnetised state comprises two dominant modes between 10-11 GHz with opposite gradients corresponding to macrospin resonance aligned parallel and anti-parallel to the applied field (FIGS. 19A-19C panels b,c)). Faint subharmonic signatures are observed at ˜8 GHz. The macrospin resonances shift linearly with applied field. When applying a sine input, the two modes appear out-of-phase with each other as the microstate transitions from saturated to demagnetised ((FIGS. 19A-19C panel c), t=7 and t=22 respectively). Each individual mode comprises two overlapping peaks due to different bar widths at different regions of the sample (˜20 nm width variation across the sample).

WM-ASVI is a square-based artificial spin ice where one subset of bars is widened (FIGS. 19A-19C panel f)), in turn lowering its coercive field. Bars have length 600 nm, width 200 nm (wide-bar)/125 nm (thin-bar) and thickness 20 nm. Modifying the width of one subset allows for preparation of all long-range ordered square-ASI states. Additionally, the wide bars are fabricated such that both macrospin and vortex states are metastable (FIGS. 19A-19C panels d,e)) introducing significant complexity in the magnetisation. Vortex formation and evolution is history-dependent, providing resolvable ‘fading-memory’ and allowing time-series prediction. The FMR spectra comprises three dominant modes corresponding to the wide- and thin-bar resonance (7 GHz and 9 GHz respectively) and the vortex resonance (2-6 GHZ) (FIGS. 19A-19C panels b,c)). Vortex mode amplitude is too weak for detection at fields used for computation (18-23.5 mT) hence the spectra comprises linearly-shifting macrospin resonances. At low input amplitudes (18-20 mT), macrospins convert to vortices resulting in non-linear wide-bar mode amplitude changes which lag with respect to the input-field profile (FIGS. 19A-19C panel c)),t=20-30). This combination of linear and non-linear response is well suited to RC.

PW-ASVI, is a pinwheel-lattice ASI where each bar in a square ASI is rotated by 45° (FIGS. 19A-19C panel k)). The pinwheel geometry is chosen to enhance density, allowing for resolution of vortex modes. To further enhance the reservoirs complexity, a gradient of bar dimensions is patterned across the sample (extremities shown in FIGS. 19A-19C panel k)). Within an area of 100×100 μm², the bar dimensions are constant (length 450 nm, width 240 nm in upper panel k)). Each nanomagnet is wide enough to host both macrospin and vortex states (FIGS. 19A-19C panels n,o)) providing fading-memory and non-linear mode shifts. The result is a reservoir with both magnetic and structural complexity, giving rise to highly non-linear spectral evolution (FIGS. 19A-19C panels l,m)).

### Individual Reservoir Performance

To begin a discussion of the computational performance of each individual reservoir, how this relates to magnetisation dynamics, and how structural/magnetic state engineering can be used to design artificial spin-reservoirs reservoirs with different functionality is presented. Throughout this work, two input data sets are used: a sine-wave and the Mackey-Glass time-delay differential equation originally developed to model biological processes which takes the form

$$\frac{dx}{dt} = β \frac{{x}_{τ}}{1 + {x}_{τ}^{{}_{n}}} - λ x$$

and is evaluated numerically with β=0.2, n=10 and τ=17.

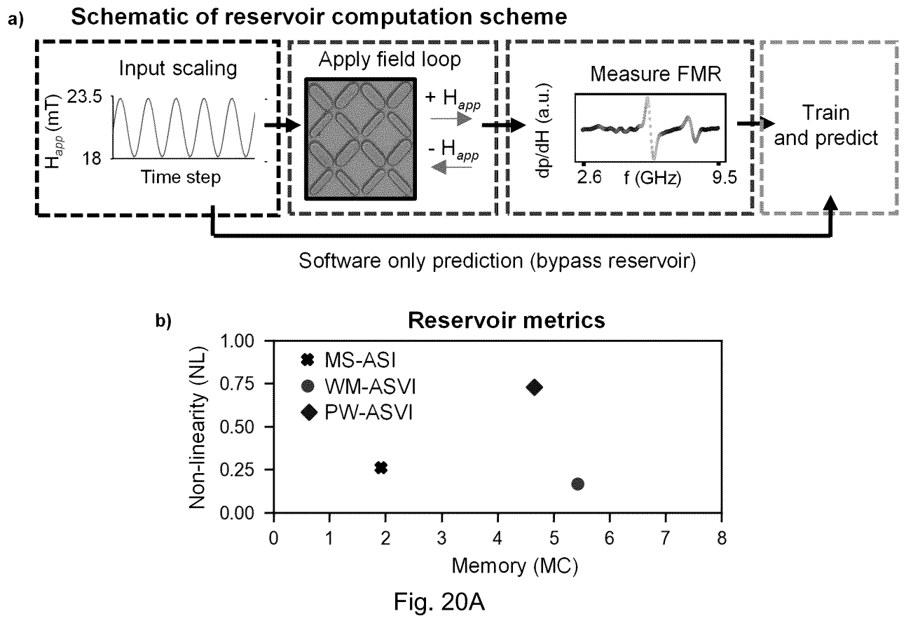

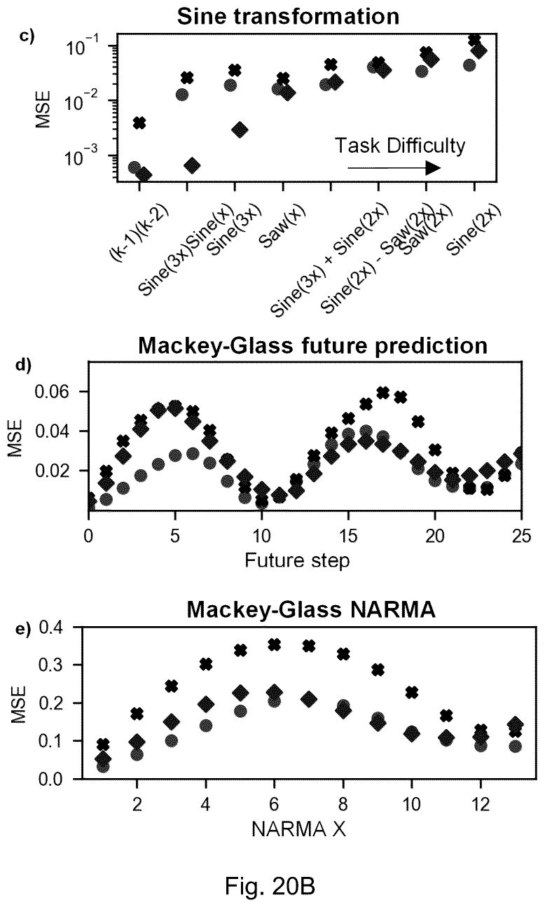

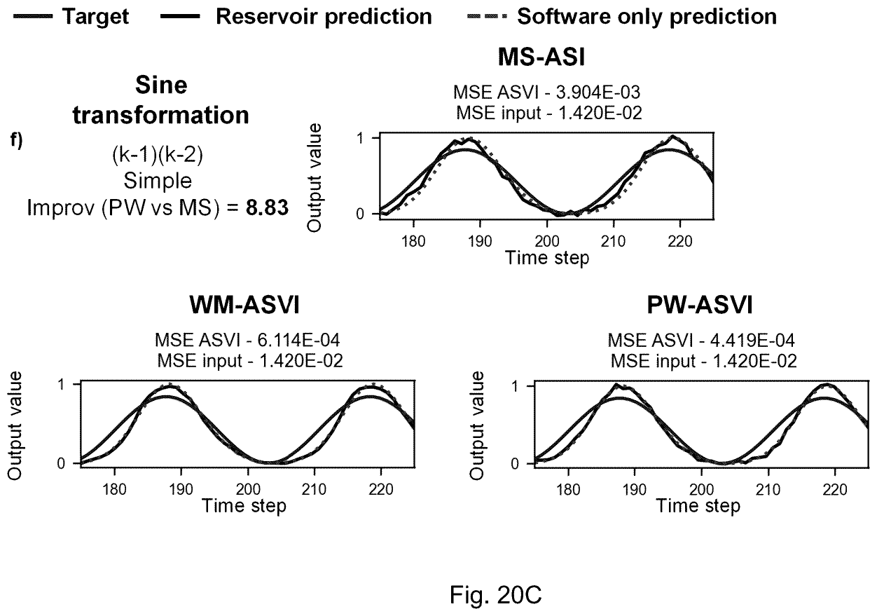

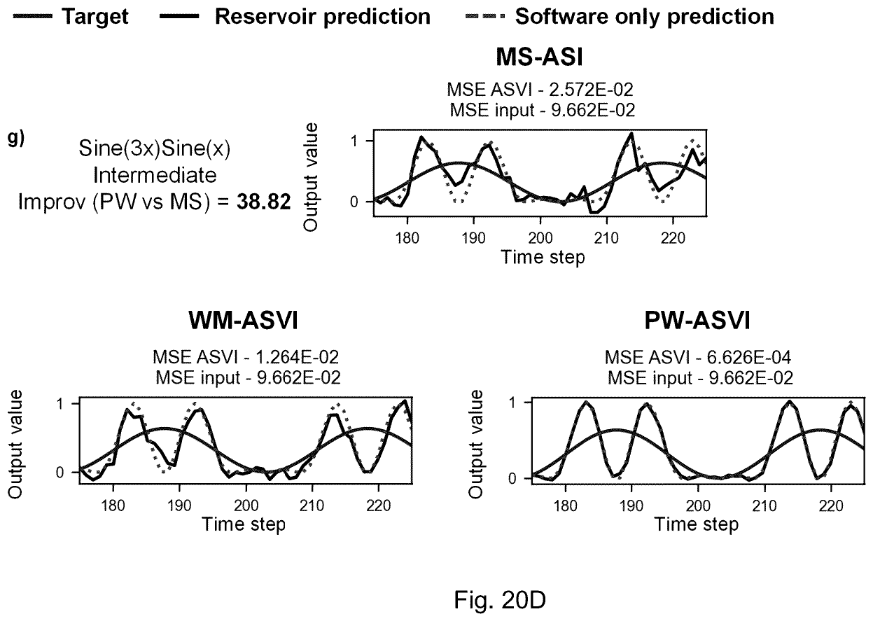

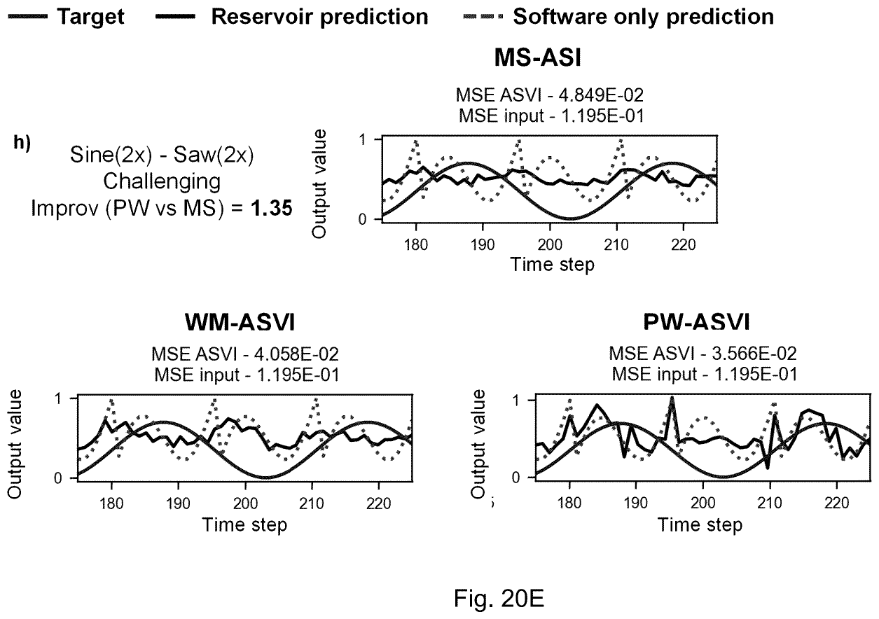

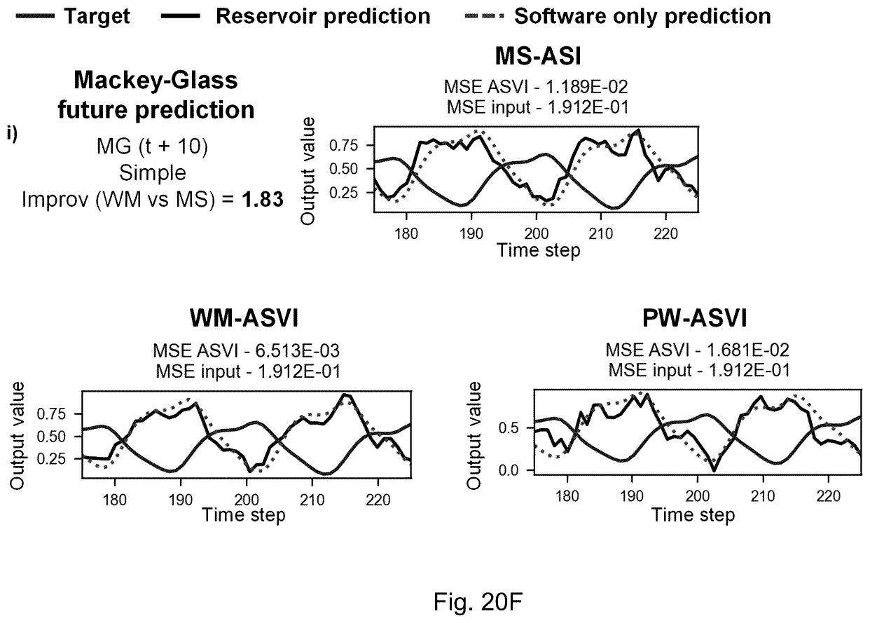

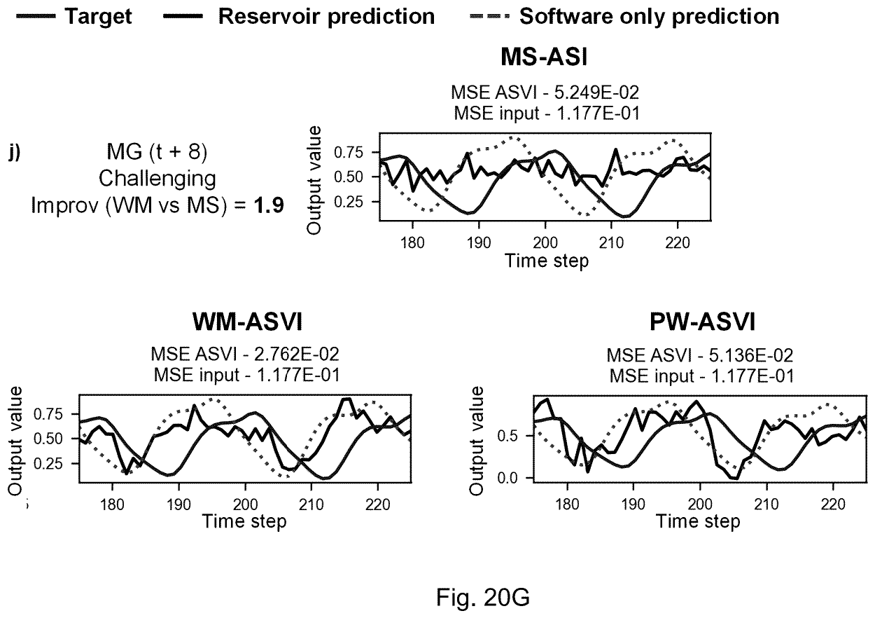

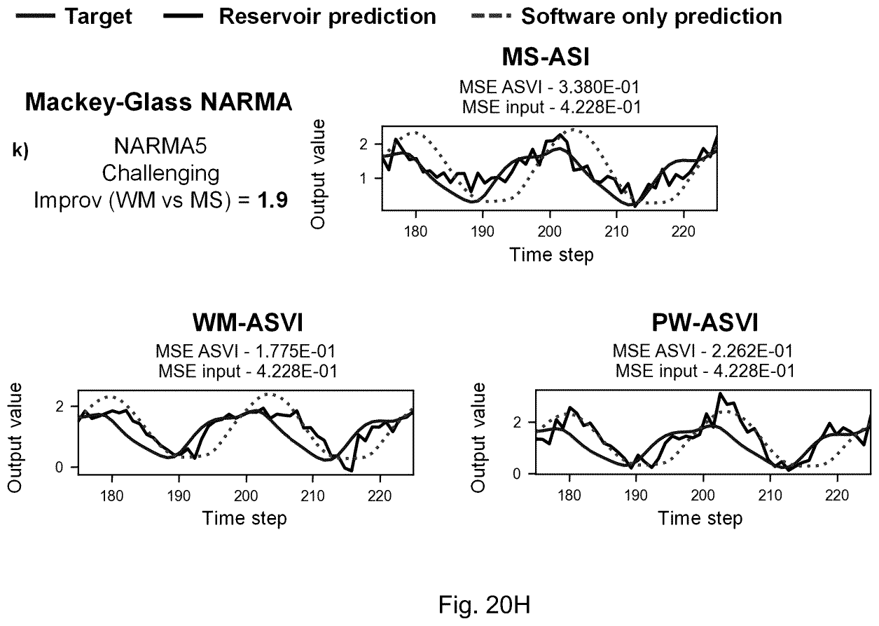

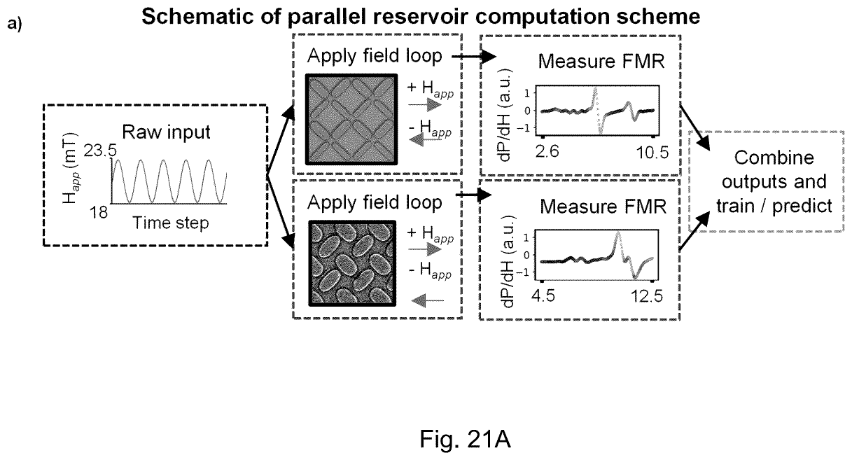

FIGS. 20A-20H panel a) shows a schematic of the reservoir computing set-up for a single reservoir. Input data is scaled to a suitable field-range depending on the sample (35-42 mT for MS-ASI, 18-23.5 mT for WM-ASVI and 30-50 mT for PW-ASVI). Input scaling is chosen to given continuous changes across the entire range. Data is input by applying a minor field-loop (i.e. apply fields at +Hₐₚₚ then −Hₐₚₚ). Computational output is obtained by probing the collective spin-wave response of the reservoir via FMR at −Hₐₚₚ. By measuring at −Hₐₚₚ, we probe microstate changes and field-dependent mode-shifts, giving enhanced computational performance. The measured FMR peaks are broad and spread over multiple outputs. As such, amplitude changes are detected simultaneously across multiple output bins are only slightly affected by field-dependent mode shifts. The process is repeated for the entire dataset with training performance offline. The FMR amplitude of each frequency bin gives one computational output resulting in 200-525 system outputs (only outputs at FMR resonance peaks are useful for computation). The dataset is split into ‘train’ and ‘test’ sets (175 and 50 data points respectively). Small ‘train’ and ‘test’ datasets are used to mimic real-world applications where low-energy requirements are desirable. A weight matrix capable of transforming the FMR spectra to the desired target waveform is calculated via ridge regression on the ‘train’ set. The weights are applied to the ‘test’ dataset and performance is evaluated by calculating the mean squared error (MSE) between predicted and target values.

To avoid overfitting, certain outputs are discarded depending on their range (i.e. max-min) over the ‘train’ dataset. The optimum number of outputs is both sample and task-dependent. Performance is optimised via a grid search where outputs are continually added in order of their range. This output selection method produces enhanced performance compared to randomly selecting or grouping neighbouring outputs (see methods).

First, two key metrics for reservoir computing, namely memory capacity (MC) and non-linearity (NL). MC and NL were evaluated following Love, J., Mulkers, J., Bourianoff, G., Leliaert, J. & Everschor-Sitte, K. Task agnostic metrics for reservoir computing. arXiv preprint arXiv: 2108.01512 (2021). MC is a measure of how correlated the current reservoir state is to previous inputs and is evaluated by using current outputs to predict past inputs via ridge regression. For each previous input, MC can range from 0 (no-memory) to 1 (perfect memory). The final value is

$${\sum }_{n = 0}^{k} M {C}_{n}$$

where k is the number of past outputs that the MC is evaluated on (here, k=8). In artificial spin systems, MC arises from history-dependent microstate evolution, detected by changing in peak amplitude. The measured FMR peaks are broad and peak amplitude variations are detected across a number of output bins. As such, a single output can still possess memory, despite the field-induced frequency (output) shifting. NL is a measure of how well the past inputs can be used to predict the current outputs using a linear estimator. Again, this ranges from 0 (perfectly linear) to 1 (non-linear). Non-linearity can arise from four effects: non-linear mode-shifts with field, the shape of the FMR peaks, complex microstate dynamics, and from outputs which do not vary with applied field.

The later effect is avoided by discarding outputs far from resonant peaks. These metrics allow mapping of physical and computational properties and for comparing different physical reservoirs, shedding light on how the underlying system dynamics affects computational properties. When evaluating MC and NL, it is conventional to use a random input. However, in this scheme, discontinuities in the input field arising from discontinuous data input translate to sharp mode-shifts, obscuring results. As such, here the metrics are evaluated using a Mackey-Glass input. This prevents comparison to other physical reservoirs. This may be resolved by measuring at a fixed bias field, at the sacrifice of reduced computational performance.

FIGS. 20A-20H panel b) shows the MC and NL for each sample when subject to a Mackey-Glass input. MC and NL are evaluated on the 60 highest ranging outputs. MC is correlated with the presence of vortices and their evolution. WM-ASVI exhibits continued vortex formation up to 30 loops and a ‘fading-memory’ of up to 10 loops resulting in a high MC. PW-ASVI also possesses complex vortex dynamics and a high MC. MC is lower than WM-ASVI due to rapid settling of microstate when subject to repeated field cycles and a higher input scaling shifting peaks across multiple outputs. MS-ASI has no vortices and a corresponding low MC due to rapid settling of the system microstate when subject to continued field loops. The presence of memory in the microstate dynamics and a multi-dimensional readout distinguishes the computational scheme presented here from other nanomagnetic systems where nanoelements are strictly non-linear or where 1D readout does not allow for harnessing of system memory. NL is related to field-dependent modes shifts, FMR peak shapes and microstate dynamics. The predominant modes in MS-ASI vary linearly with field resulting in a low NL. Although WM-HDS displays non-linear amplitude changes with field, the effect is dominated by linear-mode shifts of the macrospin resonances, hence a low NL is observed. Conversely, PW-ASVI has strongly non-linear mode shifts and microstate dynamics resulting in a high NL. Both MC and NL are dependent on input scaling and optimisation of system parameters is expected to yield improved metrics. In this work, input scaling is kept the same for each reservoir and improvements in metrics are solely due to architecture modifications.

FIGS. 20A-20H panel c) shows the performance of each reservoir when transforming a sine-wave input (sine(x)) to a variety of different waveforms with different difficulty: a second-order non-linear hysteretic transformation (k−1)(k−2), sine(3x)sine(x), sine(3x), saw(x), sine(3x)+sine(2x), sine(2x)−saw(2x), saw(2x), sine(2x). Tasks were chosen to have a range of difficulties and are presented in order of the lowest reservoir MSE. FIGS. 20A-20H panels f-h) shows example transformations (black curves) alongside the software-only prediction when bypassing the reservoir (blue curves) for f) (k−1)(k−2), g) sine(3x)sine(x) and h) sine(2x)−saw(2x). In all-cases, the prediction when bypassing the reservoir fails completely and simply recreates the input signal. Sine transformations require significant NL. The benefits of vortices are best observed for simple and intermediate tasks (FIGS. 20A-20H panels f,g)) where including vortices significantly increases performance up to 38.81×compared to conventional artificial spin systems. PW-ASVI was found to display the strongest performance due to the rich, non-linear microstate and spin-wave dynamics from vortex states which can be detected in this reservoir. As such, engineering nanomagnetic system with both structural and detectable magnetic complexity was found to be able to notably improve performance for NL dominated tasks. WM-ASVI outperforms MS-ASI despite having a lower NL. Vortex formation in WM-ASVI is both history-dependent (as reflected in MC) and results in significant amplitude changes and enhanced frequency shifts due to significant changes in the local-dipolar field landscape. This manifests as more meaningful NL, despite the overall metric being lower. For challenging tasks (e.g. sine(2x)−saw(2x), panel h)), the performance of all reservoirs breaks down, a common feature of physical reservoirs where good performance is seen for a handful of specific tasks.

FIGS. 20A-20H panel d) shows the performance of each sample when predicting future values of the Mackey-Glass equation. Example ‘train’ and ‘test’ plots are shown in FIGS. 20A-20H panels i,j) for t+10 (simple) and t+8 (challenging). t+10 is a simpler task due to the periodic nature of the Mackey-Glass equation. This task favours high MC and low NL as seen by WM-ASVI outperforming the other two reservoirs. FIGS. 20A-20H panel e) shows the performance when transforming to a NARMA model with Mackey-Glass input evaluated as

$$y ( t ) = Ay ( t - 1 ) + By ( t - 1 ) {\sum }_{n = 1}^{X} y ( t - X ) + Cu ( t - 1 ) u ( t - X ) + D$$

with A=0.3, B=0.01, C=2, D=0.1. X varies between 1 and 13. This task favours high MC with WM-ASVI and PW-ASVI performing similarly across all tasks. Example plots for challenging NARMA5 is shown in FIGS. 20A-20H panel k). These results further demonstrate the benefits of structural and magnetic complexity design. Engineering nanomagnetic systems to contain long-term non-linear microstate evolution, provided by vortices, and linear responses to applied field, provided by macrospins, can allow for good predictions of chaotic time-series at simple time-steps. For all samples, a breakdown in performance was again seen for difficult tasks, observed by the periodic MSE profile. This is clearly observed when predicting t+8 and NARMA5 (FIGS. 20A-20H panels j,k)) where the predicted values do not resemble the target waveform. This is firstly due to the fact that, whilst the Mackey-glass equation is chaotic, it has an underlying periodicity with an approximate period of 22 points. As such, minima in the MSE curves occur at ˜nπ/2 intervals of this period (n is an integer). Maxima are found at ˜mπ/4 intervals where m is odd. If we consider two inputs at a trough of the Mackey-Glass equation, the variation between these inputs is small. For t+12, the inventors predict the response is at the peak of the MG equation, which also has a small change, hence the mapping between a small input change to a small output change (with some additional non-linearity,) can be easily handled. However, when predicting t+8, a small input change corresponds to a large output change. Transforming this small input variation to a large output variation can be a difficult task. This is where schemes with homogeneous field input and an FMR readout of the entire array can be limited. Every nanomagnet within the reservoir is subject to the same input. If inputs were applied to only a subset of the nanomagnets, then recurrent connections within the system would allow for a more diverse set of responses which may be harnessed during training.

Thus, bistable spin-textures can be used for reservoir computation in artificial spin systems. Introducing vortices provides enhanced MC and NL, and can be used for time-series transformation and prediction tasks.

### Parallel Reservoir Computing

The inventors found that no individual artificial spin reservoir is capable of performing well across a variety of tasks. In order for a computational system to be effective, its functionality should be versatile. Increasing the size of a reservoir can be used as a technique for improving performance. However, physical reservoirs often comprise nodes which are similar in behaviour. Furthermore, the FMR readout employed in this work measures the collective response of the system as opposed to the response of individual elements. Extending the array size of artificial spin systems beyond one hundred microns can increase the signal to noise ratio of the readout, but the underlying dynamics and computational performance of the physical system will remain the same. Instead, separate reservoirs can be combined in architectures in order to harness their different behaviours. This approach has been demonstrated in software-based reservoirs showing enhanced system diversity compared to simply increasing the size of a single reservoir.

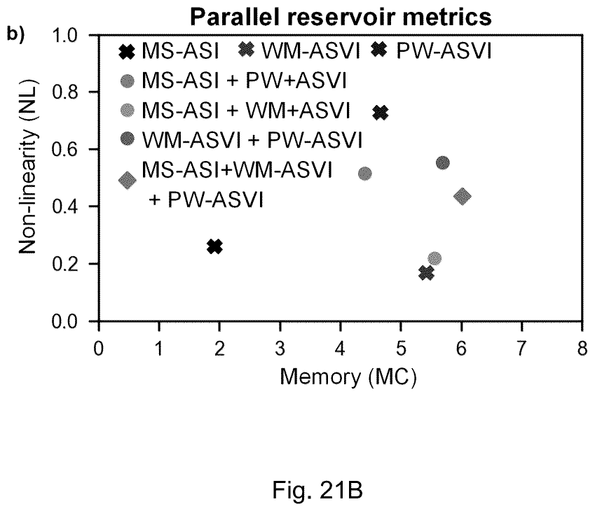

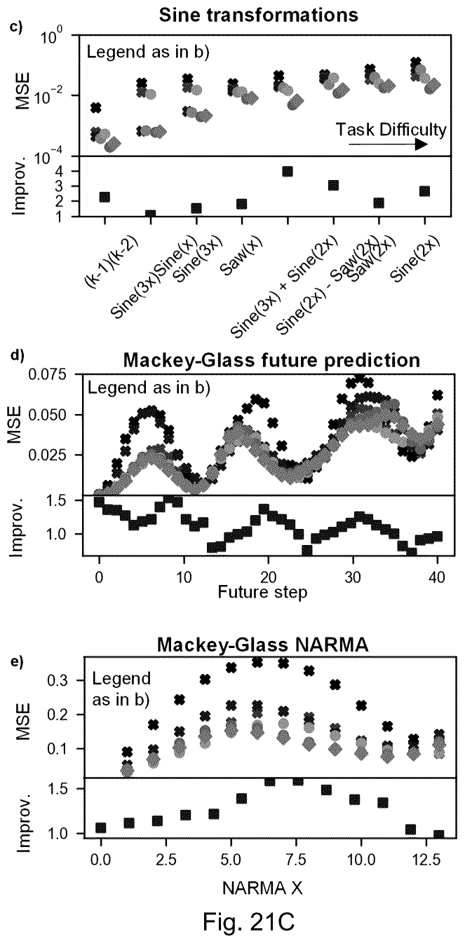

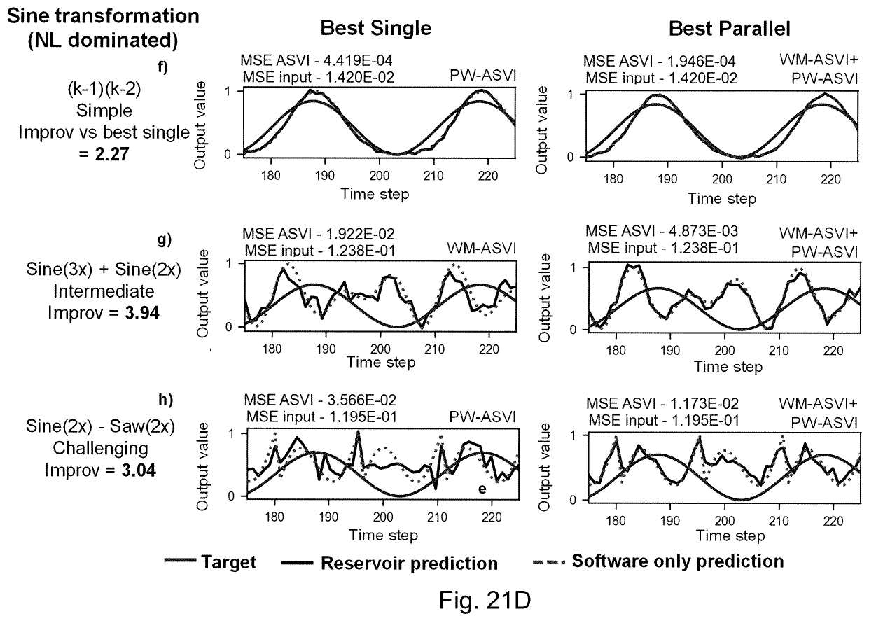

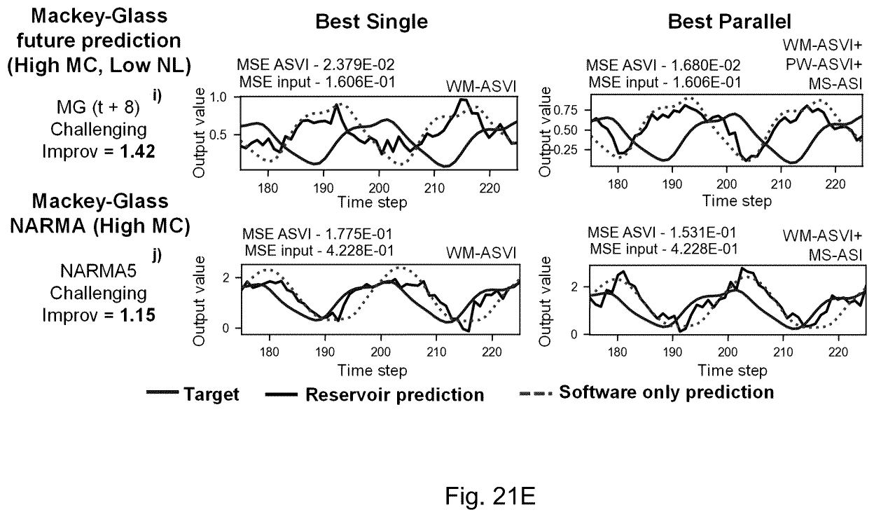

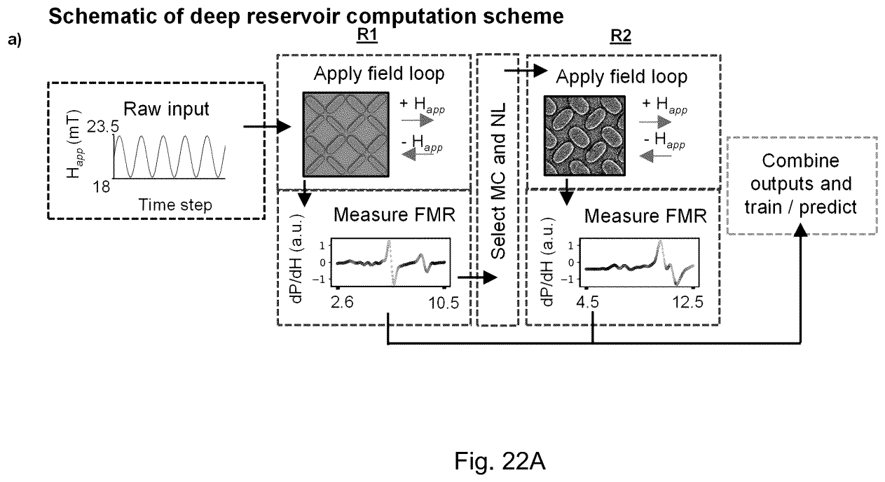

FIGS. 21A-21E panel a) shows a schematic of the parallel reservoir computing configuration. Here, the same computational scheme shown previously is used, except that data is input to multiple separate reservoirs. Their FMR response is measured and then combined to produce one set of outputs.

FIGS. 21A-21E panel b) shows the metrics of the single and parallel combinations. Each architecture contains a total of 60 outputs (i.e. two parallel reservoirs contribute 30 outputs each). When combining reservoirs in parallel, the complete system is able to harness the individual reservoir metrics to produce a more complete system. The NL of the parallel architectures averages the NL of the constituent reservoirs. The MC is slightly enhanced as the total system is able to access different types of memory from the constituent systems.

FIGS. 21A-21E panel c) shows the MSE of the single and parallel architectures when transforming a sine input. The number of outputs for each task and architecture are chosen to give the lowest MSE. Enhanced performance (lower MSE) is observed across all tasks. Example transformations are shown for the best single and parallel architecture for f) (k−1)(k−2) (simple), g) sine(3x)+sine(2x) (intermediate), h) sine(2x)−saw(2x) (challenging). The optimum architecture is typically WM-ASVI+PW-ASVI (i.e. samples with vortices). This is due to the combined parallel system containing a more diverse set of responses which can be harnessed during training. Adding MS-ASI to create a parallel architecture with all three reservoirs typically worsens performance, due to the poor performance of the MS-ASI adversely affecting weight calculation. FIGS. 21A-21E panel c) also shows the improvement ratio (MSE_{single}/MSEₚₐᵣₐₗₗₑₗ) for the best single and best parallel architecture. Significant improvements are observed for more challenging tasks where individual reservoirs breakdown. Up to 3.94×improvements are observed (sine (3x)+sine (2x), panel g)). By comparing performance across a range of output combinations, the inventors found that the improvements shown are not an effect of simply adding more system outputs and trainable parameters. Instead, the enhanced response was found to be due to a more diverse and independent set of output responses.

Contrastingly, the same level of improvements were not observed when predicting future values of the Mackey-Glass equation or transforming to the Mackey-Glass NARMA model. FIGS. 21A-21E panel d) shows MSE profiles for all single and parallel combinations when predicting 0-20 steps into the future. Here, only slight improvements in the MSE are seen for certain tasks, reflected by the low improvement factors (<1.5×). The same behaviour is observed for the Mackey-Glass NARMA transformation. FIGS. 21A-21E panels i,j) show example predictions for t+8 (i) and NARMA5 (j) for the best single and parallel architectures. Only slight improvements in the MSE are observed with prediction still failing for difficult tasks. These observations are expected as improving the performance in these tasks requires an improved memory. When combining reservoirs in parallel, memory cannot be passed from one reservoir to the next. We see a slight increase in MC when combining reservoirs in parallel, and a slightly increase in performance, which was found to be due to the fact that each reservoir does not remember the n^{th} previous step perfectly (MCₙ<1). Combining reservoirs in parallel can increase MCₙ, but the maximum value of n which the combined reservoirs can ‘remember’ cannot increase.

### Deep Reservoir Computing

To enhance the MC of multi-reservoir architectures the inventors appreciated that they can instead combine reservoirs in series, feeding data from the output of one reservoir as the input to the next. This approach is more akin to feedforward neural networks where data is fed through numerous layers before reaching the output. Creating a network of reservoirs can combine the energy efficiency gained from the reduced training requirements of reservoir computing with the performance gains of layered networks.

FIGS. 22A-22F panel a) shows a schematic of the deep reservoir architecture. Data is input to the first reservoir layer (R1) and the FMR response is measured as previously described. This scheme currently relies on 1D field input, as such, the FMR response of R1 must be converted to 1D. To do so, we take the FMR amplitude of a certain frequency bin and scale it to an appropriate field range. The output is chosen by evaluating its MC and NL (discussed later). This output is then input to the second layer (R2). The FMR outputs of all layers are combined for training and prediction.

FIGS. 22A-22F panel b) shows the MC and NL for single (red circles), parallel (black crosses), two-layered (blue star) and three-layered (green triangle) reservoir architectures. For each deep architecture, multiple later connections (i.e. FMR outputs from R1) are trialled. The range of possible metric combinations is vast, spanning across a wide variety of MC and NL values. Crucially for prediction tasks, MC can be extended far beyond that of single and parallel architectures, getting close to the maximum MC of 8.

The ordering of reservoirs within a deep architecture significantly affects performance. FIGS. 22A-22F panels c-d) shows MSE profiles when predicting future values of the Mackey-Glass equation for c) high MC to low MC and d) low MC to high MC. Equivalent plots for NARMA are show in panels f and g. For simplicity, the best interconnection combination for each reservoir architecture is shown. When going from a high MC to low MC reservoir (c,f), the improvements of 2 are observed for all tasks. However, when going from low MC to high MC (d,g), significant improvements, up to 2.8× and 4.47×for challenging t+8 and NARMA5 tasks respectively. Adding an additional layer (panels e and h) further enhances performance to 3.79× and 6.86×.

The difference can be explained as follows: if R1 has a low MC, then its response is very dependent on the current input and is not obscured by past input values. When this information is transferred, R2 receives information predominantly about the current input with some slight past input dependence which it can then ‘remember’. As such, short-term memory is retained in R1 and long-term memory is retained in R2. In the other scenario, i.e. high MC to low MC, R1 output will only slightly depend on the current input. When this information is transferred, R2 simply mimics this information. As such, neither R1 nor R2 retain a reasonable short-term memory, only long-term correlations are present, reducing the overall system memory. These results confirm predictions from software-based reservoirs where the ordering of system dynamics plays a crucial role in the architectures performance.

Prediction profiles are shown in FIGS. 22A-22F for panel i) t+8 prediction and panel j) NARMA5. The optimum performance is found for MS-ASI-WM-ASVI (2 layers, MC=6.6, NL=0.11) and MS-ASI-PW-ASVI-WM-ASVI (3 layers, MC=7.1, NL=1.1) for both tasks which have the highest MC and lowest NL. The correct ordering of reservoirs and enhanced MC results in predicted profiles which closely match the target wave. The most important aspect is that the performance improvements are found across a broad range of tasks, observed by the flattening of the MSE profiles, producing a more ‘complete’ computational system which performs well across a wide range of tasks. NARMA MSE profile becomes linear with increasing X (FIGS. 22A-22F panel h)), as expected for architectures with high MC. Furthermore, the improvement is performance is non-linear (i.e. doubling the number of reservoirs results in 2×performance). Whilst the MSE profile for predicting future steps in the Mackey-Glass equation has flattened, it still displays a periodic profile (FIGS. 22A-22F panel e)). Further improvements can be gained (up to a point) by introducing more reservoir layers or by optimising the interconnections.

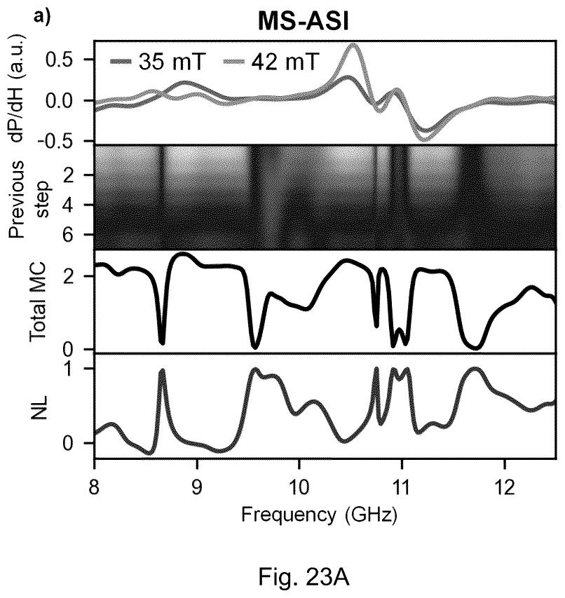

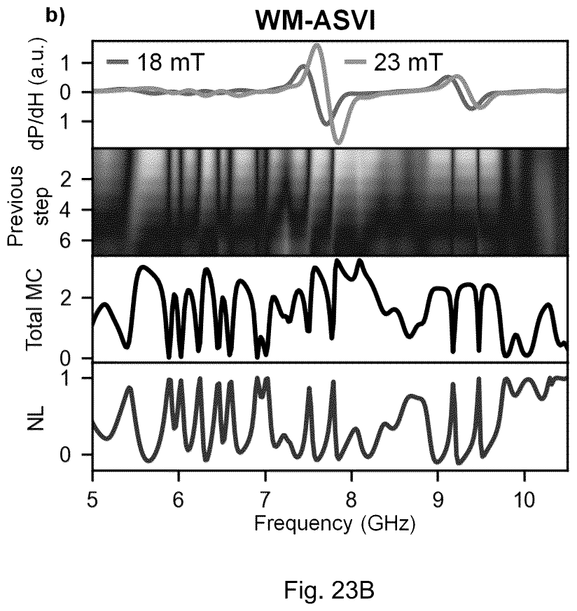

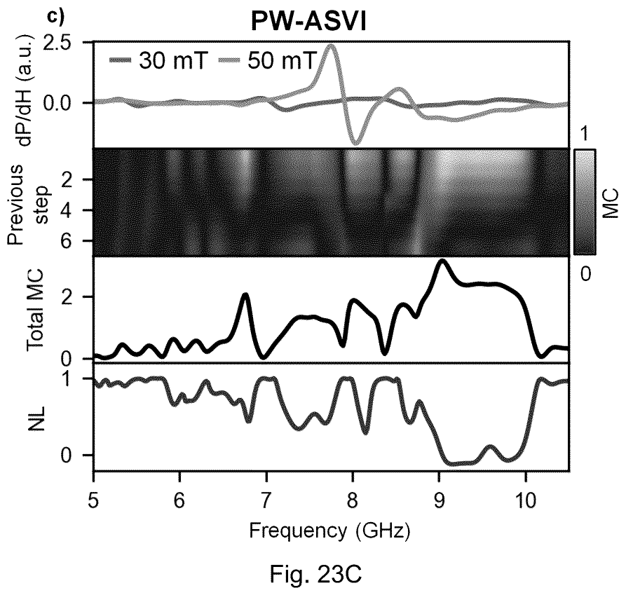

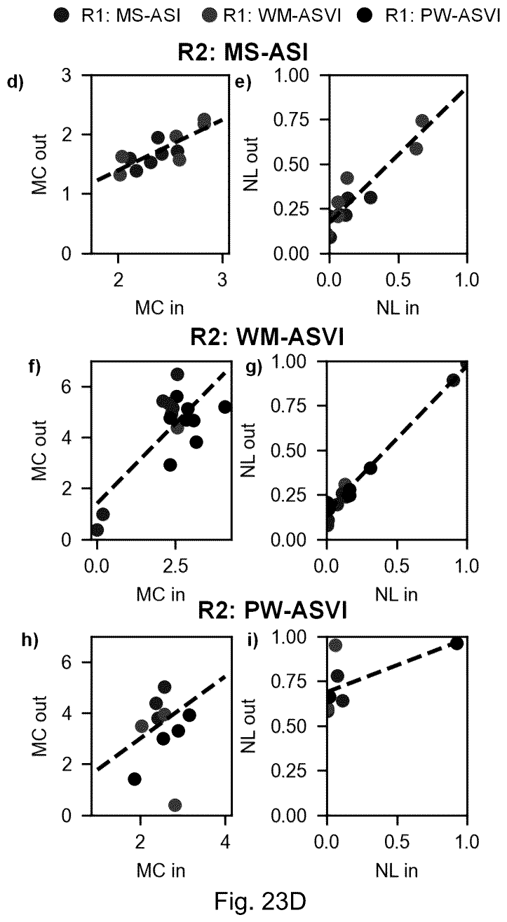

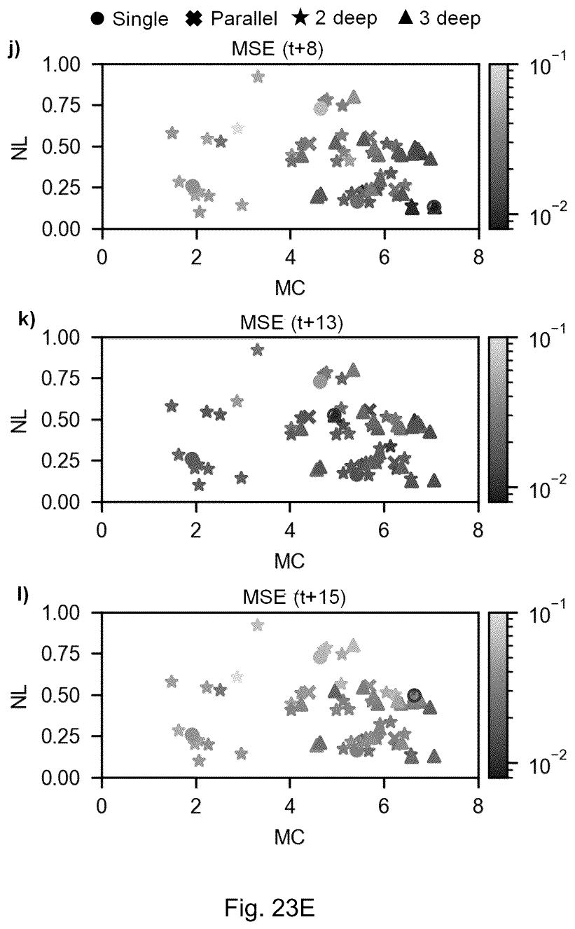

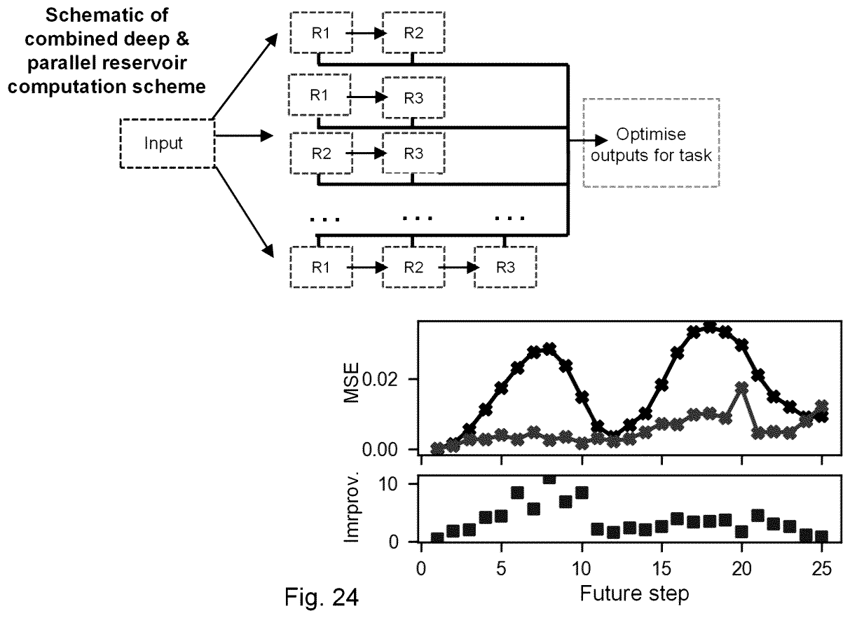

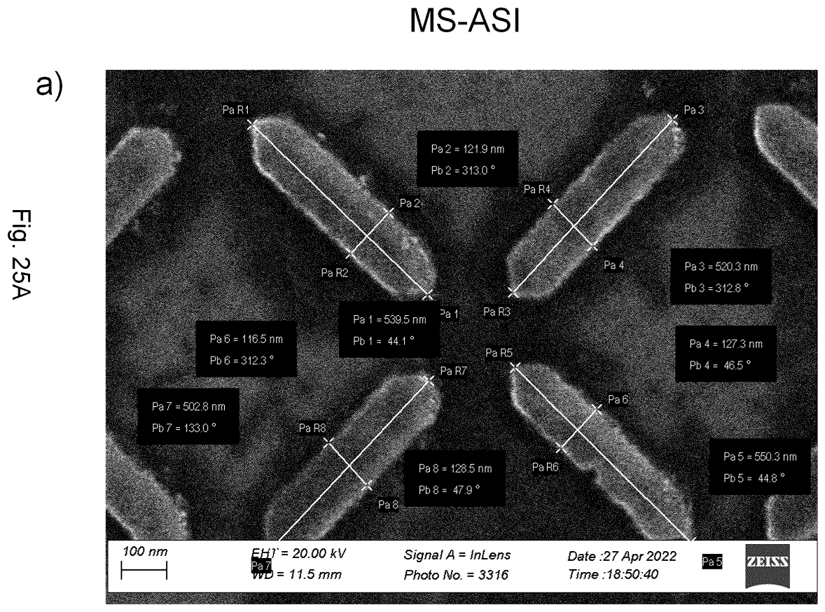

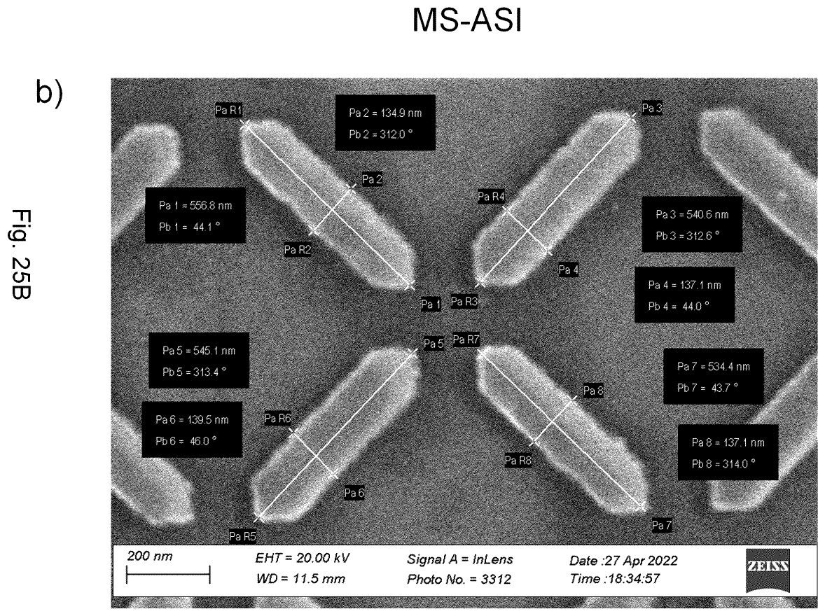

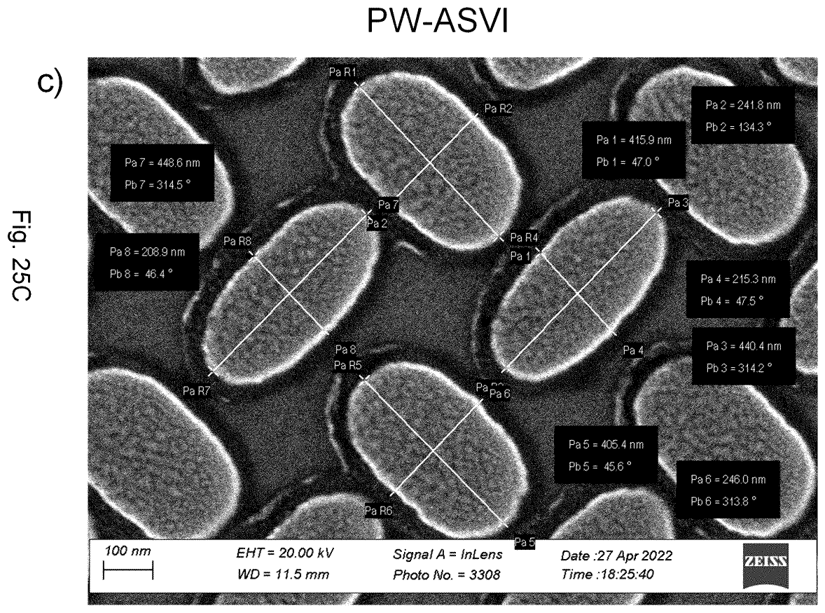

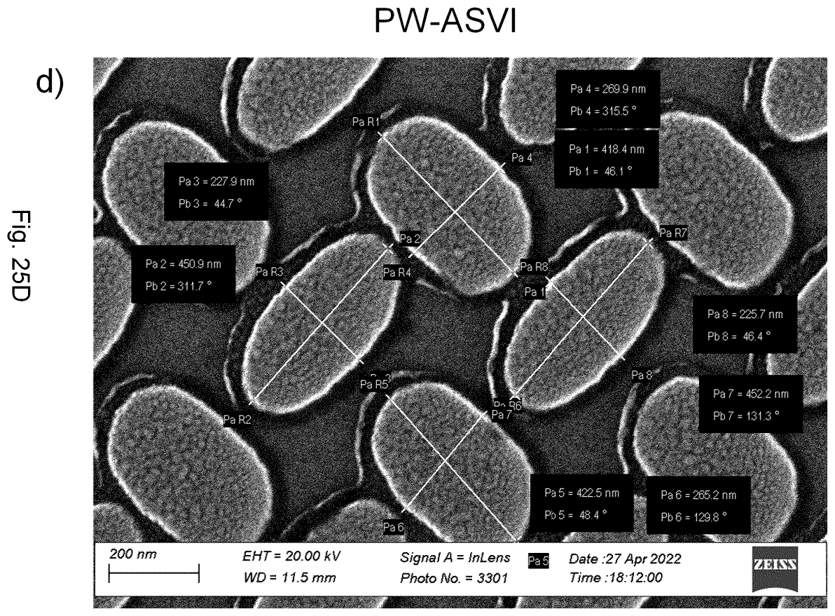

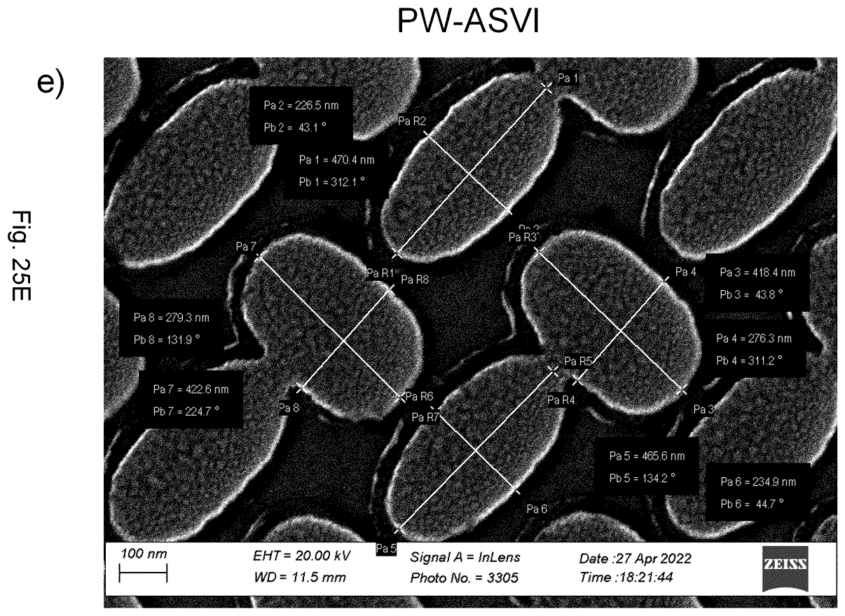

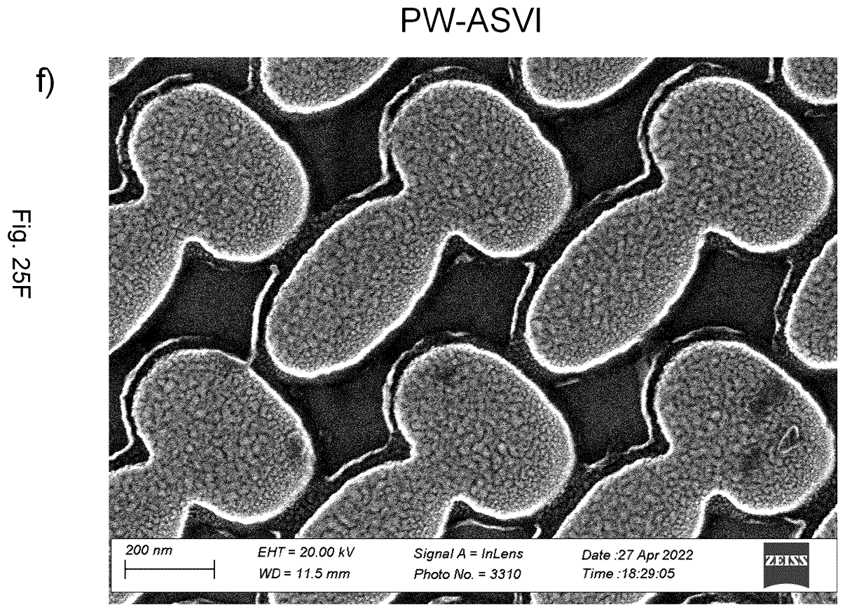

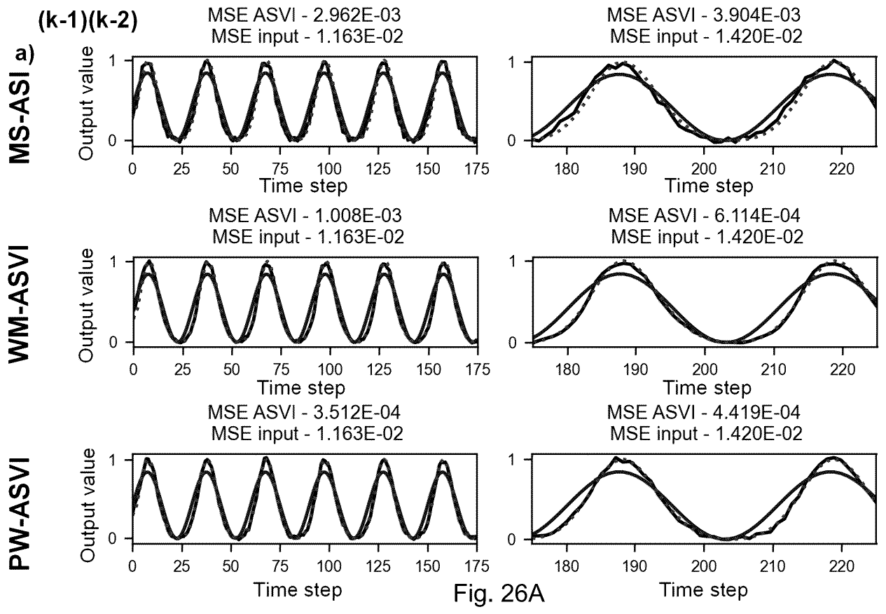

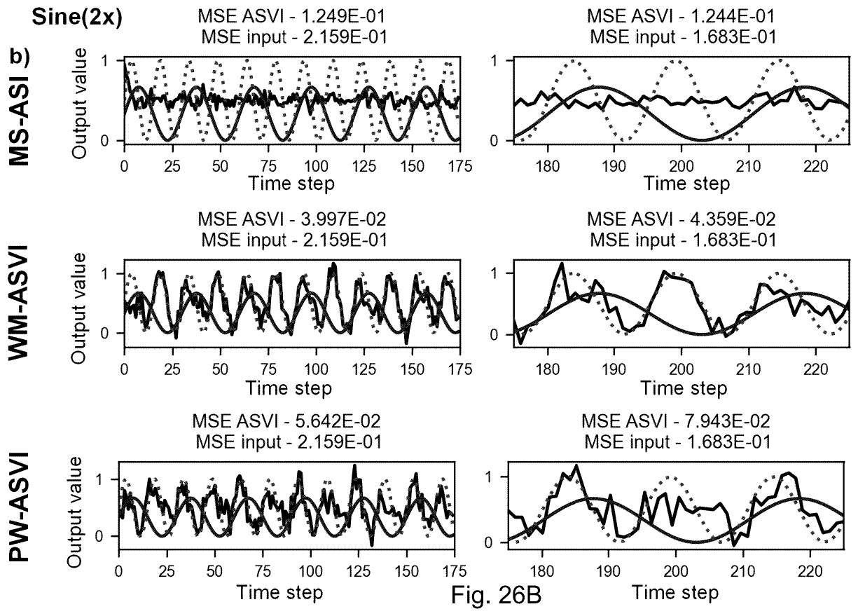

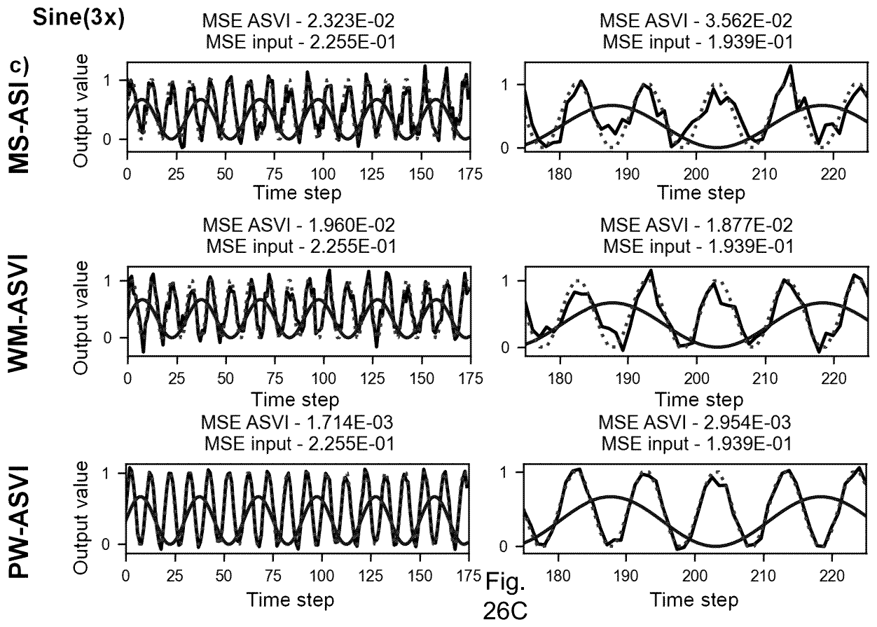

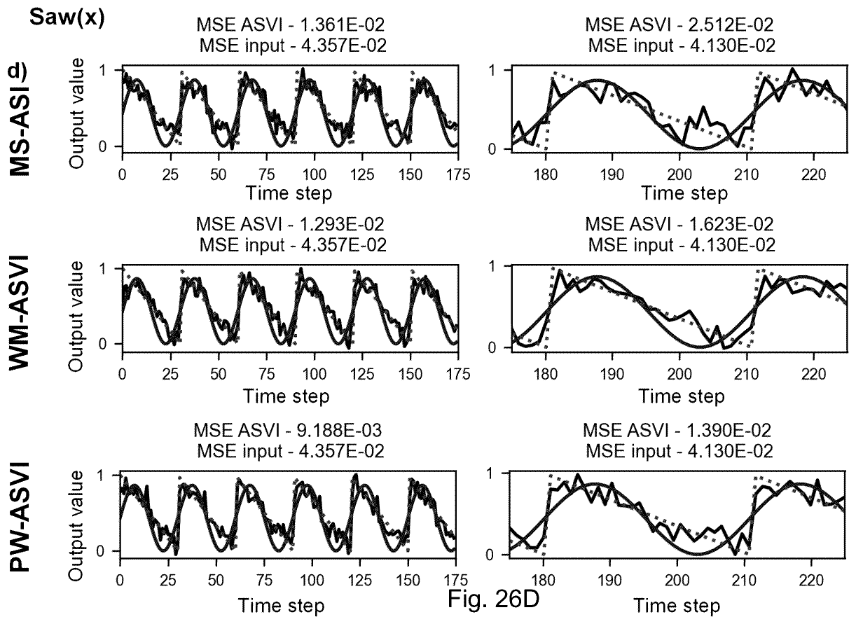

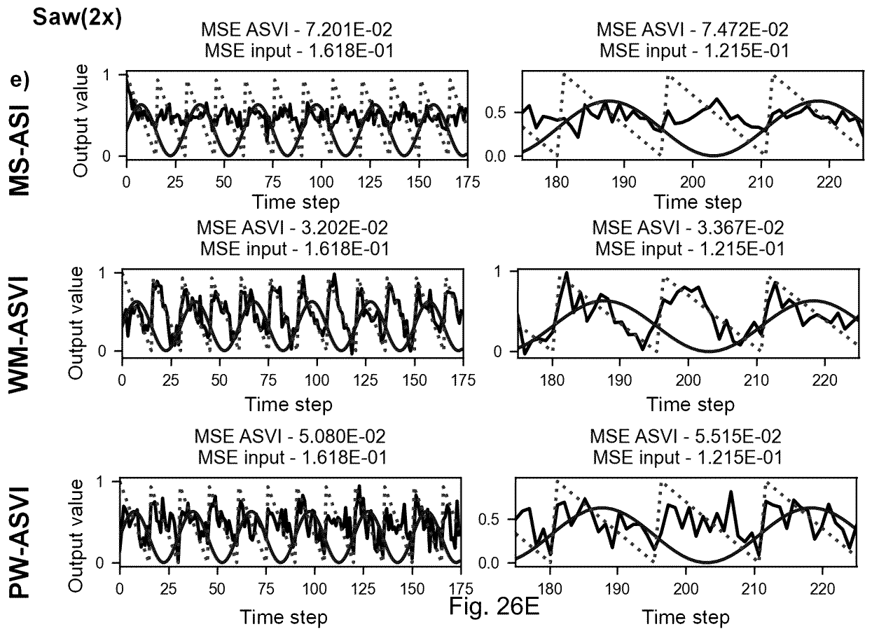

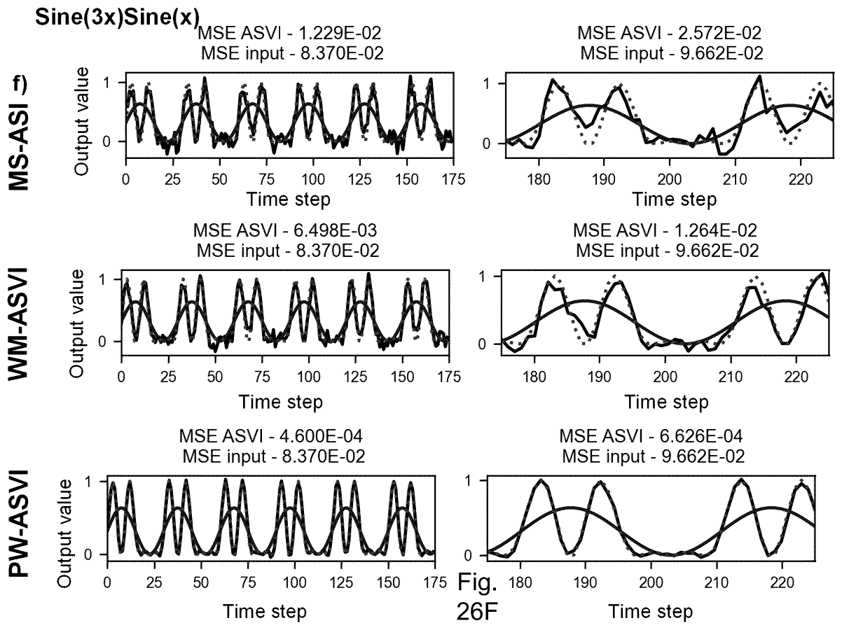

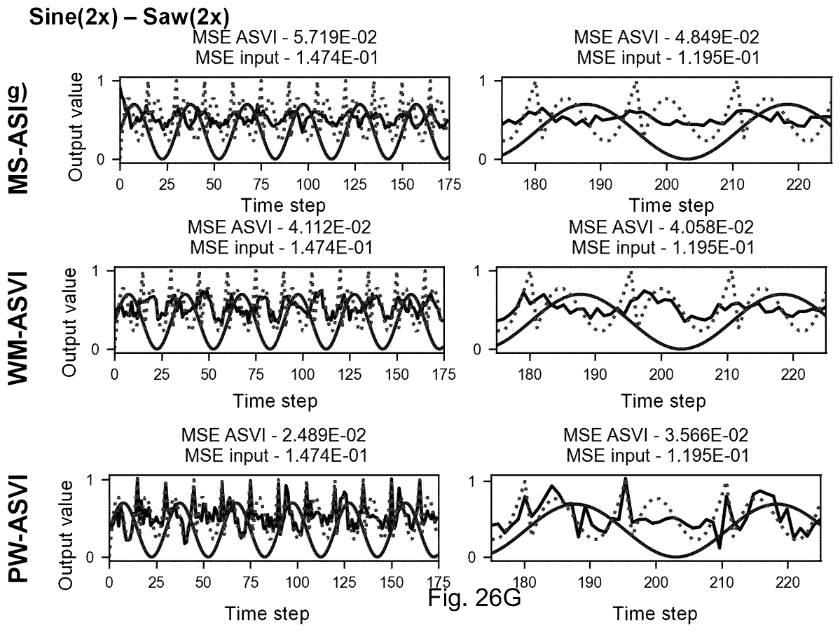

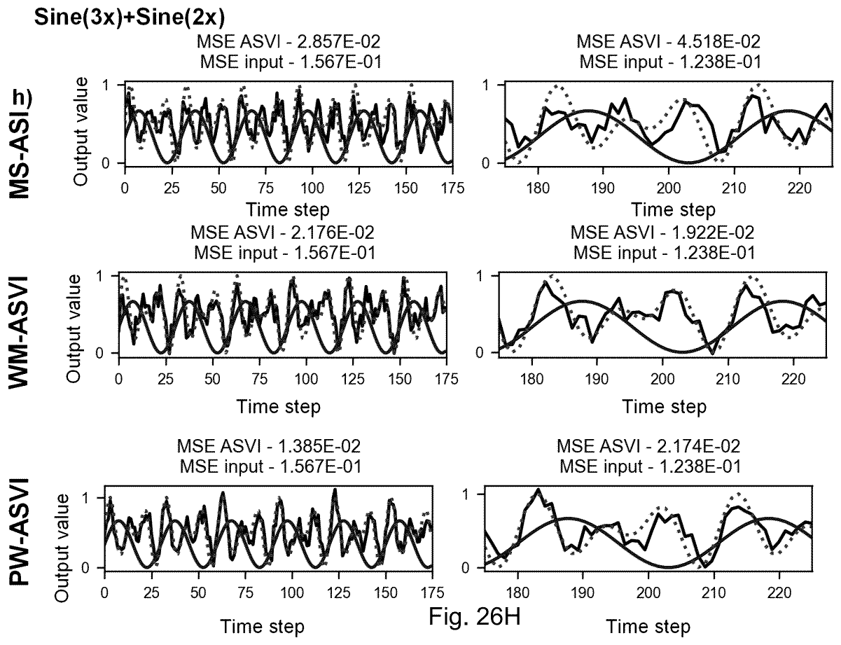

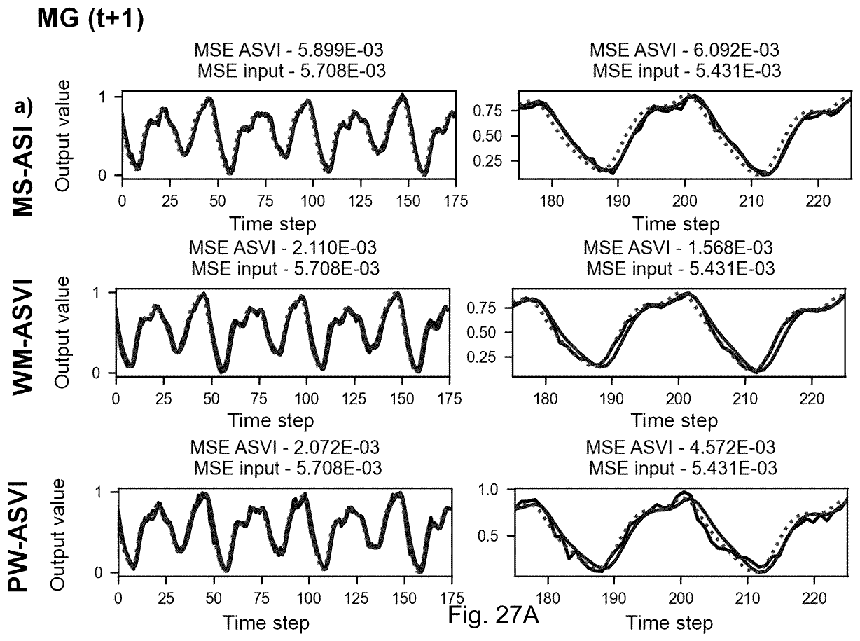

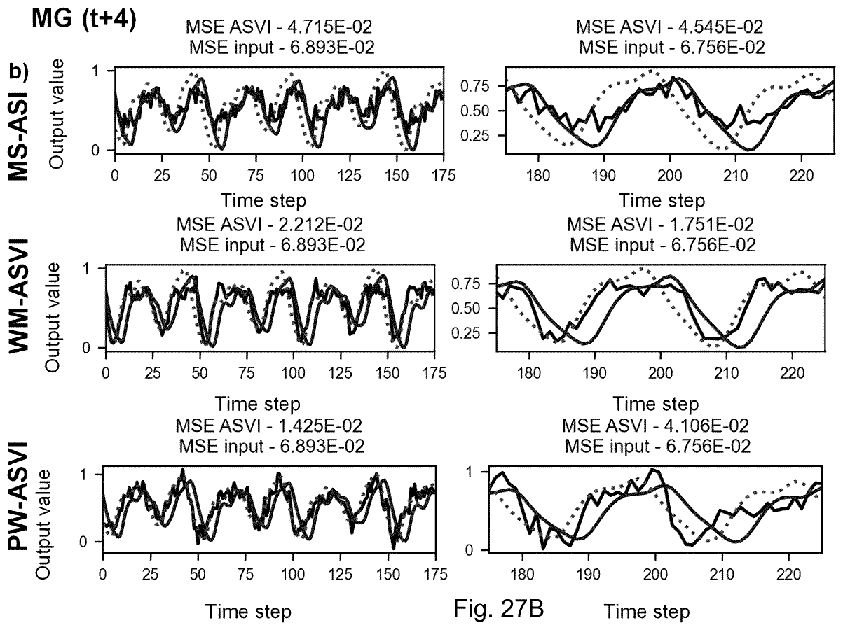

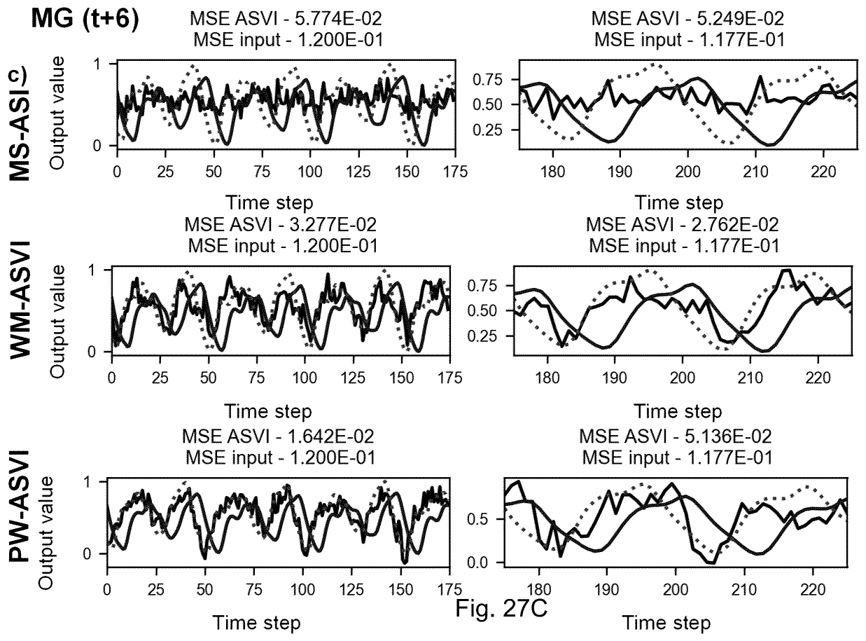

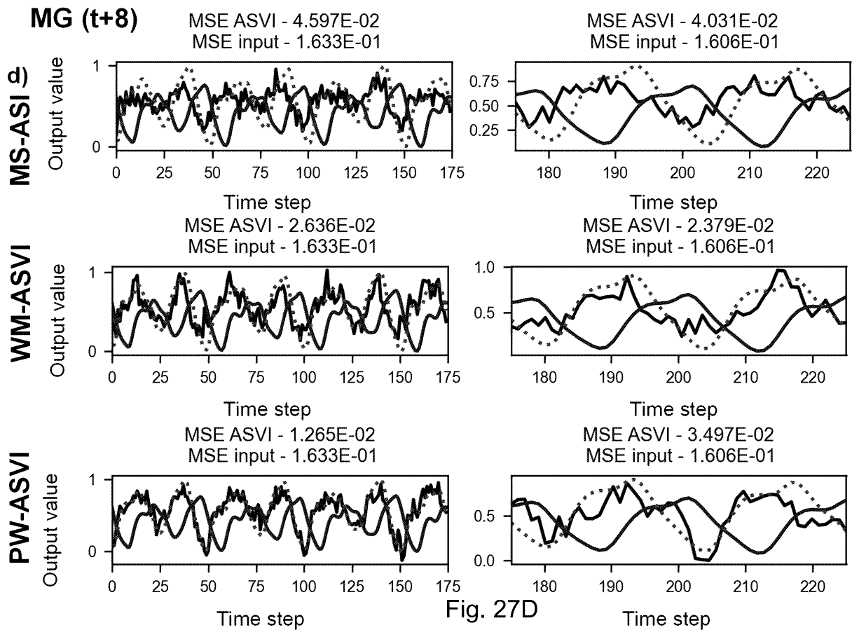

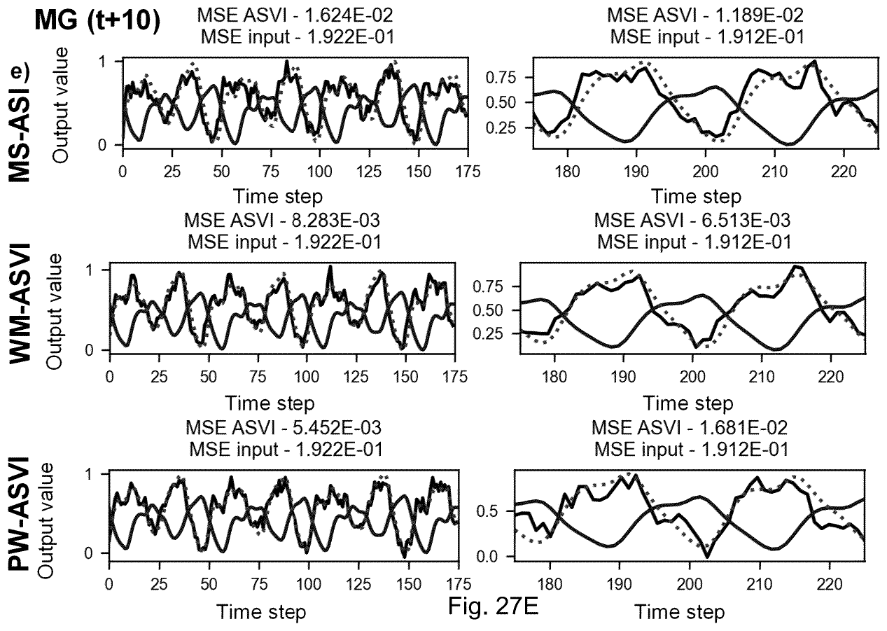

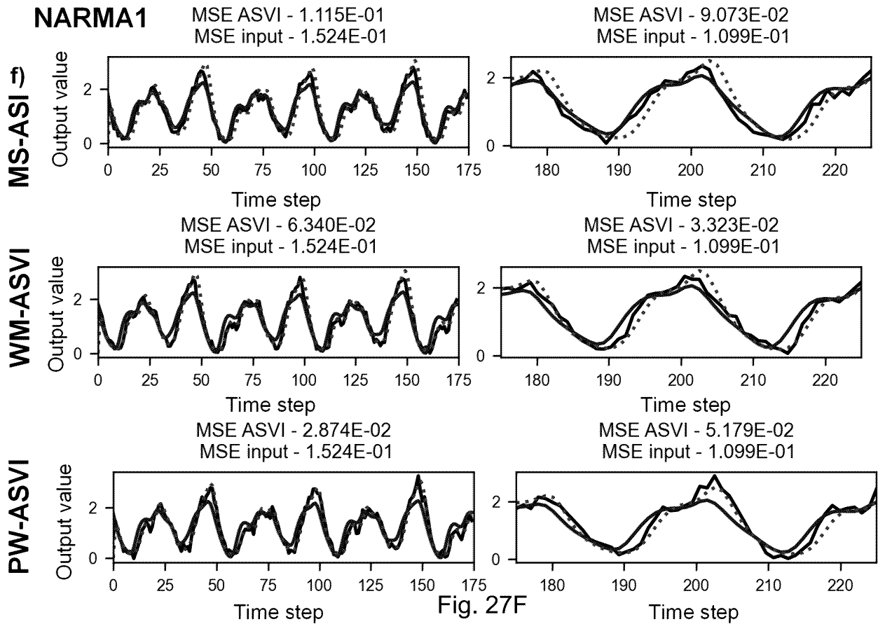

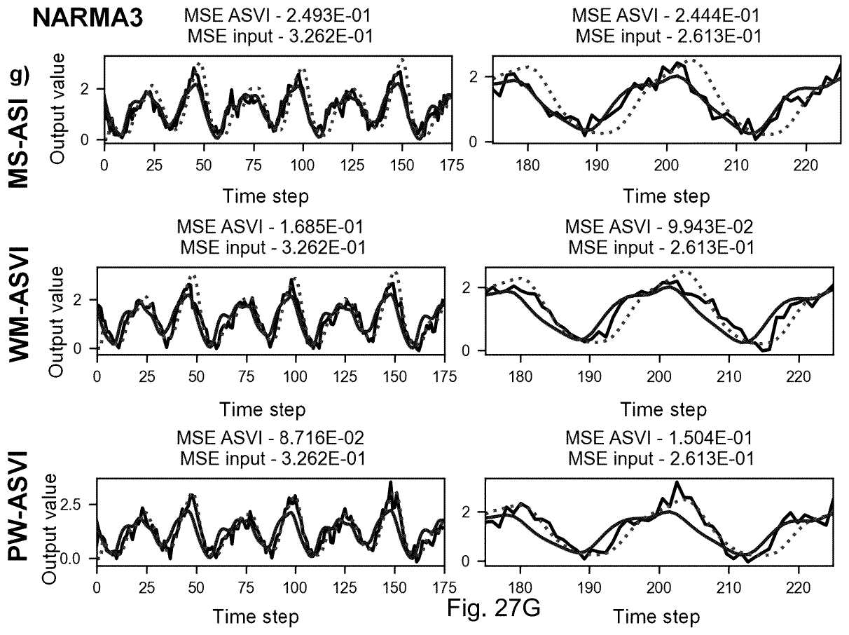

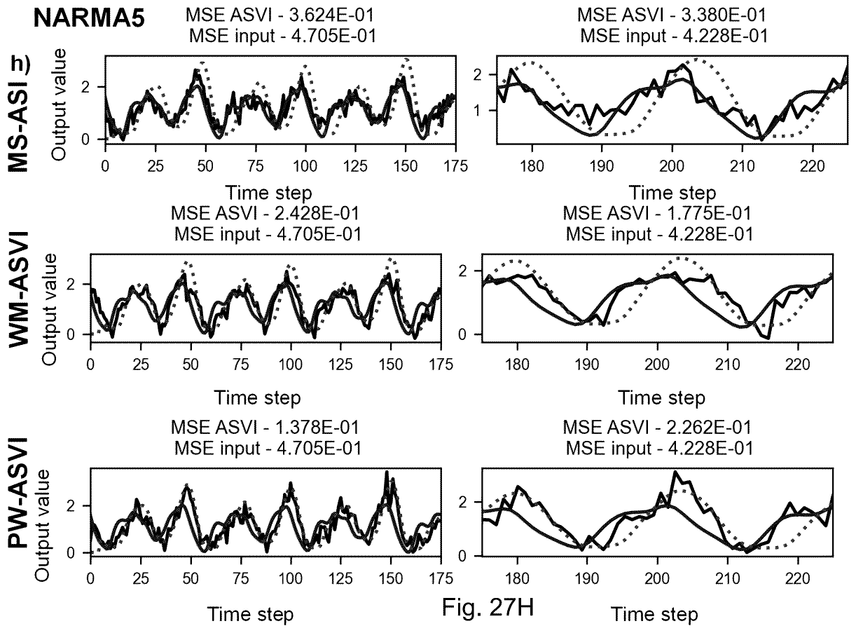

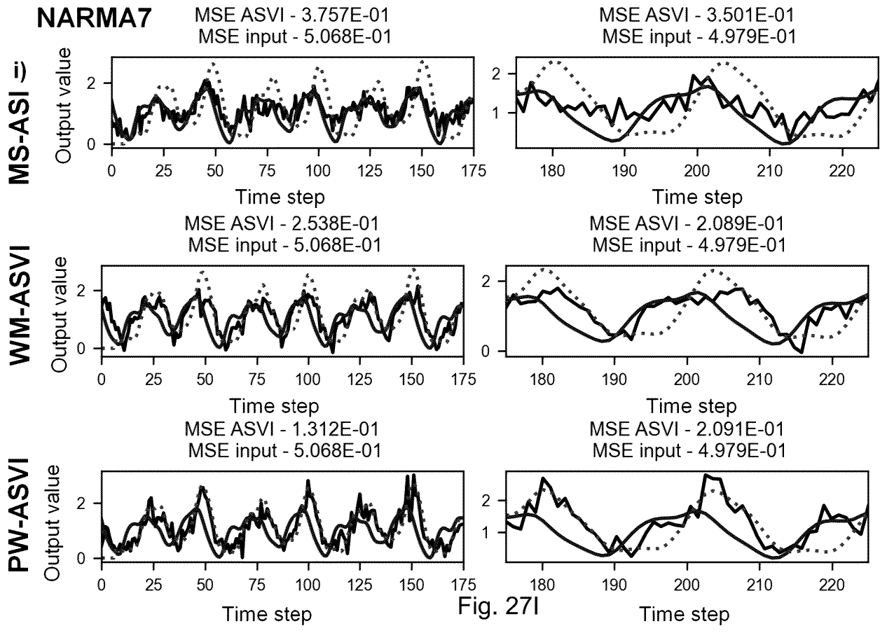

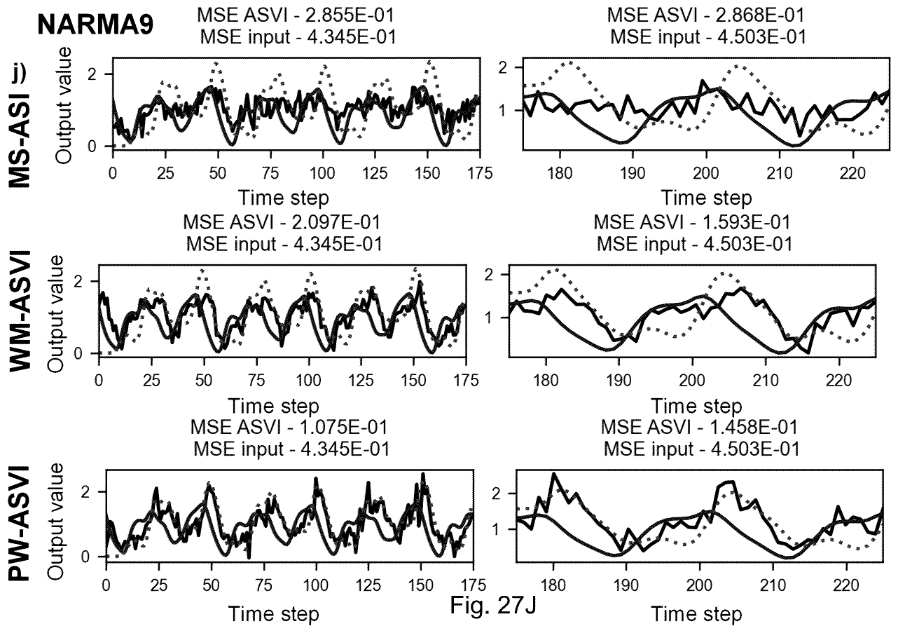

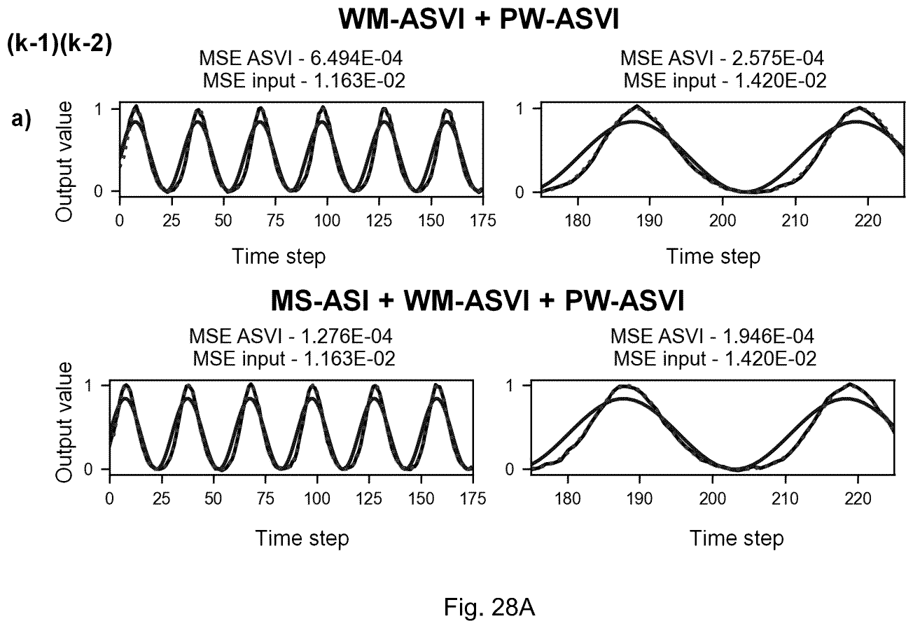

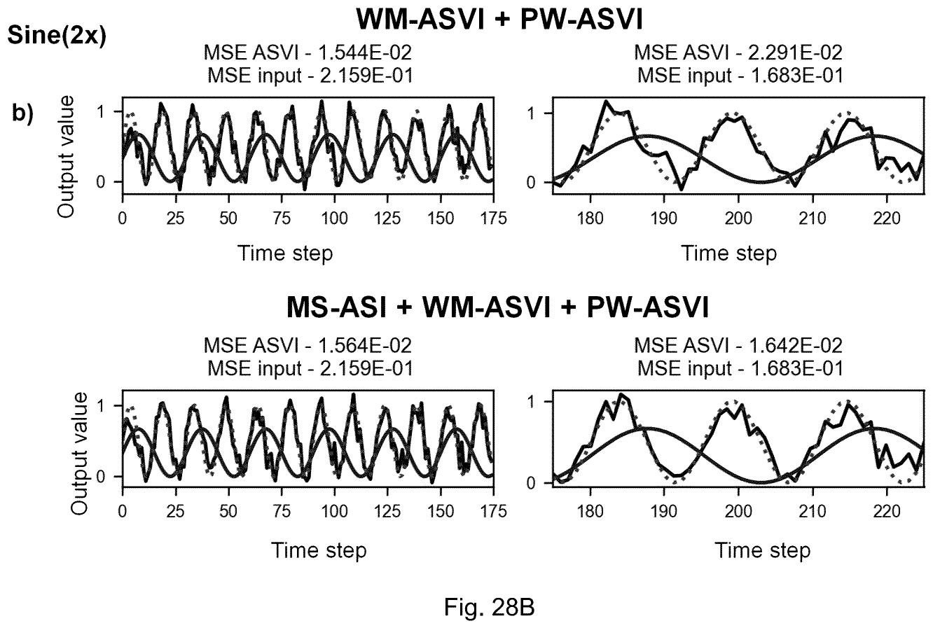

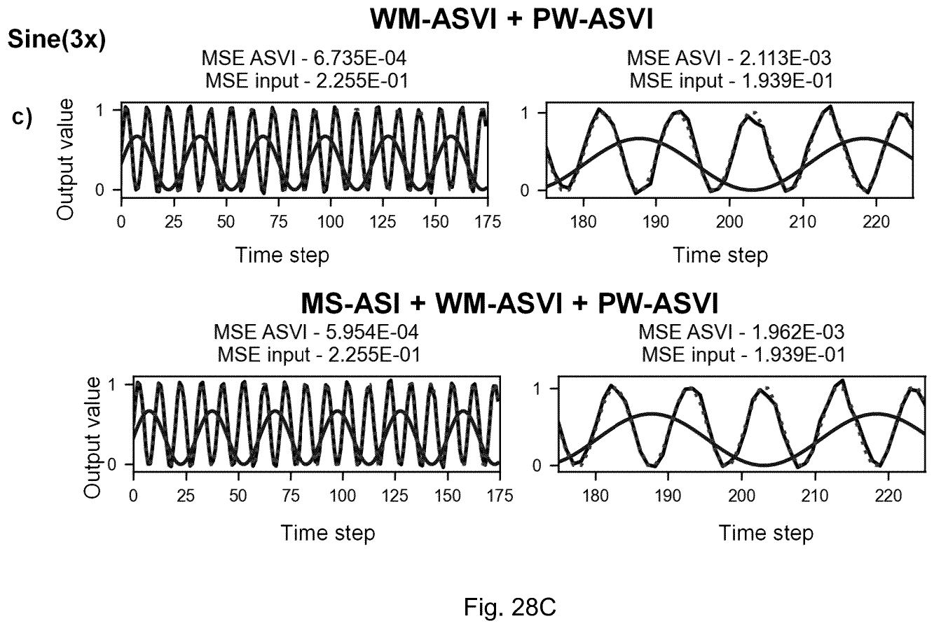

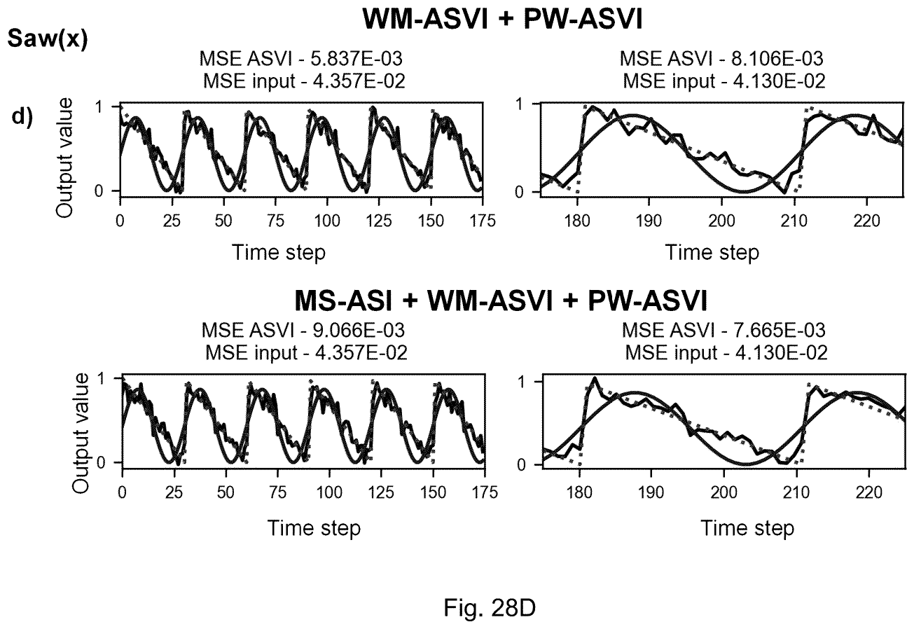

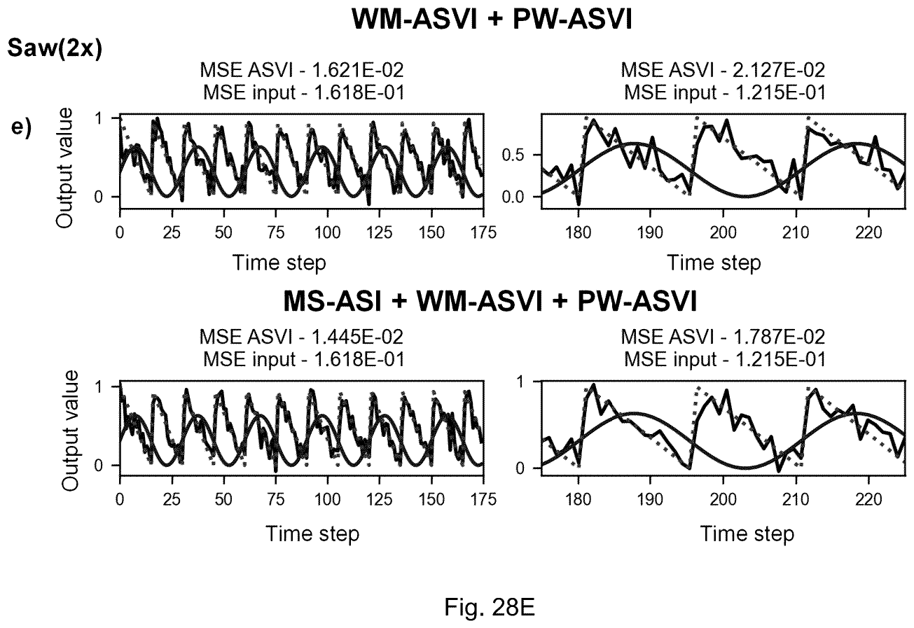

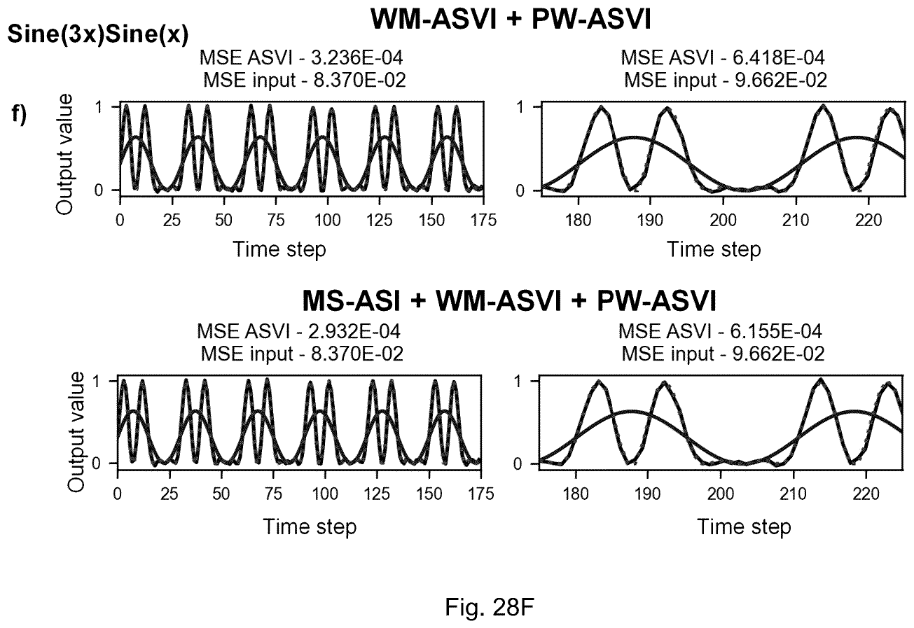

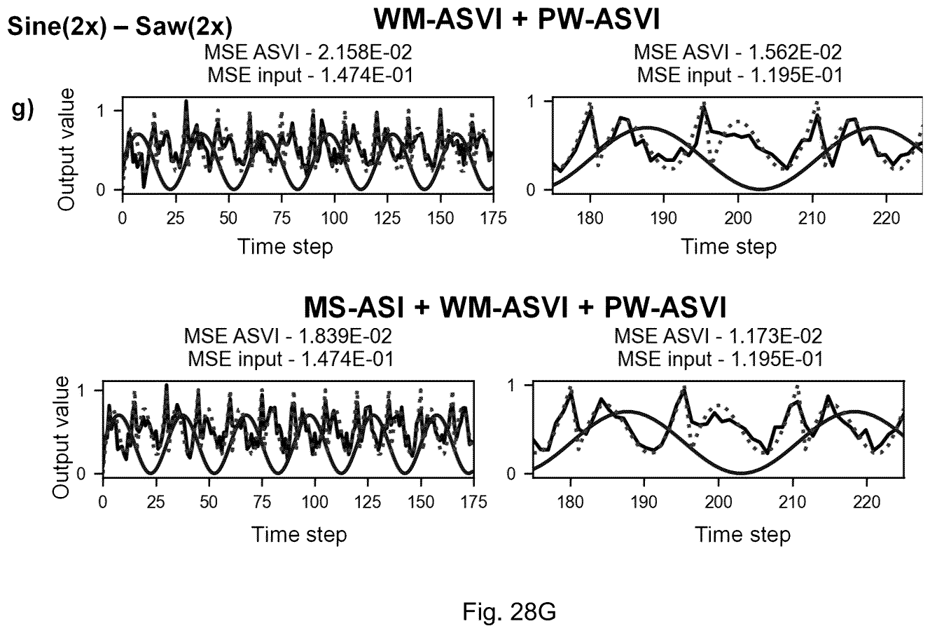

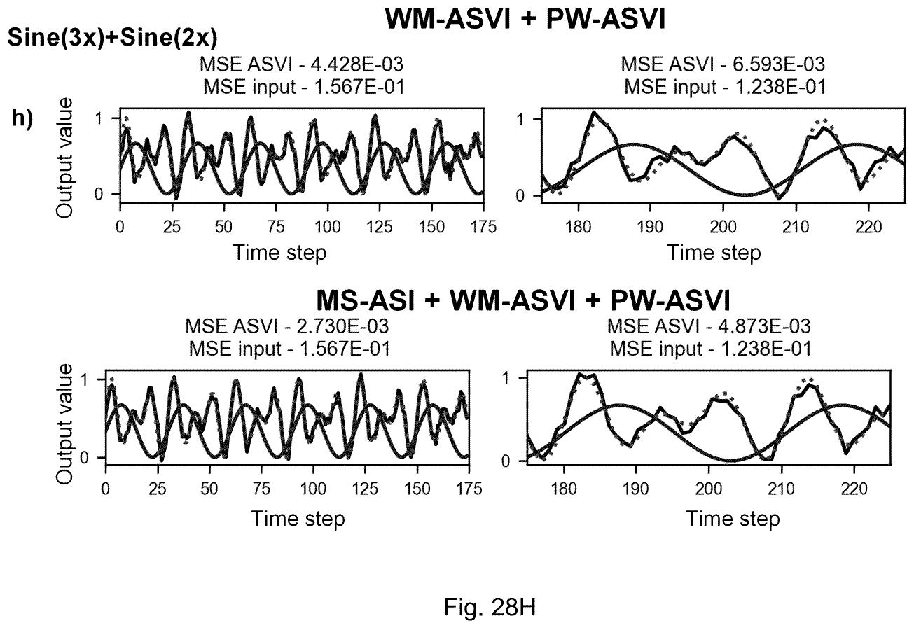

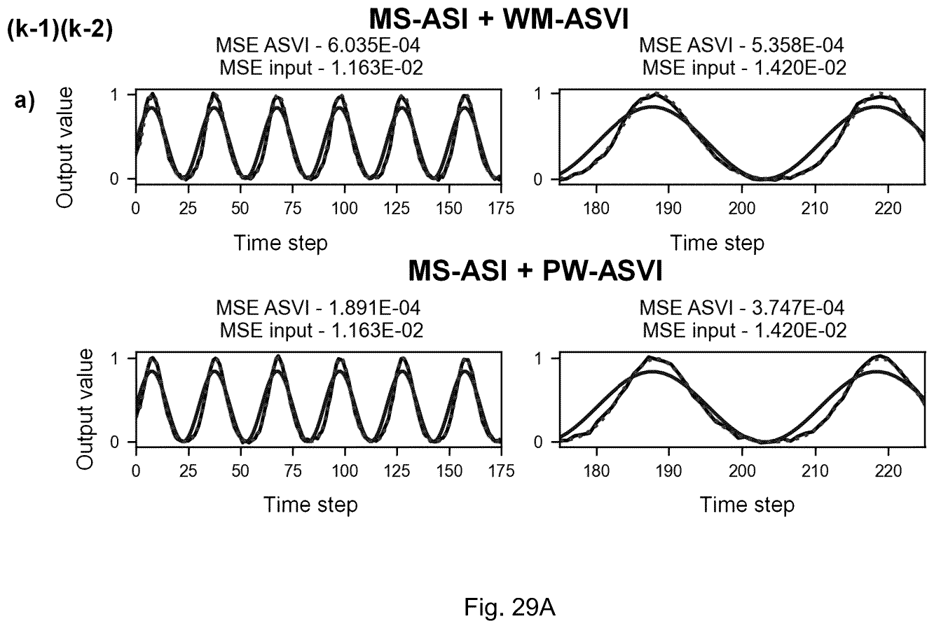

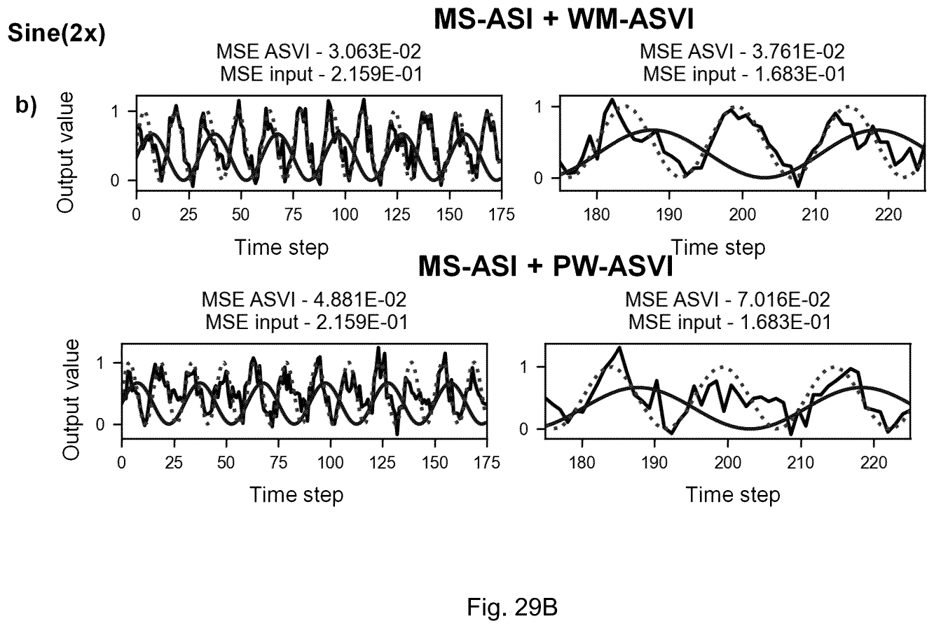

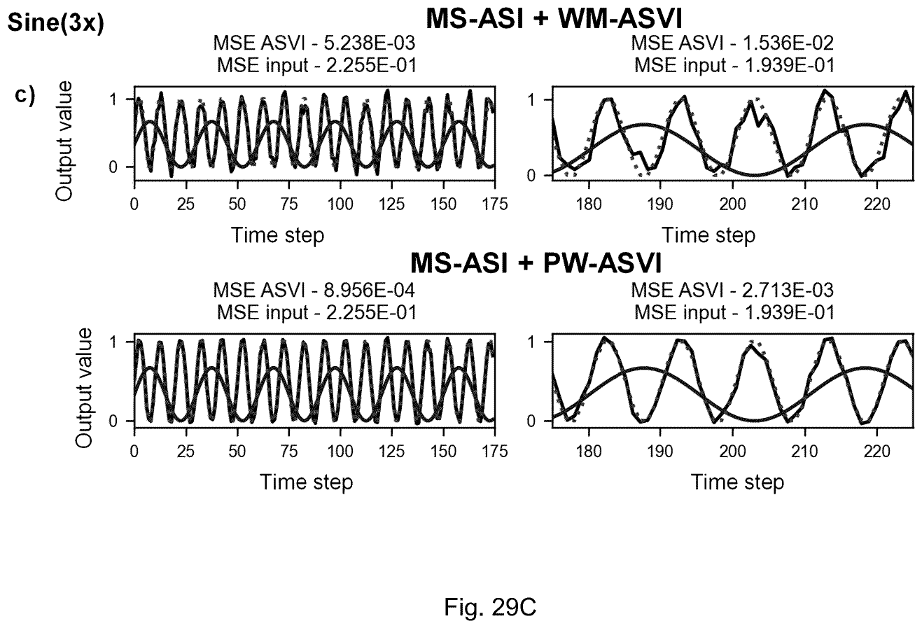

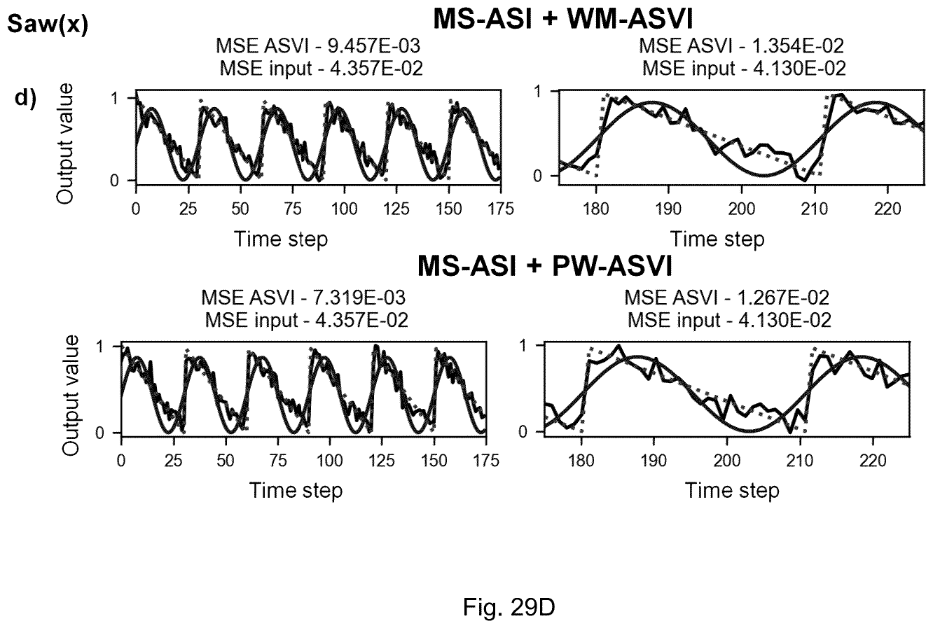

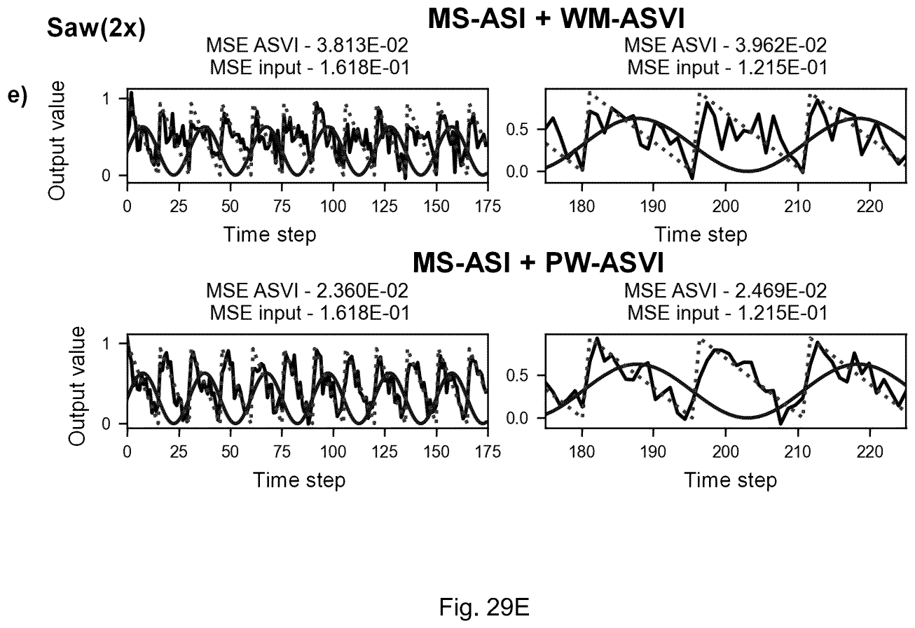

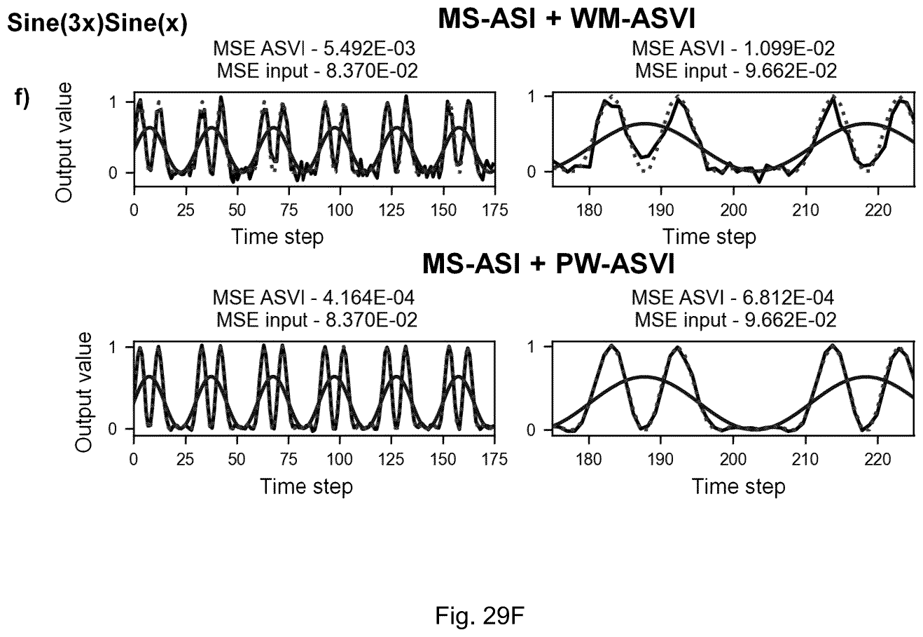

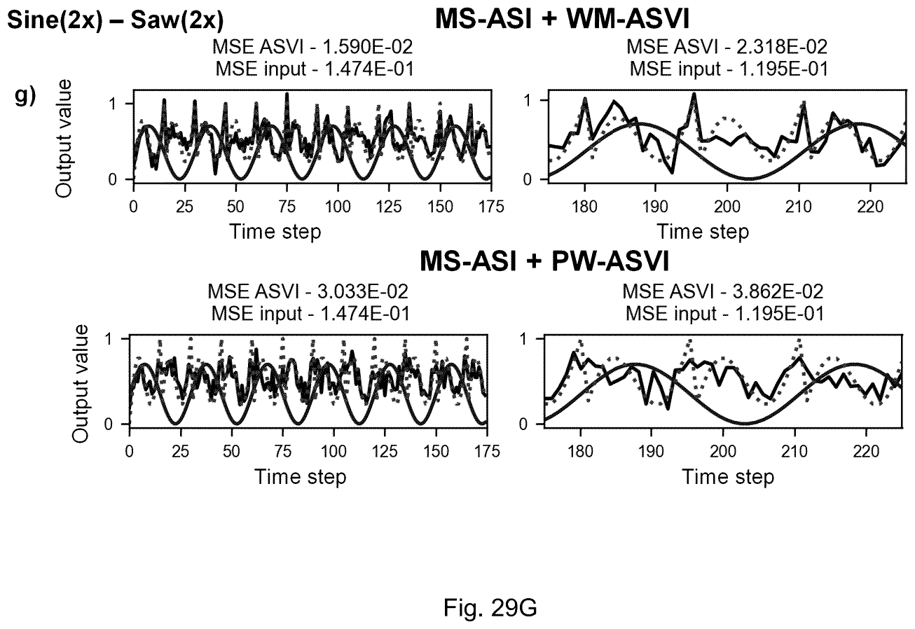

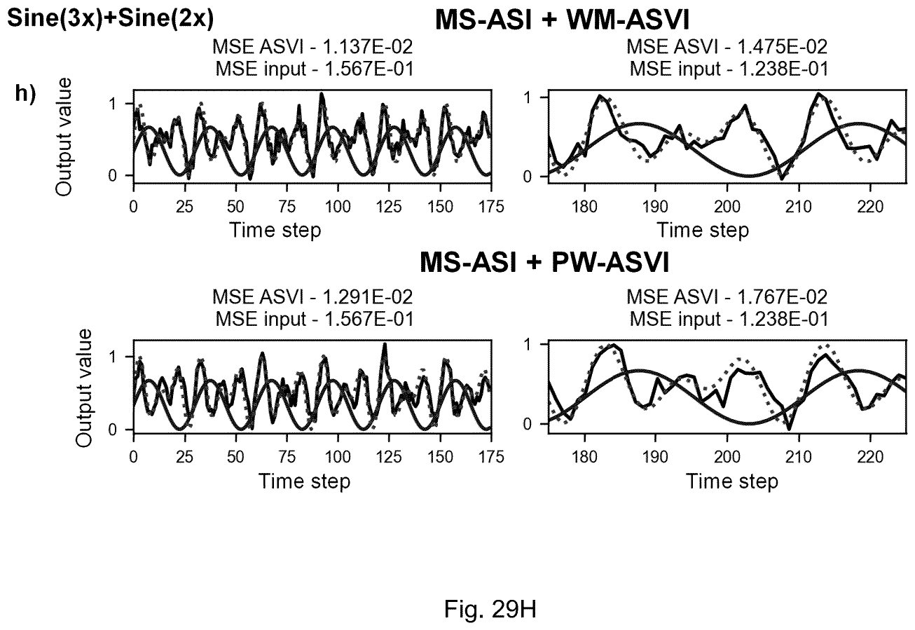

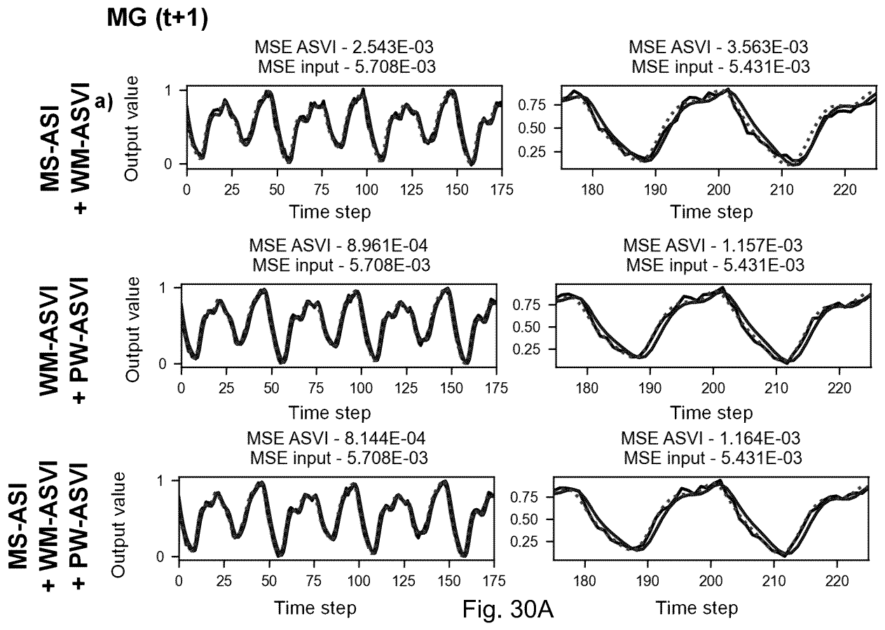

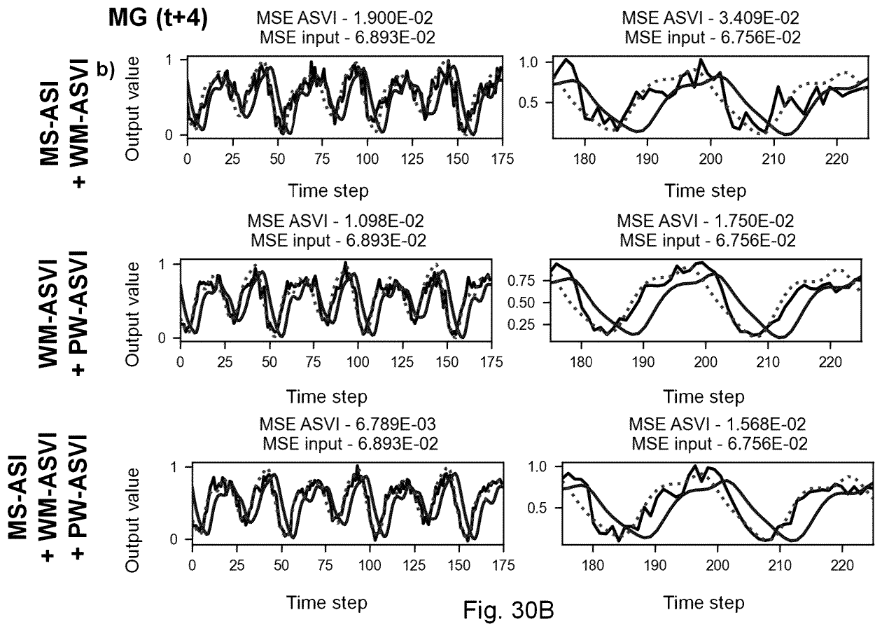

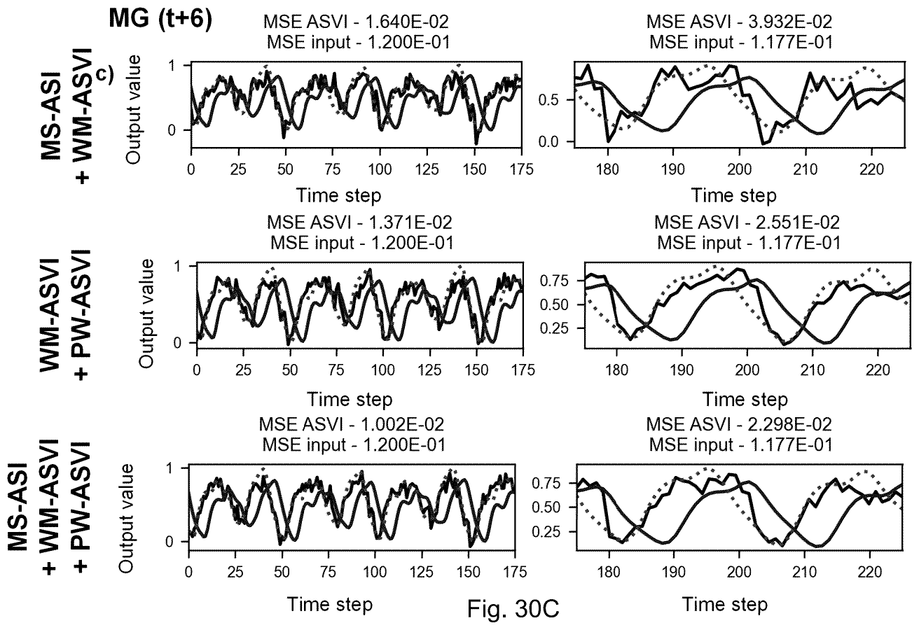

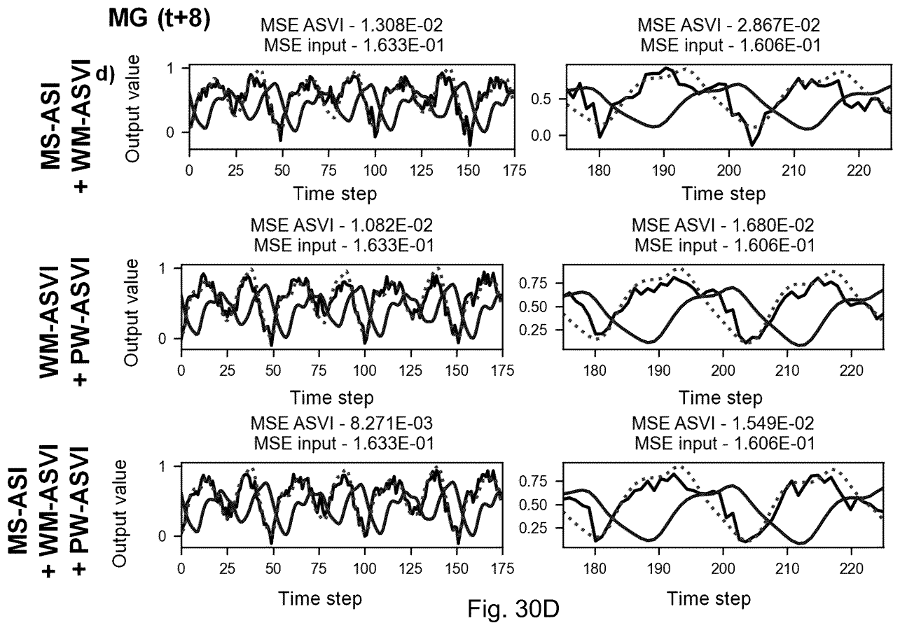

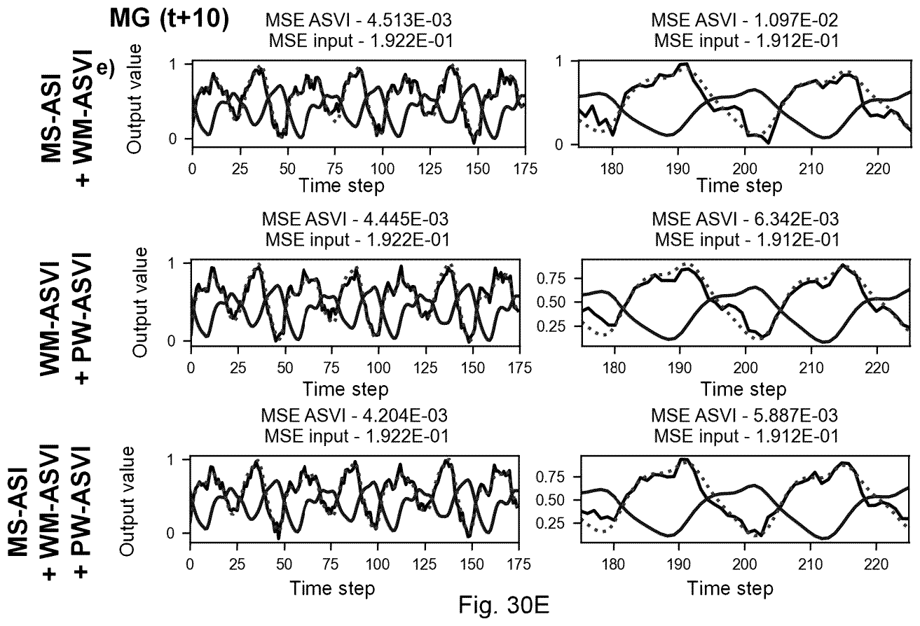

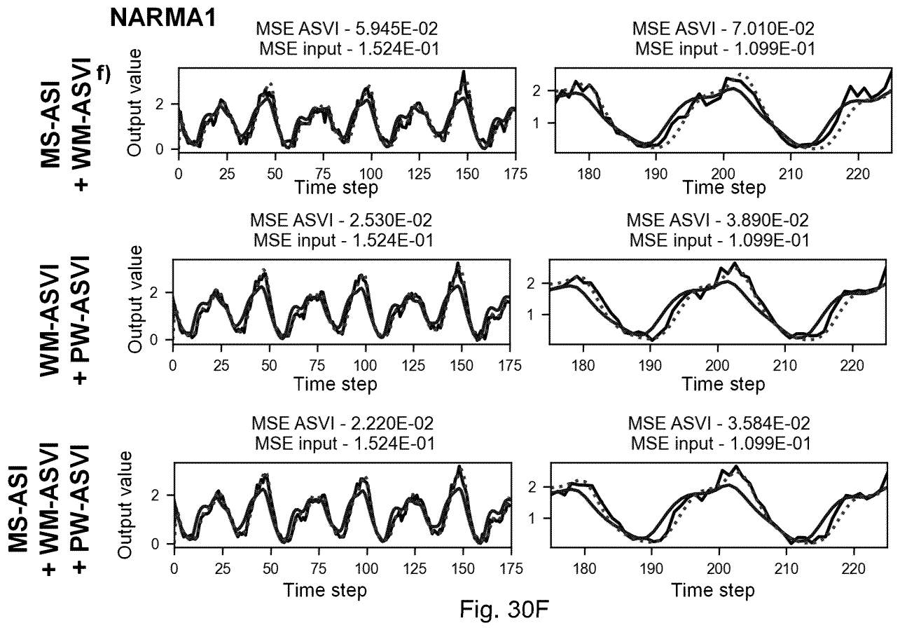

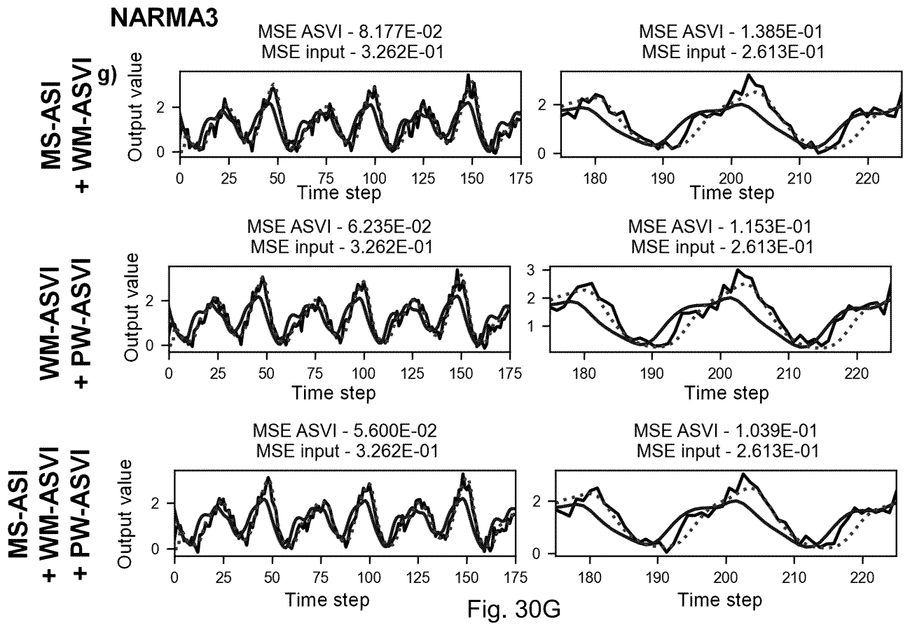

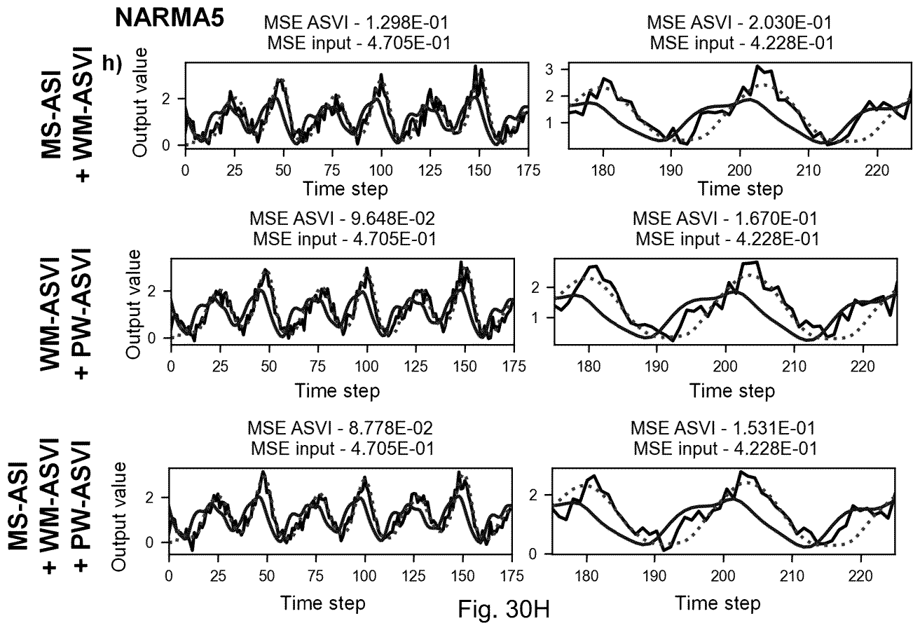

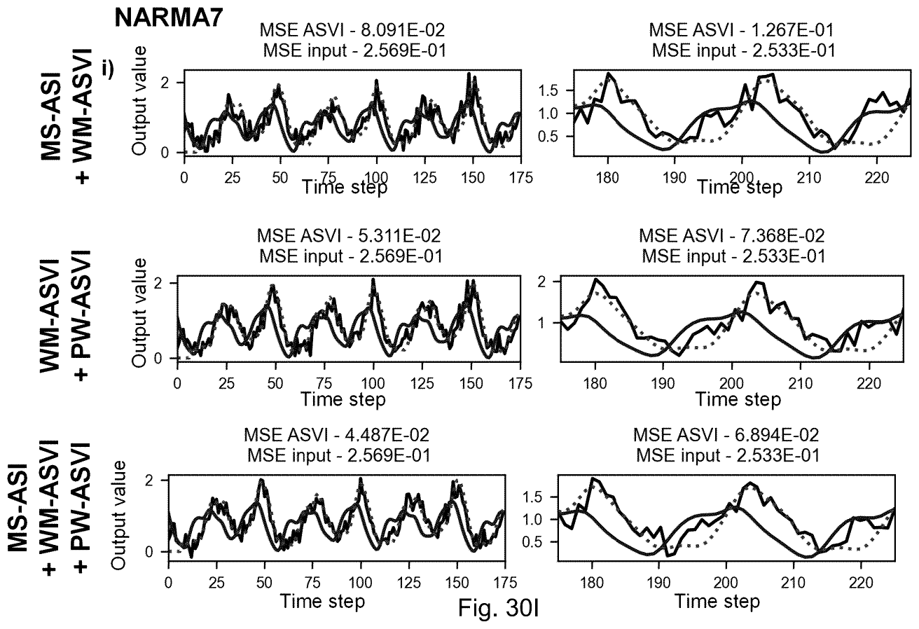

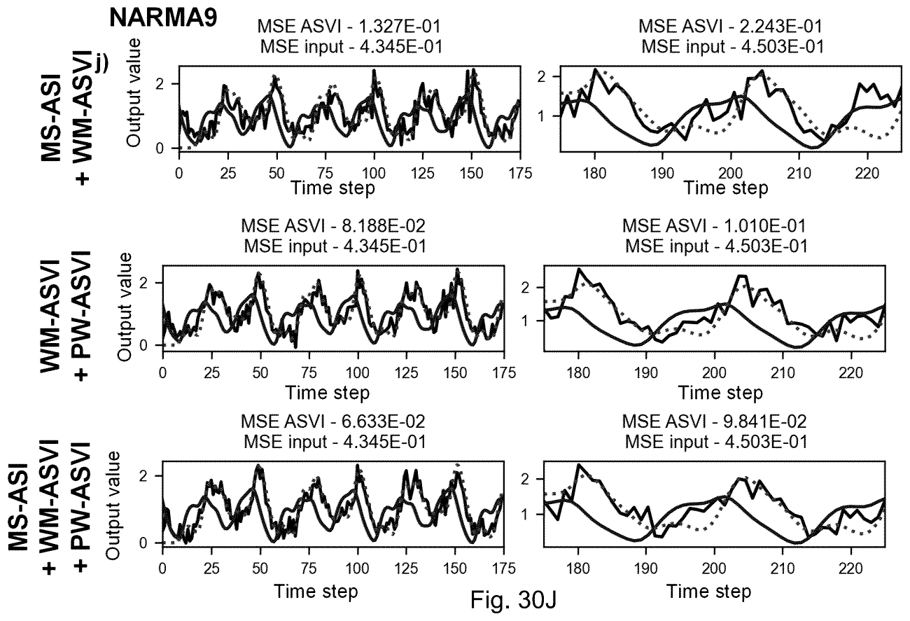

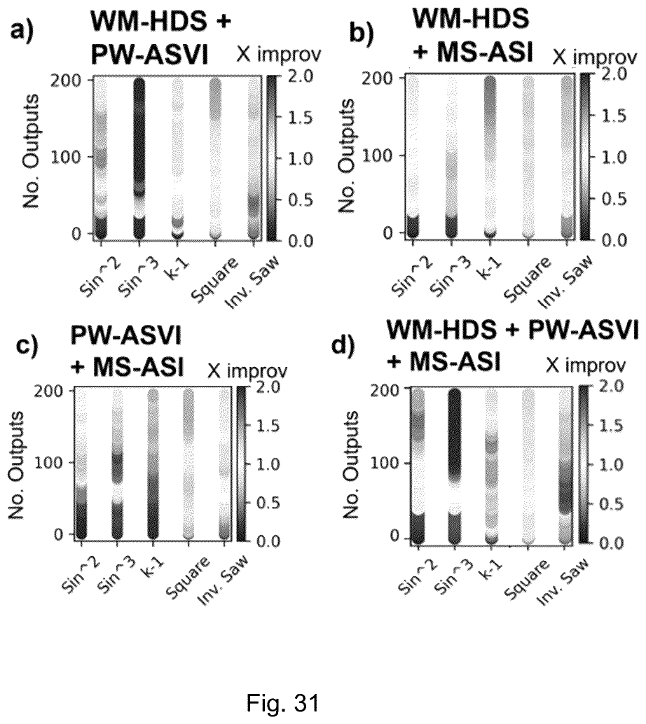

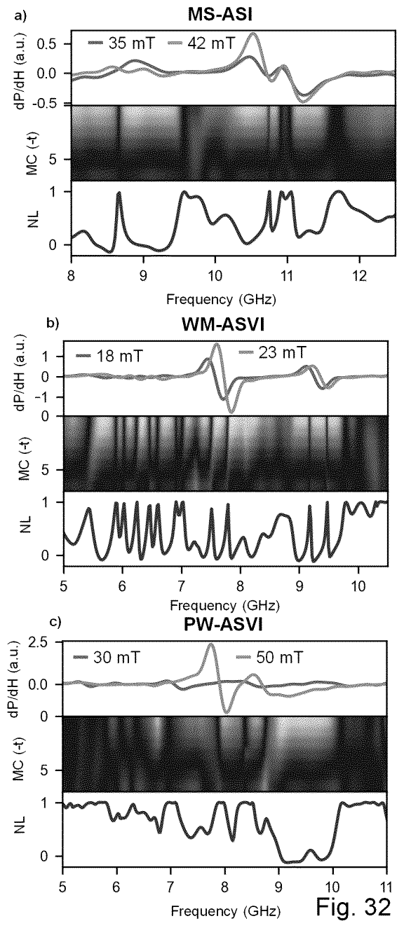

To improve the performance of a computational architecture, various system parameters can be optimised. When connecting reservoirs up in series, the transfer of information from one layer to the next plays a crucial role in the overall performance. In software-based reservoir computing schemes, inter-layer connections are often initialised randomly with multiple variations trialled to optimise performance. However, this process is inefficient and often not feasible in hardware reservoir systems due to time and engineering constraints. The significant optimisation time and energy required to evaluate all input-output combinations would significantly offset the efficiencies offered by reservoir computing. Instead, the inventors have appreciated that a better solution would be to evaluate how a change in inter-layer properties corresponds to a change in architecture performance. Here, we examine how the metrics of R1 outputs affects the metrics of R2. FIGS. 23A-23E panels a-c) show the FMR amplitude, MC, for previous steps (n) (0-7), total MC

$$( {\sum }_{n = 0}^{7} M {C}_{i , n} )$$

and NLᵢ of each individual FMR output (i) for MS-ASI (a), WM-ASVI (b) and PW-ASVI (c). The FMR amplitude at the maximum (orange) and minimum (blue) field-input of a Mackey-Glass is shown. MC_{i,n} profiles vary between samples. For MS-ASI, MC_{i,n} is limited to n 3 for most bins. For WM-ASVI and PW-ASVI, some outputs remember 0-3 previous steps, whereas others remember further back (e.g. WM-ASVI, 7.2-7.5 GHZ). Having a range of MC responses produces higher total MC seen in FIGS. 20A-20H panel b). MCᵢ has a maximum of 2.6, 3.2 and 3.1 for MS-ASI, WM-ASVI and PW-ASVI respectively, matching the order of memory observes in FIGS. 20A-20H panel b). For MS-ASI and WM-ASVI, high MC is focused at the peaks and sub-harmonics of that resonance (e.g. 8 GHz and 5.75 GHz for WM-ASVI (b)). High NL is seen where FMR amplitude is low or crossed zero and at frequencies where the maximum or minimum point of an FMR peak shifts through during in-field measurement e.g. WM-ASVI ˜9.1 GHz. For PW-ASVI (c), the MC is highest at ˜9 GHZ, away from the main FMR mode. High NL is seen across the majority of the FMR resonance, as well as at regions of low FMR amplitude. This is due to strong vortex induced non-linearities. The FMR spectra is dominated by a range of vortex and mixed states resulting in a highly non-linear response to applied field at the main resonance peak.

This analysis of individual output metrics can be used to evaluate the relationship between R1 output and R2 metrics. FIGS. 23A-23 panels d-i) show this relationship when R2 is MS-ASI (d,e), WM-ASVI (f,g) and PW-ASVI (h,i). Here, MCᵢₙ and NLᵢₙ refer to the MC and NL of the chosen R1 output (i.e. MC and NL from panels a-c)). MCₒᵤₜ and NLₒᵤₜ are the MC and NL of R2 with 60 outputs, evaluated against the original Mackey-Glass input (i.e. the input to R1). In each plot, points are colour coded depending on which reservoir acts as R1 (blue for MS-ASI, red for WM-ASVI and black for PW-HDS). For all three samples, both MCₒᵤₜ and NLₒᵤₜ follow an approximately linear relationship. The maximum memory achieved is limited by the properties of R2 (low for MS-ASI, high for WM-ASVI).

To demonstrate the flexibility afforded by this technique, FIGS. 23A-23E panels j-l) show the MC and NL of all reservoir configurations measured throughout this work, colour-coded by MSE for tasks t+8 (j), t+13 (k), t+15 (l). Red circles indicate the best performance. Each task requires a different combination of MC and NL.

By combining the relationship between inter-layer connections and architecture metrics and the fact that certain tasks require a specific combination of MC and NL, the inventors have appreciated that it is possible to optimise/‘train’ the reservoir architecture for optimising performance. With just one parameter (i.e. the inter-layer MC) a range of architecture metrics and performance can be realised. The introduction of a trainable inter-layer parameter opens up vast possibilities in implementing hardware neural networks with reservoir nodes.

### Reservoir Network

Here, the inventors combined the various deep reservoir architectures that were trialled in FIGS. 22A-22F to make a deep/parallel reservoir hybrid. From FIGS. 22A-22F, it is clear that the behaviour looks like that of a neural network. The outputs are combined from each network reservoir and optimised.

### Conclusion

In summary, the inventors have engineered different artificial spin systems with varying microstate and FMR properties and evaluated their metrics and performance across a number of benchmark tasks. The presence of vortices was found to be able to enhance the system memory, non-linearity and complexity, leading to improved non-linear transformations and chaotic time-series prediction compared to conventional ASI structures. To date, theoretical studies have focused exclusively on ASI structures constrained to macrospin states. The results presented herein highlight the need computational performance gained from vortex states.

The inventors have overcome the task-specific nature of single reservoirs by combining multiple reservoirs in architectures to boost performance. Parallel architectures can utilise the various properties of individual reservoirs to enhance non-linear transformation performance. Deep RC architectures, with reservoirs connected in series, can allow for enhanced system MC and more versatile chaotic time-series prediction. Crucially, the method of analysing/selecting the output of a given reservoir layer presented here can allow for efficient tuning of the system metrics, providing an efficient method of designing architectures without the need for time-consuming performance evaluation and iteration. For a computational system to be technologically viable, its applications should be diverse. The results presented herein demonstrate the scope and versatility of artificial spin system reservoirs. By expanding high-performance from a handful of tasks to a diverse set of complex tasks, the system can be more ‘complete’.

The reprogramming approach presented herein can be applied to any reservoir system for any tasks, provided that the required memory and non-linearity can be evaluated. As hardware reservoirs progress from single systems with 1D output, to chains of reservoirs with multi-dimensional inputs, the number of system parameters increases exponentially, the relatively simple approach to efficient tuning of reservoir metrics presented herein will serve to guide system design without the need for vast iterative experiments.

### Nanofabrication:

Artificial spin reservoirs were fabricated via electron-beam lithography liftoff method on a Raith eLine system with PMMA resist. Ni₈₁Fe₁₉ (permalloy) was thermally evaporated and capped with Al₂O₃. For WM-HDS, a ‘staircase’ subset of bars was increased in width to reduce its coercive field relative to the thin subset, allowing independent subset reversal via global field. The flip-chip FMR measurements require mm-scale nanostructure arrays. Each sample has dimensions of roughly ˜3×2 mm². As such, the distribution of nanofabrication imperfections termed ‘quenched disorder’ is of greater magnitude here than typically observed in studies on smaller artificial spin systems, typically employing 10-100 micron-scale arrays. The chief consequence of this is that the Gaussian spread of coercive fields is over a few mT for each bar subset (15.5-17 mT for wide bars, 26-29 mT for thin). Smaller ASVI arrays have narrower coercive field distributions, with the only consequence being that optimal applied field ranges for reservoir computation input will be scaled across a corresponding narrower field range, not an issue for typical 0.1 mT or better field resolution of modern magnet systems. MS-ASI contains two distinct regions.

### Fmr Measurement:

Ferromagnetic resonance spectra were measured using a NanOsc Instruments cryoFMR in a Quantum Design Physical Properties Measurement System. Broadband FMR measurements were carried out on large area samples (˜2×2 mm²) mounted flip-chip style on a coplanar waveguide. The waveguide was connected to a microwave generator, coupling RF magnetic fields to the sample. The output from waveguide was rectified using an RF-diode detector. Measurements were done in fixed in-plane field while the RF frequency was swept in 10 MHz steps. The DC field was then modulated at 490 Hz with a 0.48 mT RMS field and the diode voltage response measured via lock-in. The experimental spectra show the derivative output of the microwave signal as a function of field and frequency. The normalised differential spectra are displayed as false-colour images with symmetric log colour scale.

### Reservoir Computation:

The reservoir training inputs are chosen to have approximately 30 data points per period for the sin, inverse-saw waves and Mackey-Glass input with outputs sampled at every input. The Mackey-Glass time-delay differential equation takes the form

$$( \frac{d x}{d t} = β \frac{{x}_{τ}}{1 + {x}_{τ}^{{}_{n}}} - λ x )$$

and is evaluated numerically with β=0.2, n=10 and τ=17. The array is initially saturated in a −200 mT field in the \hat{x} direction.

Reservoir computing schemes consist of three layers: an input layer, a ‘hidden’ reservoir layer, and an outputs layer corresponding the globally-applied fields, the ASVI and the FMR response respectively.

In each case, the inputs were linearly mapped to a field range spanning 18-23.5 mT, with the mapped field value corresponding to the maximum field of a minor loop applied to the system. After each minor loop, the FMR response is measured at the applied field Hₐₚₚ and −1.2 mT between 2.6-10.5 GHz in 20 MHz steps. Measurements were performed at two fields to compare the reservoir prediction quality. The FMR output is smoothed in frequency by applying a low-pass filter to reduce noise (examples of prediction quality without smoothing are shown in supplementary note 2.4). For each input data-point, we measure 397 distinct frequency bins and take each bin as an output giving 397 reservoir outputs. This process is repeated for the entire dataset with training and prediction performed offline.

Offline training and prediction is performed using a matrix multiplication method. We first separate the ASVI response into two datasets. A ‘train’ dataset for learning the optimum set of weights for a given task and a ‘test’ dataset to test the performance of the learned weights on previously unseen data. If we consider the training set of reservoir outputs \vec{x}ₜᵣₐᵢₙ(u) and the target waveform \tilde{y}

$${\vec{x}}_{train} ( u ) = ( \begin{matrix}{O}_{0} ( 0 ) & {O}_{0} ( 1 ) & … & {O}_{0} ( m ) \\ {O}_{1} ( 0 ) & {O}_{1} ( 1 ) & … & {O}_{1} ( m ) \\ ⋮ & ⋮ & ⋱ & ⋮ \\ {O}_{n} ( 0 ) & {O}_{n} ( 1 ) & … & {O}_{n} ( m )\end{matrix} ] \tilde{y} = ( \begin{matrix}{y}_{0} \\ {y}_{1} \\ ⋮ \\ {y}_{n}\end{matrix} )$$

where m is the number of reservoir outputs, n is the number of input data points in the ‘train’ dataset and Oₙ(m) is the m^{th} reservoir output for input step n (i.e. the amplitude of the m^{th} frequency bin). The goal of training is to obtain a 1×M array of weights Wₒᵤₜ which transform the reservoir outputs (\vec{x}(u)) into the desired target (\tilde{y}). For this, ridge regression which solves the linear optimisation problem Wₒᵤₜ=argmin_{W}(∥\tilde{y}−W\vec{x}ₜᵣₐᵢₙ(u)∥²+λ∥W∥²) was used with the following solution Wₒᵤₜ=(\vec{x}ₜᵣₐᵢₙ(u)^{T}\vec{x}ₜᵣₐᵢₙ(u)+λI)⁻¹\vec{x}ₜᵣₐᵢₙ(u)^{T}\tilde{y}, where I is the identity matrix and λ is the ridge regularisation term (fixed at 0.0001 for all tasks). This can be performed with freely-available Python packages such as scikit-learn.

Once Wₒᵤₜ is obtained, we can then multiply the ‘test’ dataset \vec{x}ₜₑₛₜ(u) with Wₒᵤₜ to obtain the reservoir prediction \tilde{y}_{ASVI} (i.e. \vec{x}ₜₑₛₜ(u)Wₒᵤₜ=\tilde{y}_{ASVI}) as follows:

$${\vec{x}}_{test} ( u ) {W}_{out} = ( \begin{matrix}{O}_{n + 1} ( 0 ) & {O}_{n + 1} ( 1 ) & … & {O}_{n + 1} ( m ) \\ {O}_{n + 2} ( 0 ) & {O}_{n + 2} ( 1 ) & … & {O}_{n + 2} ( m ) \\ ⋮ & ⋮ & ⋱ & ⋮ \\ {O}_{n + l} ( 0 ) & {O}_{n + l} ( 1 ) & … & {O}_{n + l} ( m )\end{matrix} ) ( \begin{matrix}{W}_{0} \\ {W}_{1} \\ ⋮ \\ {W}_{m}\end{matrix} ) = ( \begin{matrix}{y}_{ASVI , n + 1} \\ {y}_{ASVI , n + 2} \\ ⋮ \\ {y}_{ASVI , n + l}\end{matrix} ) = {\tilde{y}}_{ASV \text{?}}$$

$$\text{?} \text{indicates text missing or illegible when filed}$$

where l is the number of input datapoints in the ‘test’ dataset. We assess the performance of the reservoir by calculating the mean-squared error (MSE) of target waveform and the reservoir response MSE=(\tilde{y}_{ASVI}−\tilde{y})²/l.

### Metric Calculation:

MC is a measure of how dependent the current state of the reservoir is to previous inputs. It is calculated by using the current output to predict past inputs via a linear estimator and evaluating the R² between the predicted and target values. For each previous input, MC can range from 0 (no-memory) to 1 (perfect memory). The final value is

$${\sum }_{n = 0}^{k} {MC}_{n}$$

where k is the number of past outputs that the MC is evaluated on (here, k=8). In NL is a measure of how well the past inputs can be used to predict the current outputs using a linear estimator. Again, this ranges from 0 (perfectly linear) to 1 (non-linear). MC and NL are evaluated using ‘train’ and ‘test’ lengths of 150 and 50 respectively. For MC, a set of weights are assigned to each FMR output to transform the current system output to previous inputs.

### Mfm Measurement:

Magnetic force micrographs were produced on a Dimension 3100 using commercially available normal-moment MFM tips.

### Supplementary Note 2.0

FIGS. 22A-22F and FIGS. 23A-23E relate to combining different reservoirs in series. The FMR output of one reservoir (R1) is converted to a field and fed into the next (R2). The inventors found that it is possible to realise improvements in performance when doing so. The inventors have devised the method of connecting the reservoirs. In software systems, connections are normally made randomly and multiple variation are trialled to get the best performance. Due to time and engineering constraints, this is not possible in experiment, so the inventors needed to devise a way to realise such connections in hardware.

The present specification presents a method of controlling the memory (MC) and non-linearity (NL) of the second reservoir by selecting which R1 output is used. An approximately linear relationship between the MC and NL of the R1 output and the MC and NL of R2 was found. By changing MC/NL of R1 output, the inventors found that R2 can be controlled—different computational tasks require different combinations of MC and NL, as such, the inventors realised control over task performance. This is good for two reasons: first, it allows quick reprogramming of the system depending on the task; and secondly, it introduces a trainable parameter for future neural network schemes-having a parameter with a direct relationship to performance is crucial for training neural networks. The inventors have found that it is possible to build networks of reservoirs and train their interconnections analogous to weights in a neural network, whereas before there would be no way to train the reservoir network as there is no relationship between connection frequency and performance.

### Memcomputing

This is an extension of “Reconfigurable training and reservoir computing in an artificial spin-vortex ice via spin-wave fingerprinting” and “Programmable, deep and parallel reservoir computing in artificial spin systems”.

### Reconfiguring Connections Between Active Elements

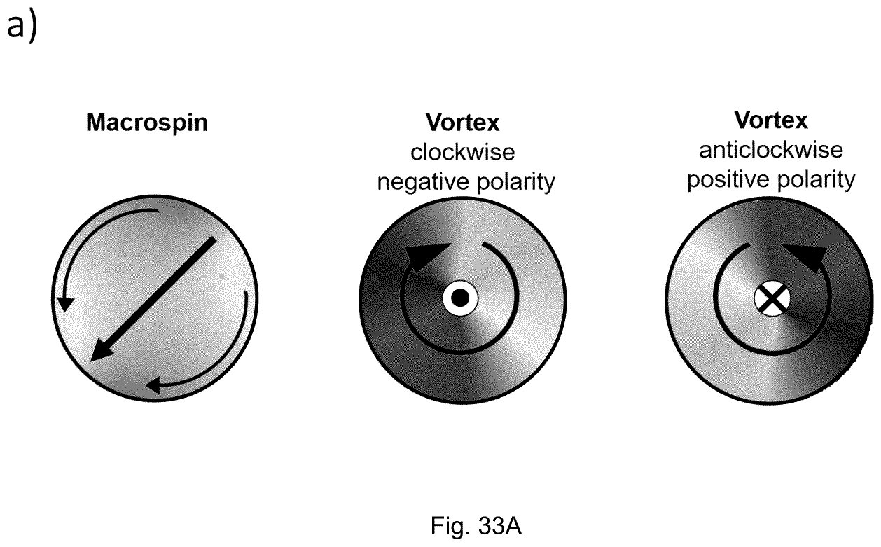

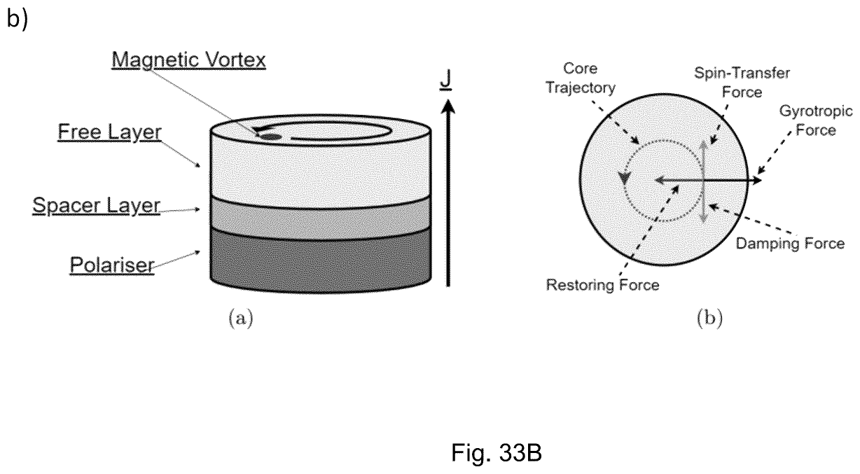

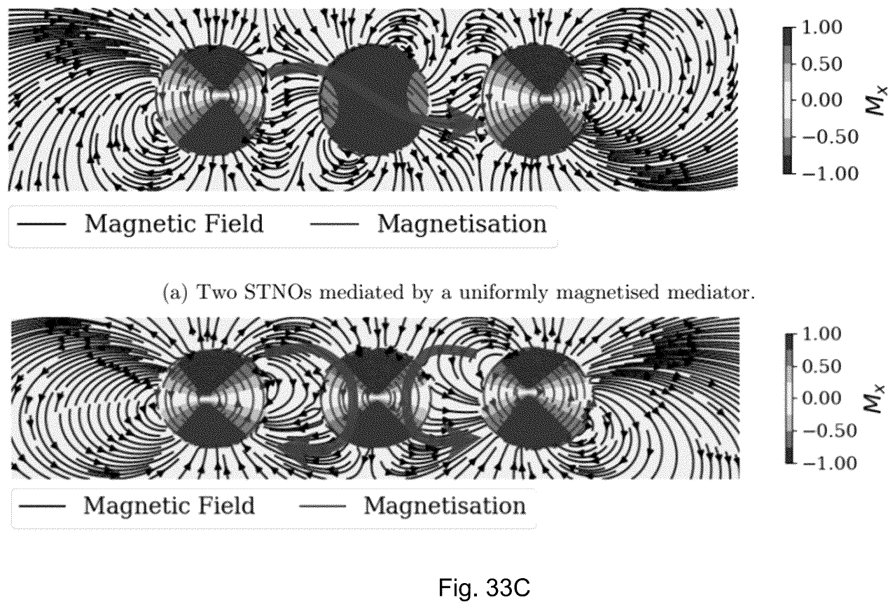

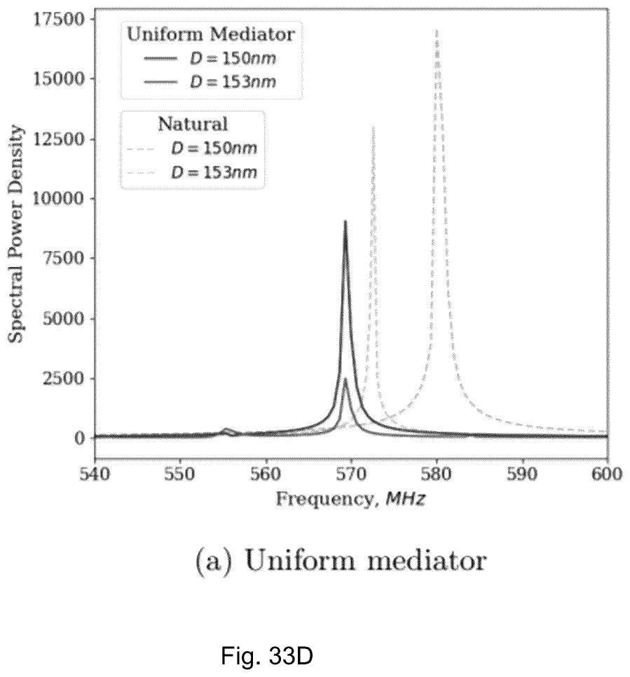

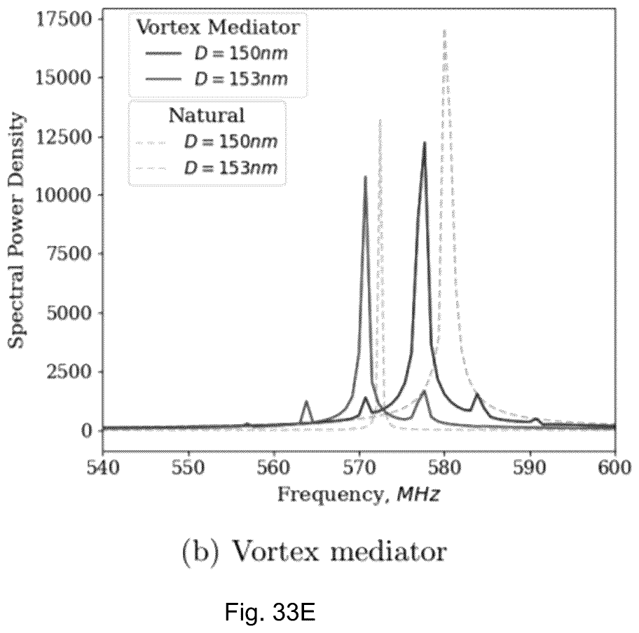

The present specification describes various ways of controlling magnetic states to in turn reconfigure the coupling between elements. The inventors have previously demonstrated that this is possible with all-optical magnetic switching (AOMS). The inventors have also performed proof of concept simulations that shown we can reconfigure the coupling between spin-torque nano-oscillators (STNOs) (see FIGS. 33A-33C). STNOs were used in the first experimental demonstration of nanomagnetic reservoir computing. Reference is made to Torrejon, J. et al. Neuromorphic computing with nanoscale spintronic oscillators. Nature 547, 428-431 (2017). In that work STNO's were well separated and connected electrically. To demonstrate the control afforded by state control, the inventors simulated two STNO's separated by a nanodisk. By changing the state of the connecting the nanodisk, the inventors found that the coupling behaviour of the two STNO's can be tuned, causing them to either synchronise or not synchronise. As such, the inventors have demonstrated that it is possible to reconfigure the coupling and/or functionality of active array elements via state control. From this, the inventors have appreciated that it is also possible to see how data can be input via state control. E.g., each nanomagnet may present a 1 (macrospin) or a 0 (vortex) and the synchronisation of the STNO's can give the computational output.

### Frequency Input Proof of Concept:

Some of the demonstrations described herein rely on slow global field input, and are not suitable for device integration. The inventors have devised many schemes that incorporate either frequency input or state-control input. Here, some proof-of-concept neural network schemes with frequency input are provided.

Proof of two different tasks, emulating logic gates and recognising spoken vowels, is provided:

### Logic:

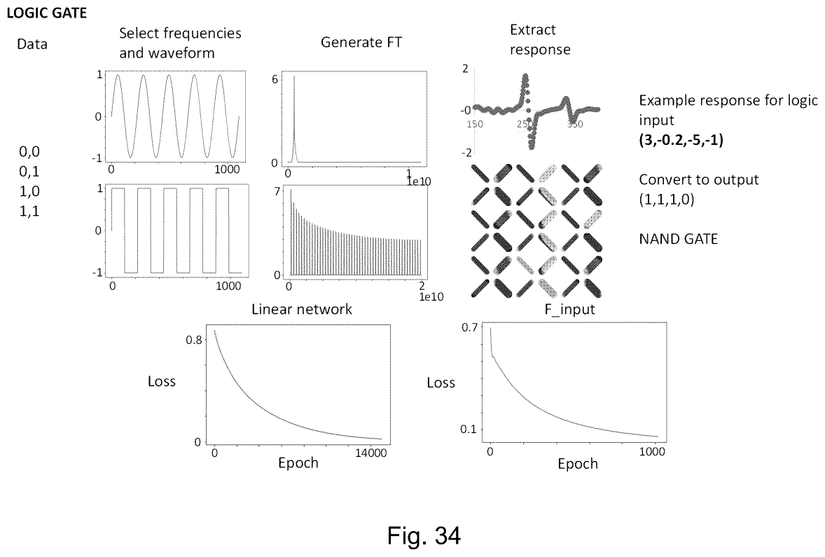

Logic gates (See FIG. 34) have the following inputs [0,0], [0,1], [1,0], [1,1] which give a logical output e.g. NAND output is 1,1,1,0.

### Method

For each input (e.g. [0,0]) assign two input frequencies (e.g. 3 and 4 GHz).
Also assign a waveform which can range from sine (0) to square (256).
The Fourier transform of this waveform is calculated.
For each input, multiply the fourier transform by an example FMR spectra from the nanomagnetic array. For example, if the frequency is 3 GHz and the waveform is a sine-wave, only take the FMR amplitude at 3 GHZ. However, for a 4 GHz square wave, there will be a sum of the FMR spectra at 4, 12, 20 GHz (odd multiples of frequency). This gives two values corresponding to the two initial inputs.
Then sum these two values and say if the sum is <0, the output is 0. If the sum is >0, the output is 1.
Train the frequency and the waveform of the input, allowing the system to find the optimum values.
This can be reproduced all logic gates. The number of training cycles is 10× less than a conventional perceptron network.

### Vowel Recognition:

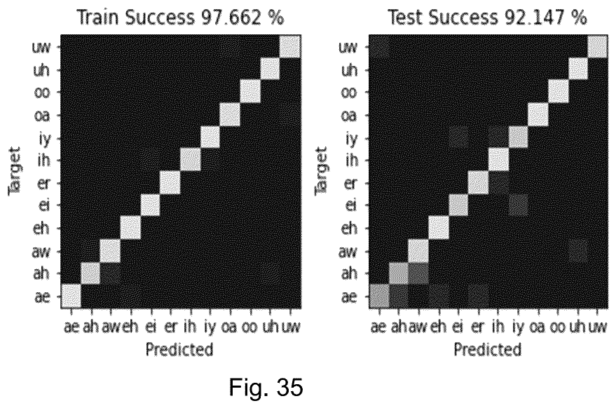

Vowel recognition works under a similar principle. Formant data available online was used and each input was assigned a frequency and waveform and the array response was probed. At the end, then train a weight matrix to give convert the FMR output into 12 different classes corresponding to the 12 input vowels, and take the maximum of the 12 outputs to give the predicted vowel. The inventors obtained a 97.9% training accuracy when predicting three digits and 92.14% when predicting 12 digits (see FIG. 35).

In these simulations the array is not being changed. Including this in the code requires some more work but will certainly improve prediction performance.

### Digit Recognition

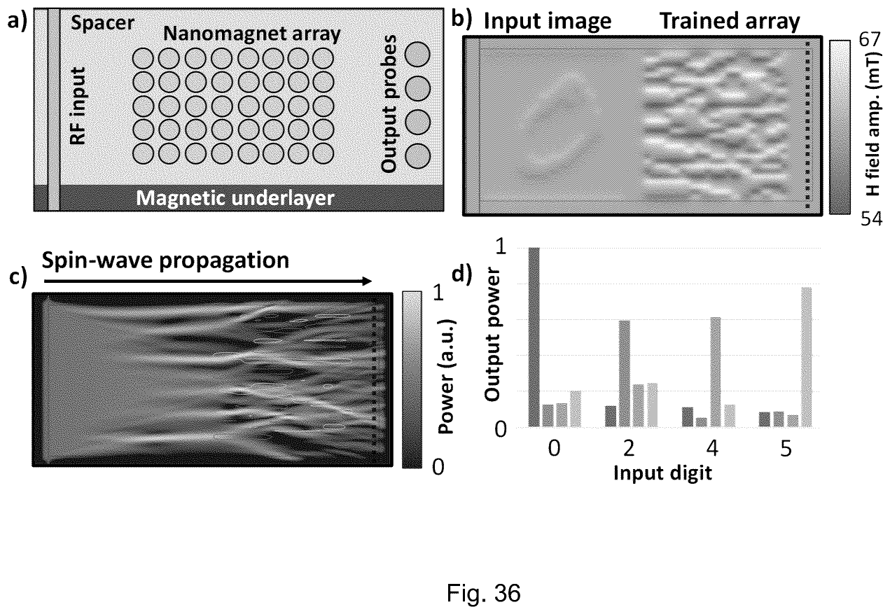

Here the inventors present proof of concept simulations on a different device geometry to perform hand-written digit recognition. Arrays are patterned on top of a continuous magnetic underlayer, separated by a spacer layer (FIG. 36 panel a). In these simulations, an image is input to the left region of a nanomagnetic array and the state of the right region is trained (FIG. 36 panel b)). The nanomagnetic array ‘imprints’ this information on a continuous magnetic underlayer via its stray field. Spin-waves propagate from left to right (FIG. 36 panel c)), interfering with imprinted information. The output corresponds to the spin-wave amplitude of probes situated at the end of the system. For the same trained array, different digit inputs are sent to different outputs allowing for classification where the highest amplitude output corresponds to the predicted digit (FIG. 36 panel d)). This scheme demonstrates the power of direct state driven input and FMR readout.

### Alternative to Flip-Chip Approach

The demonstration outlined in “Reconfigurable training and reservoir computing in an artificial spin-vortex ice via spin-wave fingerprinting” involved converting a sine-wave/chaotic time series to a magnetic field input (H). For each input, the field is cycled from +H to −H and then the ferromagnetic resonance (FMR) spectra is measured as the computational output. Linear regression is used to fit a weight to each FMR frequency bin (each reservoir output) to produce the target waveform.

The initial demonstration was slow, taking ˜1 day to get a data set for computation. This is due to the slow field input, which is not technologically attractive. The FMR readout is attractive and forms the backbone of many of the schemes the inventors are proposing. The current FMR readout technique uses a ‘flip-chip’ approach. An array of nanomagnets roughly 2×2 mm in size is placed face-down on a co-planar waveguide (CPW) which is then connected up to a CryoFMR box. The CryoFMR inputs a microwave signal and measures the power absorbed in the sample. The detection locks into a Helmholtz coil to provide greater sensitivity. Due to the large size of the waveguide and the array of nanomagnets, the measurement is an average over the whole system rather than a local pick up.

‘Flip-chip’ waveguides are large and generally unsuitable for technological integration. The inventors have appreciated that a different approach where micron-sized waveguides are fabricated in direct contact with the array, allowing for local measurement can overcome this problem. Small, spatially separated waveguides can give spatial and frequency readout.

### Modifications

It will be appreciated that various modifications may be made to the embodiments hereinbefore described. Such modifications may involve equivalent and other features which are already known in the fields of nanoscale artificial spin systems and neuromorphic hardware, and component parts thereof, and which may be used instead of, or in addition to, features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. A device for use as a physical neural network, the device comprising a plurality of artificial neurons, each artificial neuron comprising a ferromagnetic thin-film nanomagnetic structure having a respective switchable magnetic state, the device responsive to input data taking the form of a field generated by a control apparatus, the input data for switching one or more of the magnetic states and/or for exerting control over spin-wave dynamics of one or more of the magnetic states, the magnetic states and/or the spin-wave dynamics readable by one or more sensors to provide output data.

2. The device of claim 1, wherein the nanomagnetic structures are disposed on a surface of a substrate.

3. The device of claim 1, wherein the nanomagnetic structures are arranged in a coplanar arrangement.

4. The device of claim 1, wherein the nanomagnetic structures are arranged to define an array.

5. (canceled)

6. The device of claim 4, wherein the array of nanomagnetic structures forms an artificial spin system that is an artificial spin ice or an artificial spin-vortex ice.

7. The device of claim 1, wherein the nanomagnetic structures comprise or consist of an alloy, the alloy comprising:
nickel and iron, optionally permalloy; and/or
cobalt, iron, and boron, for example CoFeB; and/or
yttrium, iron, and oxygen, for example yttrium iron garnet; and/or
cobalt and platinum, for example CoPt.

8. The device of claim 1, wherein pairs of artificial neurons are configured to be coupled by dipolar coupling so as to define artificial synapses, each artificial synapse having a trainable synaptic weight that is responsive to switching of the magnetic states or modification of spin-wave dynamics of one or more of the magnetic states.

9. A system comprising:
the device of any one of claim 1;
a control apparatus for generating a field to:
switch one or more of the magnetic states; and/or
exert control over spin-wave dynamics of one or more of the magnetic states; and
one or more sensors for sensing a state of one or more of the magnetic states.

10. (canceled)

11. The system of claim 9, wherein the control apparatus is configured to generate:
a time-varying magnetic field for magnetic switching; and/or
microwave excitation for microwave-assisted magnetic switching; and/or
optical illumination for all-optical magnetic switching; and/or
a locally applied magnetic field from a scanning probe for topological magnetic writing; and/or
heat for heat-assisted switching; and/or
a local field for application by a read/write head; and/or
a current-induced field from a nanostructure proximate to the nanomagnetic structures, optionally wherein the nanostructure is a nanopatterned stripline.

12. The system of claim 9, wherein the one or more sensors comprises a first sensor, the first sensor configured to perform ferromagnetic resonance measurements and/or magneto-optical Kerr effect measurements and/or electrical measurements.

13. (canceled)

14. (canceled)

15. The system of claim 9, wherein:
the nanomagnetic structures form a first hidden layer;
the first hidden layer is one of a plurality of hidden layers; and
the plurality of hidden layers are connected in parallel, or in series, or in a hybrid arrangement combining series and parallel arrangements.

16. The system of claim 15, wherein:
the nanomagnetic structures of the first hidden layer are arranged in a first arrangement; and
the plurality of hidden layers comprises a second hidden layer having a second arrangement, the second arrangement differing from the first arrangement.

17. The system of claim 9, wherein at least one of the one or more sensors is configured to sense a weighted combination of magnetic states from two or more different nanomagnetic structures.

18. (canceled)

19. A method of operating a device for use as a physical neural network, the device comprising a plurality of artificial neurons, each artificial neuron comprising a ferromagnetic thin-film nanomagnetic structure having a respective switchable magnetic state, the device responsive to input data taking the form of a field generated by a control apparatus, the input data for switching one or more of the magnetic states and/or for exerting control over spin-wave dynamics of one or more of the magnetic states, the magnetic states and/or the spin-wave dynamics readable by one or more sensors to provide output data, the method comprising:
providing input data to the nanomagnetic structures and processing said data by switching one or more magnetic states and/or via spin-wave excitation; and
reading out output data from the nanomagnetic structures by sensing one or more magnetic states.

20. The method of claim 19, wherein spin-wave excitation comprises application of an RF-field and/or RF or DC electrical current and/or optical excitation.

21. The method of claim 19, further comprising:
training the device, wherein training the device comprises:
determining whether a performance metric and/or a loss function and/or an error value of the device is improved for a given task after one or more magnetic states are switched and/or spin-wave dynamics are controlled by the control apparatus;
in response to a positive determination of improvement of the performance metric or the loss function or the error value, keeping said one or more magnetic states switched and/or keeping changes to the state of the control apparatus; and/or
in response to a negative determination of improvement of the performance metric or the loss function or the error value, switching back said one or more magnetic states and/or reversing changes to the state of the control apparatus.

22. The method of claim 21, wherein the method of training is performed using an algorithm that is random or recursive, for example by using backpropagation or by using a gradient descent technique or by using an evolutionary or genetic search algorithm and/or a regression algorithm including ridge or linear regression.

23. (canceled)

24. (canceled)

25. (canceled)

26. A module configured to operate a device for use as a physical neural network, the device comprising a plurality of artificial neurons, each artificial neuron comprising a ferromagnetic thin-film nanomagnetic structure having a respective switchable magnetic state, the device responsive to input data taking the form of a field generated by a control apparatus, the input data for switching one or more of the magnetic states and/or for exerting control over spin-wave dynamics of one or more of the magnetic states, the magnetic states and/or the spin-wave dynamics readable by one or more sensors to provide output data, the module configured to carry out the steps of:
providing input data to the nanomagnetic structures and processing said data by switching one or more magnetic states and/or via spin-wave excitation; and
reading out output data from the nanomagnetic structures by sensing one or more magnetic states;
wherein the module is a hardware module.

27. A monolithic integrated circuit comprising:
a processor subsystem comprising:
at least one processor; and
memory; and
the module of claim 26.

28. A system comprising:
the device of claim 1; and
a monolithic integrated circuit comprising:
a processor subsystem comprising:
at least one processor; and
memory;
wherein the integrated circuit is arranged to control the magnetic states;
a module configured to operate a device for use as a physical neural network, the device comprising a plurality of artificial neurons, each artificial neuron comprising a ferromagnetic thin-film nanomagnetic structure having a respective switchable magnetic state, the device responsive to input data taking the form of a field generated by a control apparatus, the input data for switching one or more of the magnetic states and/or for exerting control over spin-wave dynamics of one or more of the magnetic states, the magnetic states and/or the spin-wave dynamics readable by one or more sensors to provide output data, the module configured to carry out the steps of:
providing input data to the nanomagnetic structures and processing said data by switching one or more magnetic states and/or via spin-wave excitation;
reading out output data from the nanomagnetic structures by sensing one or more magnetic states; and
wherein the module is a hardware module.
